(19) United States
(12) Patent Application Publication
(10) Pub. No.: US 2024/0292410 A1
(43) Pub. Date: Aug. 29, 2024

(54) TECHNIQUES FOR CHANNEL STATE INFORMATION MULTIPLEXING ON MULTIPLE PHYSICAL UPLINK SHARED CHANNEL REPETITIONS

(71) Applicant: QUALCOMM Incorporated, San Diego, CA (US)

(72) Inventors: Shaozhen GUO, Beijing (CN); Mostafa KHOSHNEVISAN, San Diego, CA (US); Xiaoxia ZHANG, San Diego, CA (US); Sony AKKARAKARAN, poway, CA (US)

(21) Appl. No.: 18/571,658

(22) PCT Filed: Aug. 27, 2021
(86) PCT No.: PCT/CN2021/114992

§ 371 Date: Dec. 18, 2023

(51) Int. Cl. H04W 72/1268; H04B 7/06; H04W 16/28; H04W 72/232

(52) U.S. Cl. CPC H04W 72/1268; H04B 7/0626; H04W 16/28; H04W 72/232

(57) ABSTRACT

Methods, systems, and devices for wireless communications are described. Abase station may transmit downlink control information (DCI) to a user equipment (UE) that schedules repetitions of one or more physical uplink shared channels (PUSCHs) over repetitions of one or more transport blocks. In response to the DCI, the UE may multiplex first aperiodic-channel state information (A-CSI) on one or more repetitions of the one or more transport blocks in accordance with a repetition type of the PUSCH repetitions and one or more rules associated with the transport block repetitions. The UE may transmit the transport blocks including the one or more repetitions that include the multiplexed A-CSI to the base station. In some examples, the UE may select the one or more rules based on whether a timing offset between reception of the DCI and the transmission of the transport blocks is satisfied.

### CROSS REFERENCE

The present Application is a 371 national stage filing of International PCT Application No. PCT/CN2021/114992 by GUO et al. entitled “TECHNIQUES FOR CHANNEL STATE INFORMATION MULTIPLEXING ON MULTIPLE PHYSICAL UPLINK SHARED CHANNEL REPETITIONS,” filed Aug. 27, 2021, which is assigned to the assignee hereof, and which is expressly incorporated by reference in its entirety herein.

### FIELD OF TECHNOLOGY

The following relates to wireless communications, including techniques for channel state information (CSI) multiplexing on multiple physical uplink shared channel (PUSCH) repetitions.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

Some wireless communication systems may support the communication of a-periodic-channel state information (A-CSI) reports. In some cases, A-CSI multiplexing techniques may be unknown or unsupported for particular scheduling scenarios.

### SUMMARY

The described techniques relate to improved methods, systems, devices, and apparatuses that support techniques for channel state information (CSI) multiplexing on multiple physical uplink shared channel (PUSCH) repetitions. Generally, the described techniques provide for managing aperiodic-CSI (A-CSI) multiplexing when PUSCH repetitions are scheduled over multiple transport blocks (e.g., repetitions of one or more transport blocks). For example, a base station may transmit downlink control information (DCI) to a user equipment (UE) that schedules repetitions of one or more physical uplink shared channels (PUSCHs) over repetitions of one or more transport blocks. In response to the DCI, the UE may multiplex first A-CSI on a first transmission occasion of the one or more transport blocks, where a transmission occasion corresponds to a single repetition of a given transport block.

The UE may multiplex the first A-CSI on the first transmission occasion in accordance with a PUSCH repetition type of the one or more PUSCHs and one or more rules associated with the one or more transport blocks. For example, the one or more rules may indicate for the UE to multiplex the first A-CSI on a temporally first transmission occasion of a temporally first transport block of the one or more transport blocks (e.g., an earliest transmission occasion of an earliest transport block of the one or more transport blocks in a time domain, a transmission occasion of a transport block that precedes other transport blocks in the time domain), where the temporally first transmission occasion corresponds to the temporally first repetition of the temporally first transport block or the temporally first actual repetition of the temporally first transport block based on the PUSCH repetition type (e.g., type A or type B). Additional and alternative rules are further described herein. In some examples, the UE may multiplex second A-CSI on a second transmission occasion of the one or more transport blocks if the UE uses different beams to communicate different transport block repetitions. For example, the first transmission occasion may be associated with a first beam and the second transmission occasion may be associated with a second beam different from the first beam.

The UE may transmit, to the base station, the repetitions of the one or more transport blocks that include the first A-CSI multiplexed on the first transmission occasion (e.g., and the second A-CSI multiplexed on the second transmission occasion). In some examples, the UE may transmit the first transmission occasion using the first beam and may transmit the second transmission occasion using the second beam.

A method for wireless communication at a UE is described. The method may include receiving DCI scheduling a set of multiple uplink data transmissions over a set of multiple transport blocks, the set of multiple uplink data transmissions including at least one repetition of a PUSCH over two or more transport blocks of the set of multiple transport blocks, multiplexing A-CSI on a transport block of the set of multiple transport blocks in accordance with a type of repetition of the PUSCH and one or more rules associated with the set of multiple transport blocks, and transmitting, to a base station, the set of multiple transport blocks including the transport block including the multiplexed A-CSI.

An apparatus for wireless communication at a UE is described. The apparatus may include a processor, memory coupled with the processor, and instructions stored in the memory. The instructions may be executable by the processor to cause the apparatus to receive DCI scheduling a set of multiple uplink data transmissions over a set of multiple transport blocks, the set of multiple uplink data transmissions including at least one repetition of a PUSCH over two or more transport blocks of the set of multiple transport blocks, multiplex A-CSI on a transport block of the set of multiple transport blocks in accordance with a type of repetition of the PUSCH and one or more rules associated with the set of multiple transport blocks, and transmit, to a base station, the set of multiple transport blocks including the transport block including the multiplexed A-CSI.

Another apparatus for wireless communication at a UE is described. The apparatus may include means for receiving DCI scheduling a set of multiple uplink data transmissions over a set of multiple transport blocks, the set of multiple uplink data transmissions including at least one repetition of a PUSCH over two or more transport blocks of the set of multiple transport blocks, means for multiplexing A-CSI on a transport block of the set of multiple transport blocks in accordance with a type of repetition of the PUSCH and one or more rules associated with the set of multiple transport blocks, and means for transmitting, to a base station, the set of multiple transport blocks including the transport block including the multiplexed A-CSI.

A non-transitory computer-readable medium storing code for wireless communication at a UE is described. The code may include instructions executable by a processor to receive DCI scheduling a set of multiple uplink data transmissions over a set of multiple transport blocks, the set of multiple uplink data transmissions including at least one repetition of a PUSCH over two or more transport blocks of the set of multiple transport blocks, multiplex A-CSI on a transport block of the set of multiple transport blocks in accordance with a type of repetition of the PUSCH and one or more rules associated with the set of multiple transport blocks, and transmit, to a base station, the set of multiple transport blocks including the transport block including the multiplexed A-CSI.

In some examples of the method, apparatuses, and non-transitory computer-readable medium described herein, multiplexing the A-CSI on the transport block may include operations, features, means, or instructions for multiplexing the A-CSI on a temporally first repetition of a temporally first transport block of the set of multiple transport blocks, the transport block corresponding to the temporally first repetition.

In some examples of the method, apparatuses, and non-transitory computer-readable medium described herein, the set of multiple of transport blocks includes two repetitions of a same transport block or repetitions of different transport blocks. In some examples of the method, apparatuses, and non-transitory computer-readable medium described herein, multiplexing the A-CSI on the transport block may include operations, features, means, or instructions for multiplexing the A-CSI on a temporally second repetition of the two repetitions of the same transport block or on a temporally second transport block of the different transport blocks, the transport block corresponding to the temporally second repetition or the temporally second transport block.

In some examples of the method, apparatuses, and non-transitory computer-readable medium described herein, multiplexing the A-CSI on the transport block may include operations, features, means, or instructions for multiplexing the A-CSI on a penultimate transmission occasion associated with the set of multiple transport blocks based on the set of multiple transport blocks including at least three repetitions of a first transport block, at least three transport blocks, or a combination thereof, the transport block corresponding to the penultimate transmission occasion, where a transmission occasion corresponds to a single repetition of a single transport block of the set of multiple transport blocks.

In some examples of the method, apparatuses, and non-transitory computer-readable medium described herein, the set of multiple transport blocks includes repetitions of two different transport blocks. In some examples of the method, apparatuses, and non-transitory computer-readable medium described herein, multiplexing the A-CSI on the transport block may include operations, features, means, or instructions for multiplexing the A-CSI on a temporally first repetition of a temporally last transport block of the two different transport blocks based on the set of multiple transport blocks including the repetitions of the two different transport blocks, the transport block corresponding to the temporally first repetition.

In some examples of the method, apparatuses, and non-transitory computer-readable medium described herein, the set of multiple transport blocks comprises repetitions of at least three different transport blocks. In some examples of the method, apparatuses, and non-transitory computer-readable medium described herein, multiplexing the A-CSI on the transport block may include operations, features, means, or instructions for multiplexing the A-CSI on a temporally first repetition of a penultimate transport block of the set of multiple transport blocks based on the set of multiple transport blocks including at least three different transport blocks, the transport block corresponding to the temporally first repetition.

In some examples of the method, apparatuses, and non-transitory computer-readable medium described herein, multiplexing the A-CSI on the transport block may include operations, features, means, or instructions for multiplexing the A-CSI on a penultimate repetition of a first transport block of the set of multiple transport blocks based on the first transport block being associated with a largest quantity of repetitions relative to remaining transport blocks of the set of multiple transport blocks, the transport block corresponding to the penultimate repetition of the first transport block.

In some examples of the method, apparatuses, and non-transitory computer-readable medium described herein, multiplexing the A-CSI on the transport block may include operations, features, means, or instructions for multiplexing the A-CSI on a temporally first repetition of a first transport block of the set of multiple transport blocks or on a temporally last repetition of the first transport block based on the first transport block being associated with a greatest symbol length indicated by a start and length indicator value (SLIV) relative to remaining transport blocks of the set of multiple transport blocks, the transport block corresponding to the temporally first repetition or the temporally last repetition.

Some examples of the method, apparatuses, and non-transitory computer-readable medium described herein may further include operations, features, means, or instructions for determining, for each transport block of the set of multiple transport blocks, a symbol length across repetitions of a respective transport block, where multiplexing the A-CSI on the transport block may include operations, features, means, or instructions for multiplexing the A-CSI on a temporally first repetition of a first transport block of the set of multiple transport blocks or on a temporally last repetition of the first transport block, the first transport block having a greatest symbol length across repetitions of the first transport block relative to remaining transport blocks of the set of multiple transport blocks, the transport block corresponding to the temporally first repetition or the temporally last repetition.

In some examples of the method, apparatuses, and non-transitory computer-readable medium described herein, multiplexing the A-CSI on the transport block may include operations, features, means, or instructions for multiplexing the A-CSI on a temporally last repetition of a temporally last transport block of the set of multiple transport blocks or on a temporally first repetition of the temporally last transport block, the transport block corresponding to the temporally last repetition or the temporally first repetition.

Some examples of the method, apparatuses, and non-transitory computer-readable medium described herein may further include operations, features, means, or instructions for multiplexing second A-CSI on a second transport block of the set of multiple transport blocks in accordance with the type of repetition of the PUSCH and the one or more rules, where transmitting the set of multiple transport blocks may include operations, features, means, or instructions for transmitting the transport block using a first beam for communicating with the base station and transmitting, to the base station using a second beam for communicating with the base station, the second transport block including the multiplexed second A-CSI, where the second beam may be different from the first beam.

In some examples of the method, apparatuses, and non-transitory computer-readable medium described herein, multiplexing the A-CSI on the transport block may include operations, features, means, or instructions for multiplexing the A-CSI on a temporally first transmission occasion associated with the first beam, the transport block corresponding to the temporally first transmission occasion associated with the first beam, where a transmission occasion corresponds to a single repetition of a single transport block of the set of multiple transport blocks, and where multiplexing the second A-CSI on the second transport block may include operations, features, means, or instructions for multiplexing the second A-CSI on a temporally first transmission occasion associated with the second beam, the second transport block corresponding to the temporally first transmission occasion associated with the second beam.

In some examples of the method, apparatuses, and non-transitory computer-readable medium described herein, multiplexing the A-CSI on the transport block may include operations, features, means, or instructions for multiplexing the A-CSI on a temporally last transmission occasion associated with the first beam, the transport block corresponding to the temporally last transmission occasion associated with the first beam, where a transmission occasion corresponds to a single repetition of a single transport block of the set of multiple transport blocks, and where multiplexing the second A-CSI on the second transport block may include operations, features, means, or instructions for multiplexing the second A-CSI on a temporally last transmission occasion associated with the second beam, the second transport block corresponding to the temporally last transmission occasion associated with the second beam.

In some examples of the method, apparatuses, and non-transitory computer-readable medium described herein, multiplexing the A-CSI on the transport block may include operations, features, means, or instructions for multiplexing the A-CSI on a penultimate transmission occasion associated with the first beam, the transport block corresponding to the penultimate transmission occasion associated with the first beam, where a transmission occasion corresponds to a single repetition of a single transport block of the set of multiple transport blocks, and where multiplexing the second A-CSI on the second transport block may include operations, features, means, or instructions for multiplexing the second A-CSI on a penultimate transmission occasion associated with the second beam, the second transport block corresponding to the penultimate transmission occasion associated with the second beam.

In some examples of the method, apparatuses, and non-transitory computer-readable medium described herein, multiplexing the A-CSI on the transport block may include operations, features, means, or instructions for multiplexing the A-CSI on a first transmission occasion associated with the first beam and including a largest quantity of resource elements for A-CSI multiplexing relative to other transmission occasions associated with the first beam, the transport block corresponding to the first transmission occasion associated with the first beam, where a transmission occasion corresponds to a single repetition of a single transport block of the set of multiple transport blocks, and where multiplexing the second A-CSI on the second transport block may include operations, features, means, or instructions for multiplexing the second A-CSI on a second transmission occasion associated with the second beam and including a largest quantity of resource elements for A-CSI multiplexing relative to other transmission occasions associated with the second beam, the second transport block corresponding to the second transmission occasion associated with the second beam.

In some examples of the method, apparatuses, and non-transitory computer-readable medium described herein, the transport block and the second transport block include a same quantity of resource elements for A-CSI multiplexing.

Some examples of the method, apparatuses, and non-transitory computer-readable medium described herein may further include operations, features, means, or instructions for determining that the transport block and the second transport block include a same quantity of resource elements for A-CSI multiplexing based on: uplink control signaling (UCI) different from the A-CSI and the second A-CSI being excluded from the transport block and the second transport block; or the transport block and the second transport block each corresponding to respective initial transmissions or retransmissions associated with the first beam and the second beam, including a same quantity of symbols, being associated with a same modulation and coding scheme (MCS), including a same quantity of resource blocks, including a same quantity of layers, including a same quantity of resource elements for demodulation reference signals (DMRSs), or a combination thereof.

Some examples of the method, apparatuses, and non-transitory computer-readable medium described herein may further include operations, features, means, or instructions for determining a quantity of resource elements for A-CSI associated with the transport block and determining a temporally first transmission occasion associated with the second beam that includes the quantity of resource elements, a temporally last transmission occasion associated with the second beam that includes the quantity of resource elements, or a temporally penultimate transmission occasion associated with the second beam that includes the quantity of resource elements, where a transmission occasion corresponds to a single repetition of a single transport block of the set of multiple transport blocks, and where the second transport block corresponds to the temporally first transmission occasion, the temporally last transmission occasion, or the temporally penultimate transmission occasion.

Some examples of the method, apparatuses, and non-transitory computer-readable medium described herein may further include operations, features, means, or instructions for determining a quantity of resource elements for A-CSI associated with the transport block, where the A-CSI and the second A-CSI may be multiplexed using the determined quantity of resource elements.

In some examples of the method, apparatuses, and non-transitory computer-readable medium described herein, multiplexing the A-CSI on the transport block may include operations, features, means, or instructions for multiplexing the A-CSI on a temporally first repetition of a first transport block of the set of multiple transport blocks that may be associated with the first beam, the transport block corresponding to the temporally first repetition associated with the first beam, and where multiplexing the second A-CSI on the second transport block may include operations, features, means, or instructions for multiplexing the second A-CSI on a temporally first repetition of the first transport block that may be associated with the second beam, the transport block corresponding to the temporally first repetition associated with the second beam.

In some examples of the method, apparatuses, and non-transitory computer-readable medium described herein, the first transport block corresponds to a temporally first transport block of the set of multiple transport blocks, a penultimate transport block of the set of multiple transport blocks, or a temporally last transport block of the set of multiple transport blocks.

In some examples of the method, apparatuses, and non-transitory computer-readable medium described herein, the first transport block corresponds to a temporally first transport block of the set of multiple transport blocks that excludes UCI different from the A-CSI and the second A-CSI.

In some examples of the method, apparatuses, and non-transitory computer-readable medium described herein, the DCI indicates a timing offset between the reception of the DCI and the transmission of the set of multiple transport blocks and the method, apparatuses, and non-transitory computer-readable medium may include further operations, features, means, or instructions for selecting the one or more rules based on the timing offset being satisfied, where the A-CSI may be multiplexed on the transport block based on the timing offset.

In some examples of the method, apparatuses, and non-transitory computer-readable medium described herein, the DCI indicates a timing offset between the reception of the DCI and the transmission of the set of multiple transport blocks and the method, apparatuses, and non-transitory computer-readable medium may include further operations, features, means, or instructions for selecting the one or more rules based on the timing offset failing to be satisfied, where the A-CSI may be multiplexed on the transport block based on the timing offset.

In some examples of the method, apparatuses, and non-transitory computer-readable medium described herein, the transport block may have a duration of at least two symbols.

A method for wireless communication at a base station is described. The method may include transmitting, to a UE, DCI scheduling a set of multiple uplink data transmissions over a set of multiple transport blocks, the set of multiple uplink data transmissions including at least one repetition of a PUSCH over two or more transport blocks of the set of multiple transport blocks and receiving, from the UE, the set of multiple transport blocks including a transport block including A-CSI that is multiplexed in accordance with a type of repetition of the PUSCH and one or more rules associated with the set of multiple transport blocks.

An apparatus for wireless communication at a base station is described. The apparatus may include a processor, memory coupled with the processor, and instructions stored in the memory. The instructions may be executable by the processor to cause the apparatus to transmit, to a UE, DCI scheduling a set of multiple uplink data transmissions over a set of multiple transport blocks, the set of multiple uplink data transmissions including at least one repetition of a PUSCH over two or more transport blocks of the set of multiple transport blocks and receive, from the UE, the set of multiple transport blocks including a transport block including A-CSI that is multiplexed in accordance with a type of repetition of the PUSCH and one or more rules associated with the set of multiple transport blocks.

Another apparatus for wireless communication at a base station is described. The apparatus may include means for transmitting, to a UE, DCI scheduling a set of multiple uplink data transmissions over a set of multiple transport blocks, the set of multiple uplink data transmissions including at least one repetition of a PUSCH over two or more transport blocks of the set of multiple transport blocks and means for receiving, from the UE, the set of multiple transport blocks including a transport block including A-CSI that is multiplexed in accordance with a type of repetition of the PUSCH and one or more rules associated with the set of multiple transport blocks.

A non-transitory computer-readable medium storing code for wireless communication at a base station is described. The code may include instructions executable by a processor to transmit, to a UE, DCI scheduling a set of multiple uplink data transmissions over a set of multiple transport blocks, the set of multiple uplink data transmissions including at least one repetition of a PUSCH over two or more transport blocks of the set of multiple transport blocks and receive, from the UE, the set of multiple transport blocks including a transport block including A-CSI that is multiplexed in accordance with a type of repetition of the PUSCH and one or more rules associated with the set of multiple transport blocks.

In some examples of the method, apparatuses, and non-transitory computer-readable medium described herein, the A-CSI may be multiplexed on a temporally first repetition of a temporally first transport block of the set of multiple transport blocks, the transport block corresponding to the temporally first repetition.

In some examples of the method, apparatuses, and non-transitory computer-readable medium described herein, the set of multiple transport blocks includes two repetitions of a same transport block or repetitions of different transport blocks, and the A-CSI may be multiplexed on a temporally second repetition of the two repetitions of the same transport block or on a temporally second transport block of the different transport blocks, the transport block corresponding to the temporally second repetition or the temporally second transport block.

In some examples of the method, apparatuses, and non-transitory computer-readable medium described herein, the A-CSI may be multiplexed on a penultimate transmission occasion associated with the set of multiple transport blocks based on the set of multiple transport blocks including at least three repetitions of a first transport block, at least three transport blocks, or a combination thereof, the transport block corresponding to the penultimate transmission occasion, where a transmission occasion corresponds to a single repetition of a single transport block of the set of multiple transport blocks.

In some examples of the method, apparatuses, and non-transitory computer-readable medium described herein, the set of multiple transport blocks includes repetitions of two different transport blocks, and the A-CSI may be multiplexed on a temporally first repetition of a temporally last transport block of the two different transport blocks based on the set of multiple transport blocks including the repetitions of the two different transport blocks, the transport block corresponding to the temporally first repetition.

In some examples of the method, apparatuses, and non-transitory computer-readable medium described herein, the set of multiple transport blocks includes repetitions of at least three different transport blocks, and the A-CSI may be multiplexed a temporally first repetition of a penultimate transport block of the set of multiple transport blocks based on the set of multiple transport blocks including at least three different transport blocks, the transport block corresponding to the temporally first repetition.

In some examples of the method, apparatuses, and non-transitory computer-readable medium described herein, the A-CSI may be multiplexed on a penultimate repetition of a first transport block of the set of multiple transport blocks based on the first transport block being associated with a largest quantity of repetitions relative to remaining transport blocks of the set of multiple transport blocks, the transport block corresponding to the penultimate repetition of the first transport block.

In some examples of the method, apparatuses, and non-transitory computer-readable medium described herein, the A-CSI may be multiplexed on a temporally first repetition of a first transport block of the set of multiple transport blocks or on a temporally last repetition of the first transport block based on the first transport block being associated with a greatest symbol length indicated by a SLIV relative to remaining transport blocks of the set of multiple transport blocks, the transport block corresponding to the temporally first repetition or the temporally last repetition.

In some examples of the method, apparatuses, and non-transitory computer-readable medium described herein, the A-CSI may be multiplexed on a temporally first repetition of a first transport block of the set of multiple transport blocks or on a temporally last repetition of the first transport block, the first transport block having a greatest symbol length across repetitions of the first transport block relative to remaining transport blocks of the set of multiple transport blocks, the transport block corresponding to the temporally first repetition or the temporally last repetition.

In some examples of the method, apparatuses, and non-transitory computer-readable medium described herein, the A-CSI may be multiplexed on a temporally last repetition of a temporally last transport block of the set of multiple transport blocks or on a temporally first repetition of the temporally last transport block, the transport block corresponding to the temporally last repetition or the temporally first repetition.

In some examples of the method, apparatuses, and non-transitory computer-readable medium described herein, receiving the set of multiple transport blocks may include operations, features, means, or instructions for receiving the transport block using a first beam for communicating with the UE and receiving, using a second beam for communicating with the UE, a second transport block including second A-CSI that may be multiplexed in accordance with the type of repetition of the PUSCH and the one or more rules, the second beam being different from the first beam.

In some examples of the method, apparatuses, and non-transitory computer-readable medium described herein, the A-CSI may be multiplexed on a temporally first transmission occasion associated with the first beam, the transport block corresponding to the temporally first transmission occasion associated with the first beam, where a transmission occasion corresponds to a single repetition of a single transport block of the set of multiple transport blocks, and the second A-CSI may be multiplexed on a temporally first transmission occasion associated with the second beam, the second transport block corresponding to the temporally first transmission occasion associated with the second beam.

In some examples of the method, apparatuses, and non-transitory computer-readable medium described herein, the A-CSI may be multiplexed on a temporally last transmission occasion associated with the first beam, the transport block corresponding to the temporally last transmission occasion associated with the first beam, where a transmission occasion corresponds to a single repetition of a single transport block of the set of multiple transport blocks, and the second A-CSI may be multiplexed on a temporally last transmission occasion associated with the second beam, the second transport block corresponding to the temporally last transmission occasion associated with the second beam.

In some examples of the method, apparatuses, and non-transitory computer-readable medium described herein, the A-CSI may be multiplexed on a penultimate transmission occasion associated with the first beam, the transport block corresponding to the penultimate transmission occasion associated with the first beam, where a transmission occasion corresponds to a single repetition of a single transport block of the set of multiple transport blocks, and the second A-CSI may be multiplexed on a penultimate transmission occasion associated with the second beam, the second transport block corresponding to the penultimate transmission occasion associated with the second beam.

In some examples of the method, apparatuses, and non-transitory computer-readable medium described herein, the A-CSI may be multiplexed on a first transmission occasion associated with the first beam and including a largest quantity of resource elements for A-CSI multiplexing relative to other transmission occasions associated with the first beam, the transport block corresponding to the first transmission occasion associated with the first beam, where a transmission occasion corresponds to a single repetition of a single transport block of the set of multiple transport blocks, and the second A-CSI may be multiplexed on a second transmission occasion associated with the second beam and including a largest quantity of resource elements for A-CSI multiplexing relative to other transmission occasions associated with the second beam, the second transport block corresponding to the second transmission occasion associated with the second beam.

In some examples of the method, apparatuses, and non-transitory computer-readable medium described herein, the transport block and the second transport block include a same quantity of resource elements for A-CSI multiplexing.

In some examples of the method, apparatuses, and non-transitory computer-readable medium described herein, the transport block and the second transport block include a same quantity of resource elements for A-CSI multiplexing based on UCI different from the A-CSI and the second A-CSI being excluded from the transport block and the second transport block; or the transport block and the second transport block each corresponding to respective initial transmissions or retransmissions associated with the first beam and the second beam, including a same quantity of symbols, being associated with a same MCS, including a same quantity of resource blocks, including a same quantity of layers, including a same quantity of resource elements for DMRSs, or a combination thereof.

In some examples of the method, apparatuses, and non-transitory computer-readable medium described herein, the A-CSI may be multiplexed on a temporally first repetition of a first transport block of the set of multiple transport blocks that may be associated with the first beam, the transport block corresponding to the temporally first repetition associated with the first beam, and the second A-CSI may be multiplexed on a temporally first repetition of the first transport block that may be associated with the second beam, the transport block corresponding to the temporally first repetition associated with the second beam.

In some examples of the method, apparatuses, and non-transitory computer-readable medium described herein, the first transport block corresponds to a temporally first transport block of the set of multiple transport blocks, a penultimate transport block of the set of multiple transport blocks, or a temporally last transport block of the set of multiple transport blocks.

In some examples of the method, apparatuses, and non-transitory computer-readable medium described herein, the first transport block corresponds to a temporally first transport block of the set of multiple transport blocks that excludes UCI different from the A-CSI and the second A-CSI.

In some examples of the method, apparatuses, and non-transitory computer-readable medium described herein, the DCI indicates a timing offset between a reception of the DCI by the UE and a transmission of the set of multiple transport blocks by the UE, the one or more rules based on the timing offset.

In some examples of the method, apparatuses, and non-transitory computer-readable medium described herein, the transport block may have a duration of at least two symbols.

### BRIEF DESCRIPTION OF THE DRAWINGS

FIGS. 1 and 2 illustrate examples of wireless communications systems that supports techniques for channel state information (CSI) multiplexing on multiple physical uplink shared channel (PUSCH) repetitions in accordance with aspects of the present disclosure.

FIGS. 3A, 3B, 4A, 4B, 5A, 5B, 6A, 6B, 7A, 7B, 8A, 8B, 9A, 9B, 10A, 10B, 11A, 11, 12A, 12B, 13A, 13B, 14A, 14B, 15A, 15B, 16A, 16B, 17A, 17B, 18A, 18B, 19A, 19B, 20A, 20B, 21A, 21B, 22A, 22B, 23A, 23B, 24A, 24B, 25A, 25B, 26A, 26B, 27A, 27B, 28A, 28B, 29A, and 29B illustrate examples of multiplexing schemes that support techniques for CSI multiplexing on multiple PUSCH repetitions in accordance with aspects of the present disclosure.

FIGS. 30 and 31 show block diagrams of devices that support techniques for CSI multiplexing on multiple PUSCH repetitions in accordance with aspects of the present disclosure.

FIG. 32 shows a block diagram of a communications manager that supports techniques for CSI multiplexing on multiple PUSCH repetitions in accordance with aspects of the present disclosure.

FIG. 33 shows a diagram of a system including a device that supports techniques for CSI multiplexing on multiple PUSCH repetitions in accordance with aspects of the present disclosure.

FIGS. 34 and 35 show block diagrams of devices that support techniques for CSI multiplexing on multiple PUSCH repetitions in accordance with aspects of the present disclosure.

FIG. 36 shows a block diagram of a communications manager that supports techniques for CSI multiplexing on multiple PUSCH repetitions in accordance with aspects of the present disclosure.

FIG. 37 shows a diagram of a system including a device that supports techniques for CSI multiplexing on multiple PUSCH repetitions in accordance with aspects of the present disclosure.

FIGS. 38 through 43 show flowcharts illustrating methods that support techniques for CSI multiplexing on multiple PUSCH repetitions in accordance with aspects of the present disclosure.

### DETAILED DESCRIPTION

Some wireless communications systems may include communication devices, such as a user equipment (UE) and a base station (e.g., an eNodeB (eNB), a next-generation NodeB or a giga-NodeB, either of which may be referred to as a gNB, or some other base station), that may support multiple radio access technologies (RATs). Examples of RATs include fourth generation (4G) systems, such as Long Term Evolution (LTE) systems, and fifth generation (5G) systems, which may be referred to as New Radio (NR) systems. In some examples, a UE and a base station may communicate information using transport blocks. A transport block may refer to a payload that is communicated between a medium access control (MAC) layer and a physical layer of a layered protocol stack. In some examples, a transport block may undergo physical layer processing at a transmitter of a communication device (e.g., the UE, the base station) and be mapped onto a physical channel (e.g., an instance of a physical uplink shared channel (PUSCH), an instance of a physical downlink shared channel (PDSCH)) for transmission over an air interface. The transport block may be segmented into code blocks and a cyclic redundancy check (CRC) may be added (e.g., to each code block) to support receiver-side error detection.

In some examples, a base station may schedule (e.g., via downlink control information (DCI)) a UE to transmit one or more PUSCHs, and the PUSCHs may each be transmitted using one or more repetitions. In addition, the PUSCHs may be transmitted over one or more transport blocks (e.g., that each include one or more repetitions). In some cases, repetitions of a single PUSCH may correspond to repetitions of a single transport block. That is, two repetitions of a first PUSCH may be transmitted over two repetitions of a first transport block (e.g., with each PUSCH repetition transmitted in a single transport block repetition), three repetitions of a second PUSCH may be transmitted over three repetitions of a second transport block, and so on. Accordingly, in response to the DCI, the UE may transmit repetitions of the one or more PUSCHs over corresponding repetitions of the one or more transport blocks.

A UE may transmit a channel state information (CSI) report to a base station to indicate channel condition information (e.g., over one or more transport blocks). For example, a CSI report may include a rank indicator (RI) requesting a quantity of layers to be used for downlink transmissions, a precoding matrix indicator (PMI) indicating a preference for which precoder matrix should be used, a channel quality indicator (CQI) representing a highest supported modulation and coding scheme (MCS), or a combination thereof, among other channel condition information. In some cases, the UE may support the transmission of a CSI report by multiplexing CSI on a PUSCH and transmitting the PUSCH including the multiplexed CSI to the base station.

In some examples, a UE may be configured to transmit a CSI report aperiodically, which may be referred to as an aperiodic-CSI (A-CSI) report. For example, a base station may transmit DCI to the UE that schedules one or more PUSCHs (e.g., one or more repetitions of one or more PUSCHs) and triggers the reporting of A-CSI. The UE may multiplex the A-CSI on one or more of the PUSCHs in accordance with one or more rules. However, in some cases, multiplexing rules may be undefined, and thus A-CSI reporting may be unsupported. For example, rules for multiplexing A-CSI in response to DCI that schedules one or more repetitions of one or more PUSCHs over multiple transport blocks (e.g., repetitions of one or more transport blocks) may be undefined, and thus A-CSI reporting may be unsupported in such scheduling scenarios, thereby increasing latency associated with reporting CSI, reducing resource utilization by reducing channel scheduling efficiency, and reducing data rates.

Techniques, systems, and devices are described herein for supporting A-CSI reporting when PUSCH repetitions are scheduled over multiple transport blocks (e.g., repetitions of one or more transport blocks). For example, a base station may transmit DCI to a UE that schedules repetitions of one or more PUSCHs over repetitions of one or more transport blocks. The UE may be configured to transmit an A-CSI report over one or more repetitions of the one or more transport blocks in response to the DCI. For example, the UE may multiplex first A-CSI on a first transmission occasion of the one or more transport blocks, where a transmission occasion corresponds to a single repetition of a given transport block.

The UE may multiplex the first A-CSI on the first transmission occasion in accordance with a PUSCH repetition type of the one or more PUSCHs and one or more rules associated with the one or more transport blocks. For example, the one or more rules may indicate for the UE to multiplex the first A-CSI on a temporally first transmission occasion of a temporally first transport block of the one or more transport blocks (e.g., an earliest transmission occasion of an earliest transport block of the one or more transport blocks in a time domain), where the temporally first transmission occasion corresponds to the temporally first repetition of the temporally first transport block or the temporally first actual repetition of the temporally first transport block based on the PUSCH repetition type (e.g., type A or type B). Alternatively, the one or more rules may indicate for the UE to multiplex the first A-CSI on a temporally last transmission occasion of a temporally last transport block of the one or more transport blocks (e.g., a last transmission occasion of a last transport block of the one or more transport blocks in the time domain), where the temporally last transmission occasion corresponds to the temporally last repetition of the temporally last transport block or the temporally last actual repetition of the temporally last transport block based on the PUSCH repetition type (e.g., type A or type B). Additional and alternative rules are further described herein.

In some examples, the UE may multiplex second A-CSI on a second transmission occasion of the one or more transport blocks if the UE uses different beams to communicate different transport block repetitions (e.g., different repetitions of a same transport block, different repetitions of different transport blocks, or both). For example, the first transmission occasion may correspond to a transmission occasion that is communicated using a first beam for communicating with the base station, and the second transmission occasion may correspond to a transmission occasion that is communicated using a second beam for communicating with the base station that is different from the first beam.

The UE may transmit, to the base station, the repetitions of the one or more transport blocks that include the first A-CSI multiplexed on the first transmission occasion (e.g., and the second A-CSI multiplexed on the second transmission occasion. In some examples, the UE may transmit the first transmission occasion using the first beam and may transmit the second transmission occasion using the second beam.

Aspects of the subject matter described in this disclosure may be implemented to realize one or more of the following potential improvements, among others. The techniques employed by the UE and the base station may provide benefits and enhancements to the operation of the UE and the base station. For example, operations performed by the UE and the base station may enable A-CSI reporting when multiple transport blocks (e.g., multiple repetitions of one or more transport blocks) are scheduled. In some examples, supporting multiple transport block A-CSI reporting may improve latency associated with CSI reporting, data rates, and spectral efficiency. In some other examples, supporting multiple transport block A-CSI reporting may provide improvements to reliability, resource utilization, coordination between devices, scheduling efficiency, and processing capability, among other benefits.

Aspects of the disclosure are initially described in the context of wireless communications systems. Aspects of the disclosure are additionally described in the context of multiplexing schemes. Aspects of the disclosure are further illustrated by and described with reference to apparatus diagrams, system diagrams, and flowcharts that relate to techniques for CSI multiplexing on multiple PUSCH repetitions.

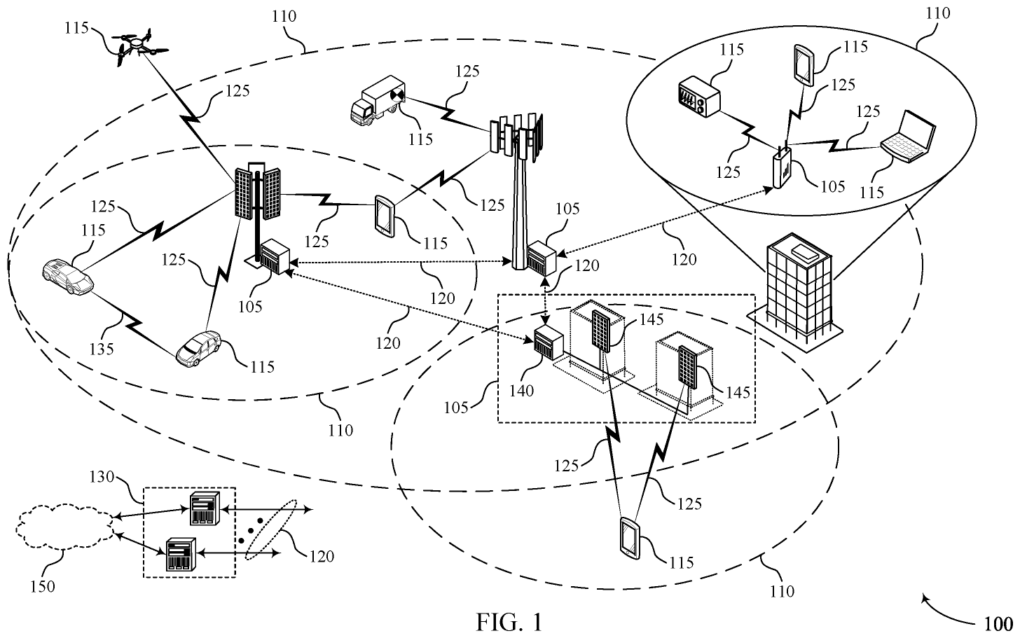

FIG. 1 illustrates an example of a wireless communications system 100 that supports techniques for CSI multiplexing on multiple PUSCH repetitions in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

The time intervals for the base stations 105 or the UEs 115 may be expressed in multiples of a basic time unit which may, for example, refer to a sampling period of Tₛ=1/(Δƒₘₐₓ·N_{ƒ}) seconds, where Δƒₘₐₓ may represent the maximum supported subcarrier spacing, and Nƒ may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{ƒ}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, for example, in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance (e.g., by performing a listen-before-talk (LBT) procedure). In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples. In some examples, the unlicensed spectrum may be referred to as a shared spectrum.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a CSI-reference signal (CSI-RS)), which may be precoded or unprecoded. The UE 115 may provide feedback for beam selection, which may be a PMI or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A MAC layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

A UE 115 and a base station 105 may support communicating PUSCHs in accordance with various repetitions types. For example, in some cases, an instance of a PUSCH may not cross a slot boundary. Accordingly, to avoid transmitting a long PUSCH across a slot boundary, a UE 115 may transmit one or more small PUSCHs in multiple repetitions scheduled by an uplink grant or an RRC message (e.g., over consecutive available slots). In some examples, a UE 115 and a base station 105 may support a PUSCH repetition type A, a PUSCH repetition type B, or both, for transmitting the multiple scheduled repetitions. For PUSCH repetition type A, each slot may include a single PUSCH repetition transmitted over a single transport block repetition. Additionally, in some examples, a same symbol allocation may be applied to each slot. That is, the time domain resources spanned by a given transport block repetition within each slot may be the same. In some other examples, a same symbol allocation may be applied to each repetition of a given transport block. That is, the time domain resources spanned by a repetition of a given transport block within each slot may be the same (e.g., and different transport blocks may be associated with different symbol allocations). In some examples, the starting symbol relative to the start of a slot and the number of consecutive symbols counting from the starting symbol allocated for a transport block repetition may be indicated by a start and length indicator value (SLIV) (e.g., included in DCI that schedules the PUSCH transmissions). In some cases, different SLIVs may be indicated for different transport blocks.

For PUSCH repetition type B, any time gaps between repetitions may be reduced or eliminated by transmitting the repetitions over consecutive mini-slots. As a result, one slot may include multiple repetitions of a transport block. To support PUSCH repetition type B, a DCI or a configured grant transmitted by a base station 105 may indicate a first nominal repetition of a PUSCH (e.g., in a time domain resource assignment (TDRA) field of the DCI, in TDRA parameters included in the configured grant), and time domain resources for remaining repetitions (e.g., of the PUSCH, of other PUSCHs) may be determined based on the time domain resources for the first repetition (e.g., and the uplink/downlink direction of symbols). For example, the DCI or the configured grant may indicate a number of repetitions, which may correspond to the number of nominal repetitions. Additionally, the starting symbol and length of the nominal repetitions may be indicated by a SLIV. If a nominal repetition crosses a slot boundary or a downlink/uplink symbol switching point, the nominal repetition may be split at the slot boundary or switching point into multiple (e.g., two) actual repetitions. Thus, the number of actual repetitions may be greater than the number of nominal repetitions and an actual repetition of transport block may not cross a slot boundary or downlink/uplink symbol switching point (e.g., although a nominal repetition may cross the slot boundary or downlink/uplink symbol switching point). In some examples, DCI may indicate the number of nominal repetitions for multiple different transport blocks and may indicate a SLIV for each transport block.

A base station 105 may gather channel condition information from a UE 115 to efficiently schedule (e.g., configure) a channel. This information may be sent from the UE 115 in the form of a channel state report (e.g., a CSI report). A channel state report may contain an RI requesting a number of layers to be used for downlink transmissions (e.g., based on antenna ports of the UE 115), a PMI indicating a preference for which precoder matrix should be used (e.g., based on a number of layers), and a CQI representing a highest MCS that may be used. In some cases, the RI may be associated with a number of antennas used by a device. CQI may be calculated by a UE 115 after receiving defined pilot symbols such as CRSs or CSI-RSs. RI and PMI may be excluded if the UE 115 does not support spatial multiplexing (or is not in a supported spatial mode). In some examples, the types of information included in the CSI report determines a reporting type. Channel state reports may have different types based on a codebook used to generate the report. For instance, a Type I CSI report may be based on a first codebook and a Type II CSI report may be based on a second codebook, where the first and second codebooks may be based on different antenna configurations. In some cases, the use of either Type I or Type II CSI reports may improve MIMO performance (as compared to other types of CSI reports). In some cases, a Type II CSI report may be carried at least on a PUSCH, and may provide CSI to a base station 105 with a relatively higher level of granularity (e.g., for MU-MIMO services). In some examples, a UE 115 and a base station 105 may support aperiodic channel state reporting. For example, the UE 115 may be configured to transmit an A-CSI report in response to DCI transmitted by the base station 105.

Various aspects of the described techniques support A-CSI reporting when repetitions of one or more PUSCHs are scheduled over multiple transport blocks (e.g., repetitions of one or more transport blocks). For example, a base station 105 may transmit DCI to a UE 115 that schedules repetitions of one or more PUSCHs over repetitions of one or more transport blocks and triggers the UE 115 to multiplex A-CSI on one or more of the transport block repetitions. The UE 115 may multiplex first A-CSI on a first transmission occasion of the one or more transport blocks, where a transmission occasion corresponds to a single repetition of a given transport block. The UE 115 may multiplex the first A-CSI on the first transmission occasion in accordance with a PUSCH repetition type of the one or more PUSCHs (e.g., PUSCH repetition type A, PUSCH repetition type B) and one or more rules associated with the one or more transport blocks and may transmit the repetitions of the one or more transport blocks that include the first A-CSI multiplexed on the first transmission occasion to the base station 105.

Additionally, in some examples, the UE 115 may multiplex second A-CSI on a second transmission occasion of the one or more transport blocks in accordance with the one or more rules and the PUSCH repetition type if the UE 115 uses different beams to communicate different transport block repetitions (e.g., different repetitions of a same transport block, different repetitions of different transport blocks, or both). For example, the first transmission occasion may correspond to a transmission occasion that is communicated using a first beam for communicating with the base station 105, and the second transmission occasion may correspond to a transmission occasion that is communicated using a second beam for communicating with the base station 105 that is different from the first beam. Here, the UE 115 may transmit, to the base station 105, the repetitions of the one or more transport blocks using the first beam and the second beam. The UE 115 may transmit the first transmission occasion that includes the first A-CSI and may transmit the second transmission occasion that includes the second A-CSI using the second beam.

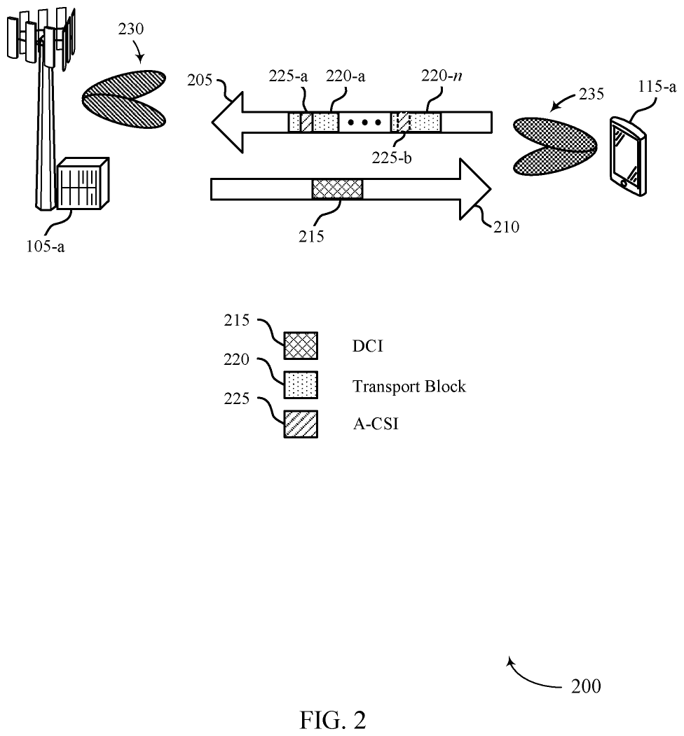

FIG. 2 illustrates an example of a wireless communications system 200 that supports techniques for CSI multiplexing on multiple PUSCH repetitions in accordance with aspects of the present disclosure. The wireless communications system 200 may implement aspects of the wireless communications system 100 or may be implemented by aspects of the wireless communications system 100. For example, the wireless communications system 200 may include a base station 105-a and a UE 115-a which may examples of the corresponding devices described with reference to FIG. 1. In some aspects, the wireless communications system 200 may support multiple RATs including 4 G systems and 5 G systems which may be referred to as NR systems. The wireless communications system 200 may support A-CSI multiplexing and reporting to support improved reliability, latency, data rates, resource utilization, spectral efficiency, coordination between devices, and scheduling efficiency, among other benefits.

The wireless communications system 200 may support communications between the UE 115-a and the base station 105-a. For example, the UE 115-a may transmit uplink messages to the base station 105-a over a communication link 205 (e.g., which may be an example of a communication link 125 described with reference to FIG. 1) and may receive downlink messages on a communication link 210 (which may be an example of a communication link 125). The wireless communications system 200 may additionally support beamformed communications between the base station 105-a and the UE 115-a. For example, the base station 105-a may transmit and receive messages using one or more of a set of one or more base station beams 230, and the UE 115-a may transmit and receive messages using one or more of a set of one or more UE beams 235. It is noted that, for illustrative purposes, FIG. 2 depicts the set of one or more base station beams 230 as including two base station beams 230 and the set of one or more UE beams 235 as including two UE beams 235, however the principles disclosed herein may be adapted and applied for the set of one or more base station beams 230 and the set of one or more UE beams 235 to include any quantity of base station beams 230 and UE beams 235, respectively.

The UE 115-a and the base station 105-a may support A-CSI reporting. For example, the base station 105-a may transmit DCI 215 to the UE 115-a that schedules multiple uplink data transmissions over one or more transport blocks 220. For instance, the DCI 215 may schedule one or more PUSCHs that each include one or more repetitions, and in response to receiving the DCI 215, the UE 115-a may transmit the one or more PUSCHs over the one or more transport blocks 220 (e.g., transport block 220-a through transport block 220-n). In some examples, the transport blocks 220-a through 220-n may include multiple repetitions of a single transport block 220 (e.g., the transport block 220-a through the transport block 220-n correspond to repetitions of a same transport block). In some other examples, the transport blocks 220 may include single repetitions of multiple transport blocks 220 (e.g., the transport blocks 220-a through the transport block 220-n may each correspond to a single repetition of a different transport block 220). In still some other examples, the transport blocks 220 may include multiple repetitions of multiple transport blocks 220.

The DCI 215 may trigger the UE 115-a to transmit one or more A-CSI reports on one or more of the transport blocks 220. For example, the DCI 215 may trigger the UE 115-a to multiplex A-CSI 225 on one or more of the transport blocks 220 in accordance with one or more rules associated with the transport blocks 220 and based on a PUSCH repetition type (e.g., PUSCH repetition type A, PUSCH repetition type B) associated with the uplink data transmissions. For instance, the UE 115-a may multiplex A-CSI 225-a on a first transport block 220 (e.g., the transport block 220-a) in accordance with the one or more rules and based on the PUSCH repetition type corresponding to the transport blocks 220. The UE 115-a may transmit the transport blocks 220 to the base station 105-a including the first transport block 220 that includes the multiplex A-CSI 225-a.

Additionally, in some cases, the UE 115-a may multiplex A-CSI 225-b on a second transport block 220 (e.g., the transport block 220-n) in accordance with the one or more rules and the PUSCH repetition type. For example, the UE 115-a may transmit a first subset of the transport blocks 220 to the base station 105-a using a first UE beam 235 and a second subset of the transport blocks 220 to the base station 105-a using a second UE beam 235 different from the first UE beam 235. Here, the first subset may include the first transport block 220 and the second subset may include the second transport block. Accordingly, to support A-CSI reporting for each beam, the UE 115-a may multiplex the A-CSI 225-a on the first transport block and may multiplex the A-CSI 225-b on the second transport block. Subsequently, the UE 115-a may transmit the first subset using the first UE beam 235 and the second subset using the second UE beam 235.

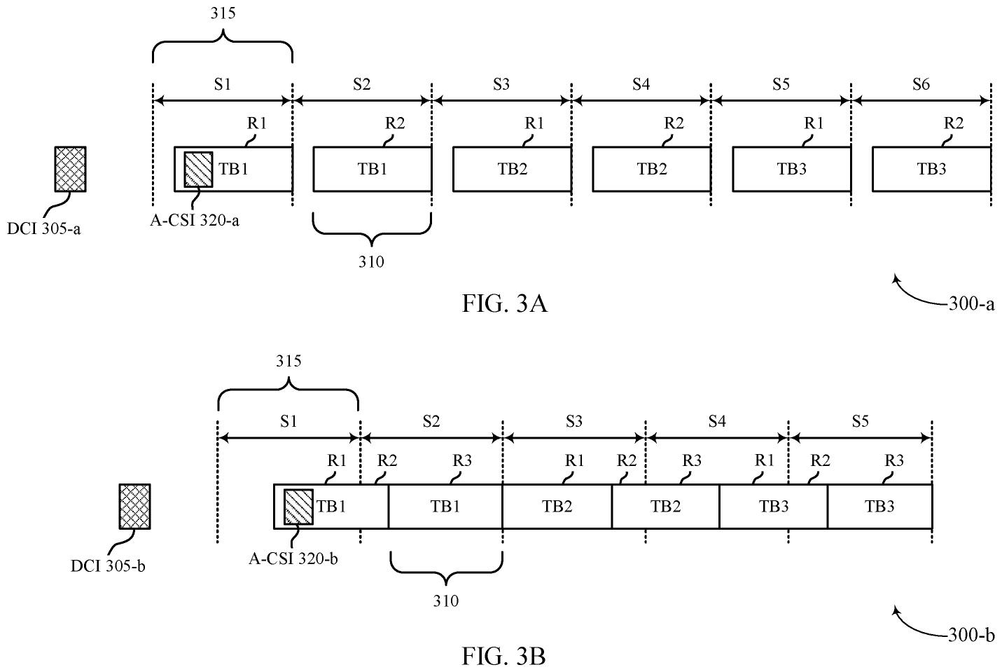

Additional details related to multiplexing A-CSI 225 in accordance with the one or more rules and PUSCH repetition type are further described with reference to FIGS. 3A through 29B below. In particular, FIGS. 3A, 3B, 4A, 4B, 5A, 5B, 6A, 6B, 7A, 7B, 8A, 8B, 9A, 9B, 10A, 10B, 11A, 11B, 12A, 12B, 13A, 13B, 14A, and 14B illustrate examples of multiplexing schemes that support techniques for CSI multiplexing on multiple PUSCH repetitions in accordance with aspects of the present disclosure. Specifically, the multiplexing schemes described with reference to FIGS. 3A through 14B depict rules for multiplexing A-CSI on a repetition of a transport block in response to receiving DCI that schedules multiple PUSCHs (e.g., multiple repetitions of a single PUSCH, one or more repetitions of multiple PUSCHs) over multiple transport blocks (e.g., multiple repetitions of a single transport block, one or more repetitions of multiple transport blocks), where the multiple transport blocks may be transmitted using a same beam. The multiplexing schemes may be implemented by aspects of the wireless communications system 100 and 200 as described with reference to FIGS. 1 and 2, respectively. For example, the multiplexing schemes may be implemented by a UE 115 and a base station 105 to support A-CSI reporting when PUSCH repetitions are scheduled over multiple transport blocks (e.g., repetitions of one or more transport blocks).

FIG. 3A illustrates an example of a multiplexing scheme 300-a that supports techniques for CSI multiplexing on multiple PUSCH repetitions in accordance with aspects of the present disclosure. The multiplexing scheme 300-a depicts DCI 305-a transmitted by a base station 105 that schedules multiple PUSCH repetitions over multiple transport blocks 310 (e.g., TB1, TB2, and so forth) according to a PUSCH repetition type A. For example, the DCI 305-a may schedule PUSCH repetitions over repetitions of transport blocks 310 (e.g., TB1, TB2, and TB3) spanning a quantity of slots 315 in a time domain (e.g., spanning slots S1, S2, S3, S4, S5, and S6). In the example of FIG. 3A, each of the transport blocks 310 may include a first repetition (e.g., R1) and a second repetition (e.g., R2). In accordance with PUSCH repetition type A, each slot 315 may include a single repetition (e.g., R1) of a transport block 310, and each repetition of a respective transport block 310 (e.g., each repetition of TB1, each repetition of TB2, and so on) may correspond to a same or different time resource allocation within a respective slot 315 (e.g., based on one or more SLIVs included in the DCI 305-a). For instance, respective transport blocks 310 may be allocated with the same or different time domain resources, which may be based on a time domain resource allocation.

In response to receiving the DCI 305-a, a ULE 115 may multiplex A-CSI 320-a on a first transmission occasion of the transport blocks 310 in accordance with one or more rules, where a transmission occasion corresponds to a single repetition of a single transport block 310 (e.g., R2 of TB1, R1 of TB2, etc.). In the example of FIG. 3A, the one or more rules may indicate for the UE 115 to multiplex the A-CSI 320-a on a temporally first transmission occasion of a temporally first transport block 310 (e.g., an earliest transmission occasion of an earliest transport block 310 in the time domain). Here, in accordance with the one or more rules, the UE 115 may multiplex the A-CSI 320-a on the first repetition (e.g., R1) of TB1 and may transmit the transport blocks 310 to the base station 105. In this way, the UE 115 may report the A-CSI 320-a sooner compared to multiplexing the A-CSI 320-a on a later transmission occasion in the time domain, thus reducing latency.

FIG. 3B illustrates an example of a multiplexing scheme 300-b that supports techniques for CSI multiplexing on multiple PUSCH repetitions in accordance with aspects of the present disclosure. The multiplexing scheme 300-b depicts DCI 305-b transmitted by a base station 105 that schedules multiple PUSCH repetitions over multiple transport blocks 310 according to a PUSCH repetition type B. For example, the DCI 305-b may schedule PUSCH repetitions over repetitions of transport blocks 310 (e.g., TB1, TB2, and TB3) spanning a quantity of slots 315 in a time domain (e.g., spanning slots S1, S2, S3, S4, and S5). In the example of FIG. 3B, each of the transport blocks 310 may include a number of (e.g., two) nominal repetitions. In accordance with PUSCH repetition type B, if a nominal repetition of a given transport block 310 crosses a slot boundary (e.g., or an downlink/uplink symbol switch point), the nominal repetition may be split into different actual repetitions at the slot boundary. Accordingly, in the example of FIG. 3B, each of the transport blocks 310 (e.g., TB1, TB2, and TB3) may include three actual repetitions R1, R2, and R3 based on a nominal repetition of a respective transport block 310 crossing a slot boundary (e.g., the first nominal repetition of TB1 crossing the S1 boundary, the second nominal repetition of TB2 crossing the S3 boundary, and the first nominal repetition of TB3 crossing the S4 boundary).

In response to receiving the DCI 305-b, a UE 115 may multiplex A-CSI 320-b on a first transmission occasion of the transport blocks 310 in accordance with one or more rules and the PUSCH repetition type B. In the example of FIG. 3B, the one or more rules may indicate for the UE 115 to multiplex the A-CSI 320-b on a temporally first transmission occasion of a temporally first transport block 310. Thus, in accordance with the one or more rules, the UE 115 may multiplex the A-CSI 320-b on R1 of TB1 (e.g., corresponding to the earliest actual repetition of TB1 in the time domain) and may transmit the transport blocks 310 to the base station 105. In this way, the UE 115 may report the A-CSI 320-b sooner compared to multiplexing the A-CSI 310-b on a later transmission occasion in the time domain, thus reducing latency.

In some examples, the UE 115 may expect that the temporally first actual repetition of the temporally first transport block 310 (e.g., TB1) has a threshold duration (e.g., a duration of at least two symbols). In some other examples, if the temporally first actual repetition of the temporally first transport block 310 (e.g., TB1) has a duration (e.g., a single symbol duration) that does not satisfy the threshold duration, the one or more rules may indicate for the UE 115 to multiplex the A-CSI 320-b on the temporally first actual repetition of the temporally first transport block 310 that has the threshold duration (e.g., the duration of at least two symbols). For example, if R1 of TB1 has a single symbol duration, the UE 115 may multiplex the A-CSI 320-b on the earliest repetition of TB1 that has a duration of at least two symbols (e.g., R2 of TB1). In some cases, if R1 of TB1 has a single symbol duration, the UE 115 may drop the R1 of TB1 transmission. In some other cases, the UE 115 may transmit R1 of TB1 without A-CSI.

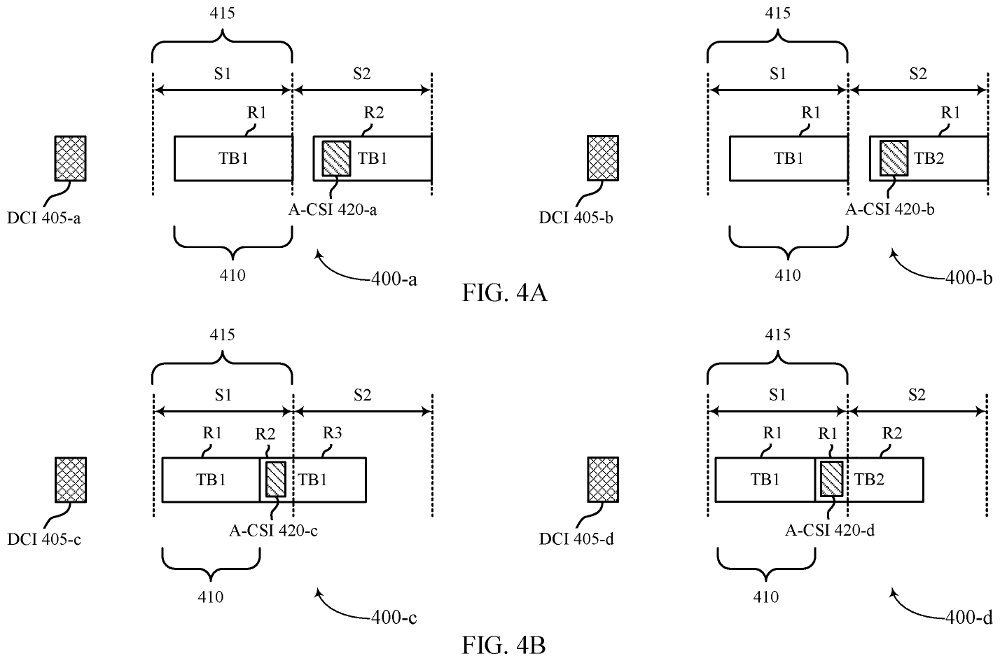

FIG. 4A illustrates an example of multiplexing schemes 400-a and 400-b that support techniques for CSI multiplexing on multiple PUSCH repetitions in accordance with aspects of the present disclosure. In a first example, the multiplexing scheme 400-a depicts DCI 405-a transmitted by a base station 105 that schedules multiple PUSCH repetitions over a first repetition (e.g., R1) and a second repetition (e.g., R2) of a single transport block 410 (e.g., TB1) that spans a first slot 415 (e.g., S1) and a second slot 415 (e.g., S2) in a time domain (e.g., a first repetition of a first PUSCH over R1 and a second repetition of the first PUSCH over R2). In the example of FIG. 4A, the PUSCH repetitions may be scheduled according to a PUSCH repetition type A. Accordingly, R1 may be included in S1 and R2 may be included in S2 and each of R1 and R2 may correspond to a same or different time resource allocation within S1 and S2, respectively.

In response to receiving the DCI 405-a, one or more rules may indicate for a UE 115 to multiplex A-CSI 420-a on a temporally second repetition of TB1. Accordingly, in accordance with the one or more rules, the UE 115 may multiplex the A-CSI 420-a on R2 of TB1 and may transmit TB1 to the base station 105.

In a second example, the multiplexing scheme 400-b depicts DCI 405-b transmitted by a base station 105 that schedules multiple PUSCH repetitions over a single repetition R1 of a first transport block 410 (e.g., TB1) and a single repetition R1 of a second transport block 410 (e.g., TB2) (e.g., a single repetition of a first PUSCH over R1 of TB1 and a single repetition of a second PUSCH over R1 of TB2). In accordance with PUSCH repetition Type A, TB1 and TB2 may span two slots 415 in a time domain (e.g., spanning slot S1 and S2), where R1 of TB1 is included in S1 and R1 of TB2 is included in S2 and each repetition corresponds to a same or different time resource allocation within S1 and S2, respectively.

In response to receiving the DCI 405-b, one or more rules may indicate for the UE 115 to multiplex A-CSI 420-b on a temporally second transport block 410. Accordingly, in accordance with the one or more rules, the UE 115 may multiplex the A-CSI 420-a on the first repetition (e.g., R1) of TB2 and may transmit TB1 and TB2 to the base station 105.

By multiplexing A-CSI 420 on a temporally second transmission occasion of the transport blocks 410, the UE 115 may increase a reliability associated with transmitting the A-CSI 420, for example, if using a shared spectrum to transmit the transport blocks 410. For example, if using the shared spectrum, a failure of an LBT procedure may be less likely to occur during later transmission occasions in the time domain. Thus, multiplexing the A-CSI 420 on a later transmission occasion (e.g., compared to the first transmission occasion) may increase the reliability associated with transmitting the A-CSI 420.

FIG. 4B illustrates an example of a multiplexing scheme 400-c and 400-d that support techniques for CSI multiplexing on multiple PUSCH repetitions in accordance with aspects of the present disclosure. In a first example, the multiplexing scheme 400-c depicts DCI 405-c transmitted by a base station 105 that schedules multiple PUSCH repetitions over two nominal repetitions of a single transport block 410 (e.g., TB1) that spans multiple slots 415 (e.g., S1 and a S2) in a time domain. In the example of FIG. 4B, the PUSCH repetitions may be scheduled according to a PUSCH repetition type B and the second nominal repetition may cross a slot boundary (e.g., the S1 boundary). Accordingly, in this example, TB1 may include actual repetitions R1, R2, and R3 based on the second nominal repetition crossing the S1 boundary.

In response to receiving the DCI 405-c, one or more rules may indicate for a UE 115 to multiplex A-CSI 420-c on a temporally second repetition of TB1. Accordingly, in accordance with the one or more rules, the UE 115 may multiplex the A-CSI 420-c on R2 of TB1 (e.g., corresponding to the second actual repetition of TB1) and may transmit TB1 to the base station 105.

In a second example, the multiplexing scheme 400-d depicts DCI 405-d transmitted by a base station 105 that schedules multiple PUSCH repetitions over a single nominal repetition of a first transport block 410 (e.g., TB1) and a single nominal repetition of a second transport block 410 (e.g., TB2) that span multiple slots 415 (e.g., slot S1 and slot S2) in the time domain. In the example of FIG. 4B, the PUSCH repetitions may be scheduled according to the PUSCH repetition type B. Accordingly, TB1 may include actual repetition R1 and TB2 may include actual repetitions R1 and R2 based on the nominal repetition of TB1 not crossing a slot boundary and the nominal repetition of TB2 crossing a slot boundary (e.g., the S1 boundary).

In response to receiving the DCI 405-d, one or more rules may indicate for the UE 115 to multiplex A-CSI 420-d on a temporally second transmission occasion of the transport blocks 410. In accordance with the one or more rules, the UE 115 may multiplex the A-CSI 420-d on R1 of TB2 and may transmit TB1 and TB2 to the base station 105.

By multiplexing A-CSI 420 on a temporally second transmission occasion of the transport blocks 410, the UE 115 may increase a reliability associated with transmitting the A-CSI 420, for example, if using a shared spectrum to transmit the transport blocks 410 (e.g., based on a failure of an LBT procedure being less likely to occur during later transmission occasions in the time domain).

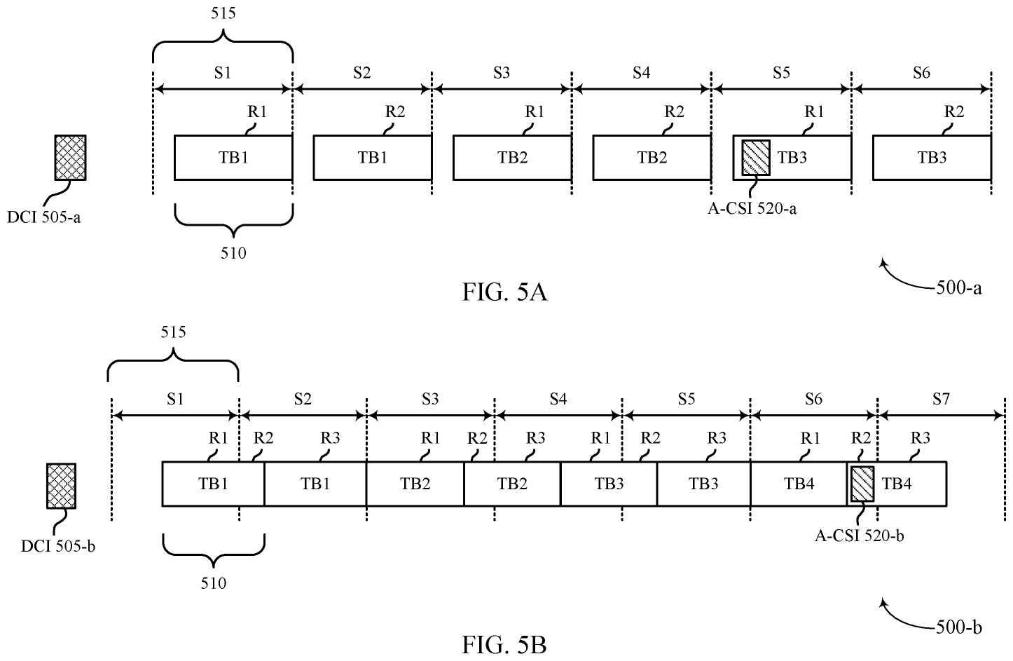

FIG. 5A illustrates an example of a multiplexing scheme 500-a that supports techniques for CSI multiplexing on multiple PUSCH repetitions in accordance with aspects of the present disclosure. The multiplexing scheme 500-a depicts DCI 505-a transmitted by a base station 105 that schedules multiple PUSCH repetitions over multiple transport blocks 510 (e.g., TB1, TB2, and so forth) according to a PUSCH repetition type A. For example, the DCI 505-a may schedule PUSCH repetitions over repetitions of transport blocks 510 (e.g., TB1, TB2, and TB3) spanning a quantity of slots 515 in a time domain (e.g., spanning slots S1, S2, S3, S4, S5, and S6). In the example of FIG. 5A, each of the transport blocks 510 may include a first repetition (e.g., R1) and a second repetition (e.g., R2) with each slot 515 including a single repetition of a transport block 510.

In response to receiving the DCI 505-a, one or more rules may indicate for a UE 115 to multiplex A-CSI 520-a on a penultimate transmission occasion of the transport blocks 510. That is, the one or more rules may indicate for the UE 115 to multiplex the A-CSI 520-a on a second to last repetition of a last transport block 510 in the time domain. Accordingly, in accordance with the one or more rules, the UE 115 may multiplex the A-CSI 520-a on the first repetition (e.g., R1) of TB3 and may transmit the transport blocks 510 to the base station 105.

By multiplexing A-CSI 520 on a penultimate transmission occasion of the transport blocks 510, the UE 115 may increase a reliability associated with transmitting the A-CSI 520, for example, if using a shared spectrum to transmit the transport blocks 510 (e.g., based on a failure of an LBT procedure being less likely to occur during later transmission occasions in the time domain).

FIG. 5B illustrates an example of a multiplexing scheme 500-b that supports techniques for CSI multiplexing on multiple PUSCH repetitions in accordance with aspects of the present disclosure. The multiplexing scheme 500-b depicts DCI 505-b transmitted by a base station 105 that schedules multiple PUSCH repetitions over multiple transport blocks 510 according to a PUSCH repetition type B. For example, the DCI 505-b may schedule PUSCH repetitions over repetitions of transport blocks 510 (e.g., TB1, TB2, TB3, and TB4) spanning a quantity of slots 515 in a time domain (e.g., spanning slots S1, S2, S3, S4, S5, S6, and S7). In the example of FIG. 5B, each of the transport blocks 510 may include two nominal repetitions, where the first nominal repetition of TB1 crosses a slot boundary (e.g., the S1 boundary), the second nominal repetition of TB2 crosses a slot boundary (e.g., the S3 boundary), the first nominal repetition of TB3 crosses a slot boundary (e.g., the S4 boundary), and the second nominal repetition of TB4 crosses a slot boundary (e.g., the S6 boundary). Accordingly, each of the transport blocks TB1, TB2, TB3, and TB4 may include three actual repetitions R1, R2, and R3.

In response to receiving the DCI 505-b, one or more rules may indicate for a UE 115 to multiplex A-CSI 520-b on a penultimate transmission occasion of the transport blocks 510. That is, the one or more rules may indicate for the UE 115 to multiplex the A-CSI 520-b on a second to last actual repetition of a last transport block 510 in the time domain. In accordance with the one or more rules, the UE 115 may multiplex the A-CSI 520-b on R2 of TB4 (e.g., corresponding to the penultimate actual repetition of TB4) and may transmit the transport blocks 510 to the base station 105.

In some examples, the UE 115 may expect that the penultimate transmission occasion has a threshold duration (e.g., a minimum quantity of symbols, such as at least two symbols). In some other examples, if the penultimate transmission occasion has a duration (e.g., a single symbol duration) that does not satisfy the threshold duration, the one or more rules may indicate for the UE 115 to multiplex the A-CSI 520-b on the next to last transmission occasion in the time domain that has the threshold duration (e.g., of at least two symbols). For example, if R2 of TB4 has a single symbol duration, the UE 115 may multiplex the A-CSI 520-b on R1 of TB4 if R1 of TB4 has a duration of at least two symbols.

By multiplexing A-CSI 520 on a penultimate transmission occasion of the transport blocks 510, the UE 115 may increase a reliability associated with transmitting the A-CSI 520, for example, if using a shared spectrum to transmit the transport blocks 510 (e.g., based on a failure of an LBT procedure being relatively less likely to occur during later transmission occasions in the time domain).

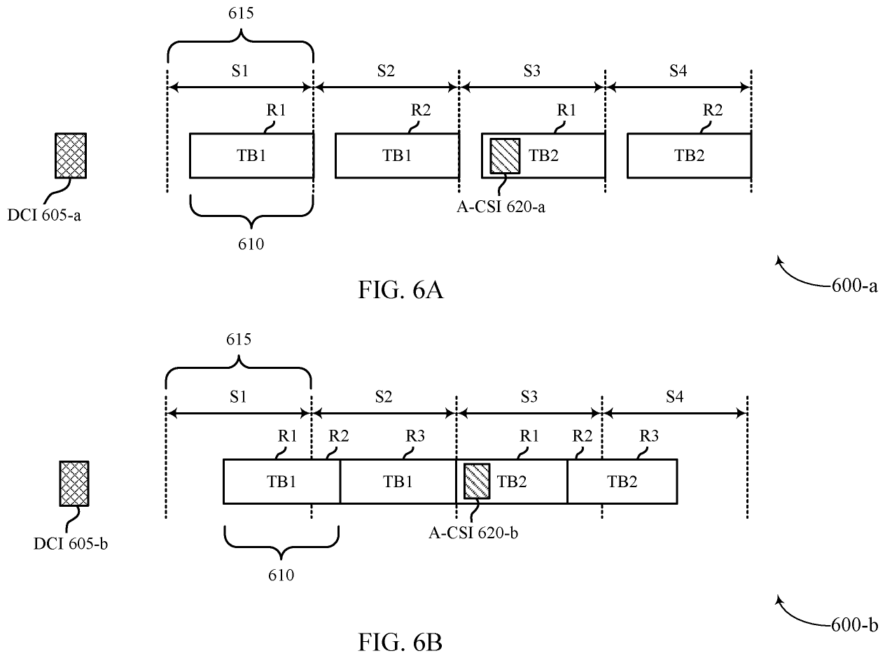

FIG. 6A illustrates an example of a multiplexing scheme 600-a that supports techniques for CSI multiplexing on multiple PUSCH repetitions in accordance with aspects of the present disclosure. The multiplexing scheme 600-a depicts DCI 605-a transmitted by a base station 105 that schedules multiple PUSCH repetitions over multiple transport blocks 610 according to a PUSCH repetition type A. For example, the DCI 605-a may schedule PUSCH repetitions over repetitions of transport blocks 610 (e.g., TB1 and TB2) spanning a quantity of slots 615 in a time domain (e.g., spanning slots S1, S2, S3, and S4). In the example of FIG. 6A, each of the transport blocks 610 may include a first repetition (e.g., R1) and a second repetition (e.g., R2) with each slot 615 including a single repetition of a transport block 610.

In response to receiving the DCI 605-a, one or more rules may indicate for a UE 115 to multiplex A-CSI 620-a on a temporally first repetition of a temporally last transport block 610 of the transport blocks 610 (e.g., TB1 and TB2). That is, the one or more rules may indicate for the UE 115 to multiplex the A-CSI 620-a on an earliest repetition of a last transport block 610 in the time domain. Accordingly, in accordance with the one or more rules, the UE 115 may multiplex the A-CSI 620-a on the first repetition (e.g., R1) of TB2 and may transmit the transport blocks 610 to the base station 105.

By multiplexing the A-CSI 620-a on the temporally first repetition of the temporally last transport block 610 of the two transport blocks TB1 and TB2, the UE 115 may balance a tradeoff between reliability and latency associated with transmitting the A-CSI 620-a. For example, later transmission occasions may be associated with an increased reliability compared to earlier transmission occasions, while earlier transmission occasions may be associated with a lower latency compared to later transmission occasions. Thus, the UE 115 may balance the reliability and latency associated with transmitting the A-CSI 620-a by multiplexing the A-CSI on R1 of TB2.

FIG. 6B illustrates an example of a multiplexing scheme 600-b that supports techniques for CSI multiplexing on multiple PUSCH repetitions in accordance with aspects of the present disclosure. The multiplexing scheme 600-b depicts DCI 605-b transmitted by a base station 105 that schedules multiple PUSCH repetitions over multiple transport blocks 610 according to a PUSCH repetition type B. For example, the DCI 605-b may schedule PUSCH repetitions over repetitions of transport blocks 610 (e.g., TB1 and TB2) spanning a quantity of slots 615 in a time domain (e.g., spanning slots S1, S2, S3, and S4). In the example of FIG. 6B, each of the transport blocks 610 may include two nominal repetitions, where the first nominal repetition of a first transport block 610 (e.g., TB1) crosses a slot boundary (e.g., the S1 boundary) and the second nominal repetition of a second transport block 610 (e.g., TB2) crosses the S3 boundary. In such cases, each of the transport blocks TB1 and TB2 may include three actual repetitions R1, R2, and R3.

In response to receiving the DCI 605-b, one or more rules may indicate for a UE 115 to multiplex A-CSI 620-b on a temporally first actual repetition of a temporally last transport block 610 of the transport blocks 610 (e.g., TB1 and TB2). That is, the one or more rules may indicate for the UE 115 to multiplex the A-CSI 620-a on an earliest actual repetition of a last transport block 610 in the time domain. Accordingly, in accordance with the one or more rules, the UE 115 may multiplex the A-CSI 620-b on R1 of TB2 and may transmit the transport blocks 610 to the base station 105. In this way, the UE 115 may balance a tradeoff between reliability and latency associated with transmitting the A-CSI 620-b.

In some examples, the UE 115 may expect that the temporally first actual repetition of the temporally last transport block 610 has a threshold duration (e.g., a duration of at least two symbols). In some other examples, if the temporally first actual repetition of the temporally last transport block 610 has, for example, a single symbol duration, the one or more rules may indicate for the UE 115 to multiplex the A-CSI 620-b on the temporally first actual repetition of the temporally last transport block 610 that has the threshold duration (e.g., of at least two symbols). For example, if R1 of TB2 has a single symbol duration, the UE 115 may multiplex the A-CSI 620-b on R2 of TB2 if R2 of TB2 has a duration of at least two symbols.

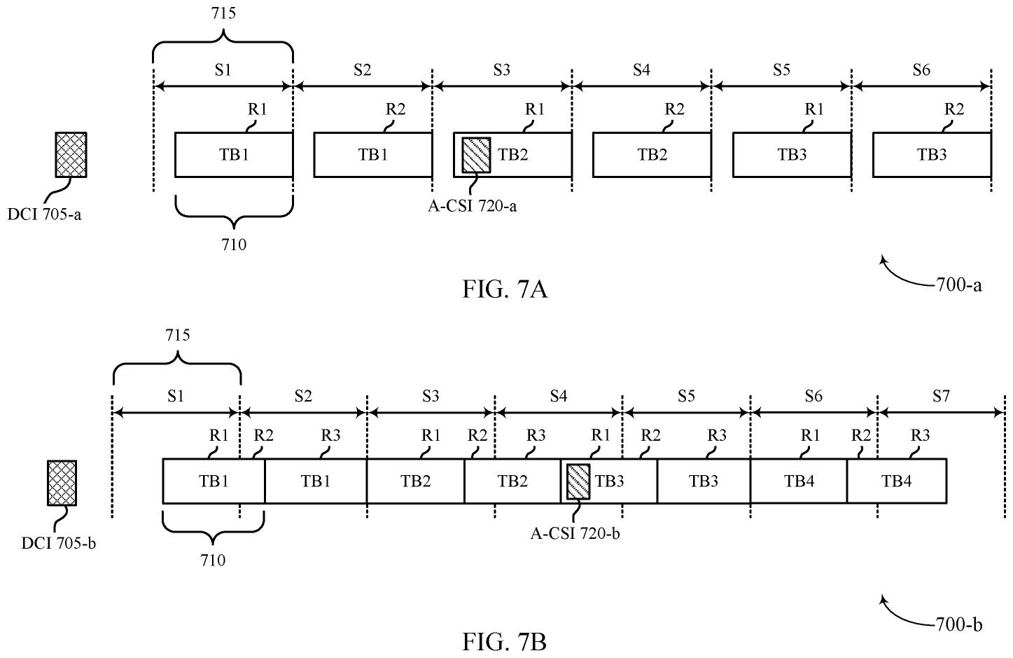

FIG. 7A illustrates an example of a multiplexing scheme 700-a that supports techniques for CSI multiplexing on multiple PUSCH repetitions in accordance with aspects of the present disclosure. The multiplexing scheme 700-a depicts DCI 705-a transmitted by a base station 105 that schedules multiple PUSCH repetitions over multiple transport blocks 710 according to a PUSCH repetition type A. For example, the DCI 705-a may schedule PUSCH repetitions over repetitions (e.g., R1, R2, and so forth) of transport blocks 710 (e.g., TB1, TB2, and TB3) spanning a quantity of slots 715 in a time domain (e.g., spanning slots S1, S2, S3, S4, S5, and S6). In the example of FIG. 7A, each of the transport blocks 710 may include a first repetition (e.g., R1) and a second repetition (e.g., R2) with each slot 715 including a single repetition of a transport block 710.

In response to receiving the DCI 705-a, one or more rules may indicate for a UE 115 to multiplex A-CSI 720-a on a temporally first repetition of a penultimate transport block 710. That is, the one or more rules may indicate for the UE 115 to multiplex the A-CSI 720-a on an earliest repetition of a penultimate transport block 710 in the time domain. Accordingly, in accordance with the one or more rules, the UE 115 may multiplex the A-CSI 720-a on the first repetition (e.g., R1) of TB2 and may transmit the transport blocks 710 to the base station 105. In this way, the UE 115 may balance a tradeoff between reliability and latency associated with transmitting the A-CSI 720-a.

FIG. 7B illustrates an example of a multiplexing scheme 700-b that supports techniques for CSI multiplexing on multiple PUSCH repetitions in accordance with aspects of the present disclosure. The multiplexing scheme 700-b depicts DCI 705-b transmitted by a base station 105 that schedules multiple PUSCH repetitions over multiple transport blocks 710 according to a PUSCH repetition type B. For example, the DCI 705-b may schedule PUSCH repetitions over repetitions of transport blocks 710 (e.g., TB1, TB2, TB3, and TB4) spanning a quantity of slots 715 in a time domain (e.g., spanning slots S1, S2, S3, S4, S5, S6, and S7). In the example of FIG. 7B, each of the transport blocks 710 may include two nominal repetitions, where the first nominal repetition of a first transport block 710 (e.g., TB1) crosses a slot boundary (e.g., the S1 boundary), the second nominal repetition of a second transport block 710 (e.g., TB2) crosses the slot boundary (e.g., the S3 boundary), the first nominal repetition of a third transport block 710 (e.g., TB3) crosses the slot boundary (e.g., the S4 boundary), and the second nominal repetition of a fourth transport block 710 (e.g., TB4) crosses the slot boundary (e.g., the S6 boundary). In this example, each of the transport blocks TB1, TB2, TB3, and TB4 may include three actual repetitions R1, R2, and R3, but a different number of actual repetitions may be possible and the repetitions illustrated herein should not be considered limiting.

In response to receiving the DCI 705-b, one or more rules may indicate for a UE 115 to multiplex A-CSI 720-b on a temporally first actual repetition of a penultimate transport block 710. That is, the one or more rules may indicate for the UE 115 to multiplex the A-CSI 720-b on an earliest actual repetition of a penultimate transport block 710 in the time domain. Accordingly, in accordance with the one or more rules, the UE 115 may multiplex the A-CSI 720-b on R1 of TB3 (e.g., corresponding to the earliest actual repetition of TB3) and may transmit the transport blocks 710 to the base station 105. In this way, the UE 115 may balance a tradeoff between reliability and latency associated with transmitting the A-CSI 720-b.

In some examples, the UE 115 may expect that the temporally first actual repetition of the penultimate transport block 710 has a threshold duration (e.g., a duration of at least two symbols). In some other examples, if the temporally first actual repetition of the penultimate transport block 710 has a duration (e.g., a single symbol duration) that does not satisfy the threshold duration, the one or more rules may indicate for the UE 115 to multiplex the A-CSI 720-b on the temporally first actual repetition of the penultimate transport block 710 that satisfies the threshold duration (e.g., the penultimate transport block 710 that has a duration of at least two symbols). For example, if R1 of TB3 has a single symbol duration, the UE 115 may multiplex the A-CSI 720-b on R2 of TB3 if R2 of TB3 has a duration of at least two symbols.

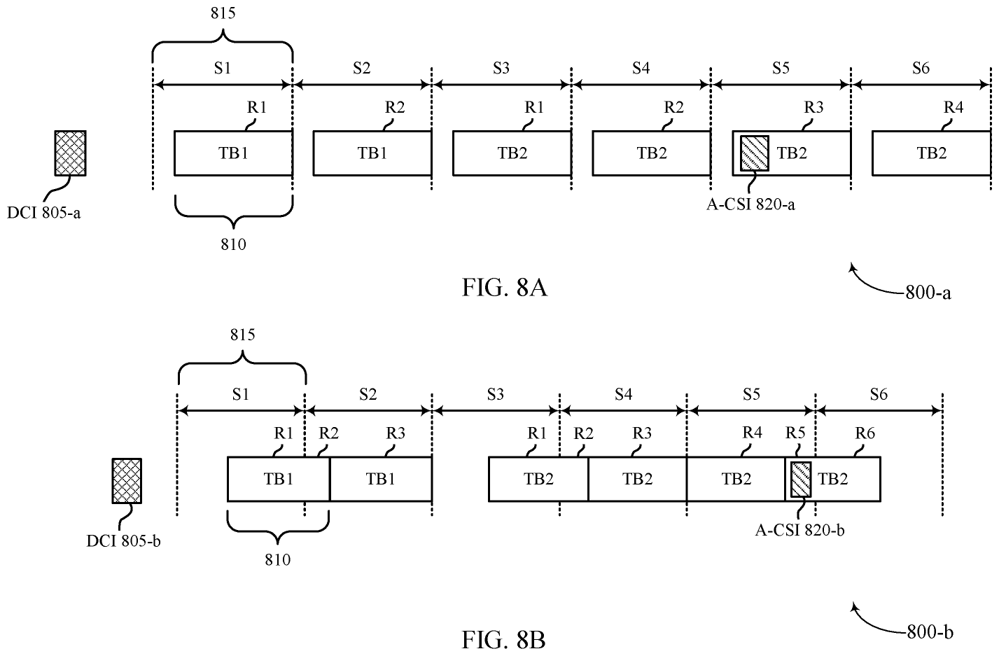

FIG. 8A illustrates an example of a multiplexing scheme 800-a that supports techniques for CSI multiplexing on multiple PUSCH repetitions in accordance with aspects of the present disclosure. The multiplexing scheme 800-a depicts DCI 805-a transmitted by a base station 105 that schedules multiple PUSCH repetitions over multiple transport blocks 810 according to a PUSCH repetition type A. For example, the DCI 805-a may schedule PUSCH repetitions over repetitions (e.g., R1, R2) of transport blocks 810 (e.g., TB1 and TB2) spanning a quantity of slots 815 in a time domain (e.g., spanning slots S1, S2, S3, S4, S5, and S6). In the example of FIG. 8A, a first transport block 810 (e.g., TB1) may include a first repetition (e.g., R1) and a second repetition (e.g., R2), and a second transport block 810 (e.g., TB2) may include a first repetition R1, a second repetition R2, a third repetition R3, and a fourth repetition R4, with each slot 815 including a single repetition of a transport block 810.

In response to receiving the DCI 805-a, one or more rules may indicate for a UE 115 to multiplex A-CSI 820-a on a penultimate repetition of a transport block 810 that has the largest quantity of repetitions. As an example, the UE 115 may determine that TB1 has two repetitions and TB2 has four repetitions. Accordingly, in accordance with the one or more rules, the UE 115 may multiplex the A-CSI 820-a on the third repetition (e.g., R3) of TB2 (e.g., corresponding to the second to last repetition of TB2) and may transmit the transport blocks 810 to the base station 105.

By multiplexing the A-CSI 820-a on a penultimate repetition of the transport block 810 having the largest quantity of repetitions, the UE 115 may increase a reliability associated with transmitting the A-CSI 820-a, for example, if using a shared spectrum to transmit the transport blocks 810 (e.g., based on a failure of an LBT procedure being less likely to occur during later repetitions of a transport block 810 in the time domain).

FIG. 8B illustrates an example of a multiplexing scheme 800-b that supports techniques for CSI multiplexing on multiple PUSCH repetitions in accordance with aspects of the present disclosure. The multiplexing scheme 800-b depicts DCI 805-b transmitted by a base station 105 that schedules multiple PUSCH repetitions over multiple transport blocks 810 according to a PUSCH repetition type B. For example, the DCI 805-b may schedule PUSCH repetitions over repetitions of transport blocks 810 (e.g., TB1 and TB2) spanning a quantity of slots 815 in a time domain (e.g., spanning slots S1, S2, S3, S4, S5, and S6). In the example of FIG. 8B, a first transport block 810 (e.g., TB1) may include two nominal repetitions and a second transport block 810 (e.g., TB2) may include four nominal repetitions, where the first nominal repetition of TB1 crosses a slot boundary (e.g., the S1 boundary), the first nominal repetition of TB2 crosses a slot boundary (e.g., the S3 boundary), and the fourth nominal repetition of TB2 crosses a slot boundary (e.g., the S5 boundary). Accordingly, TB1 may include three actual repetitions R1, R2, and R3, and TB2 may include six actual repetitions R1, R2, R3, R4, R5, and R6.

In response to receiving the DCI 805-b, one or more rules may indicate for a UE 115 to multiplex A-CSI 820-b on a penultimate actual repetition of a transport block 810 that has a largest quantity of repetitions (e.g., a largest quantity of nominal repetitions, a largest quantity of actual repetitions). The UE 115 may determine that TB1 has two nominal repetitions and TB2 has four nominal repetitions. Alternatively, the UE 115 may determine that TB1 has three actual repetitions and TB2 has six actual repetitions. The UE 115 may determine that TB2 has the largest quantity of repetitions based on determining the quantity of nominal repetitions or actual repetitions associated with each transport block 810. Accordingly, in accordance with the one or more rules, the UE 115 may multiplex the A-CSI 820-b on R5 of TB2 (e.g., corresponding to the second to last actual repetition of TB2) and may transmit the transport blocks 810 to the base station 105. In this way, the UE 115 may increase a reliability associated with transmitting the A-CSI 820-b, for example, if using a shared spectrum to transmit the transport blocks 810 (e.g., based on a failure of an LBT procedure being relatively less likely to occur during later repetitions of a transport block 810 in the time domain).

In some examples, the UE 115 may expect that the penultimate actual repetition of the transport block 810 having the largest quantity of repetitions has a threshold duration (e.g., a duration of at least two symbols). In some other examples, if the penultimate actual repetition of the transport block 810 having the largest quantity of repetitions has, for example, a single symbol duration, the one or more rules may indicate for the UE 115 to multiplex the A-CSI 820-b on next to last actual repetition (e.g., in the time domain) of the transport block 810 having the largest quantity of repetitions that has a duration of at least two symbols (e.g., the threshold duration). For example, if R5 of TB2 has a single symbol duration, the UE 115 may multiplex the A-CSI 820-b on R4 of TB2 if R4 of TB2 has a duration of at least two symbols.

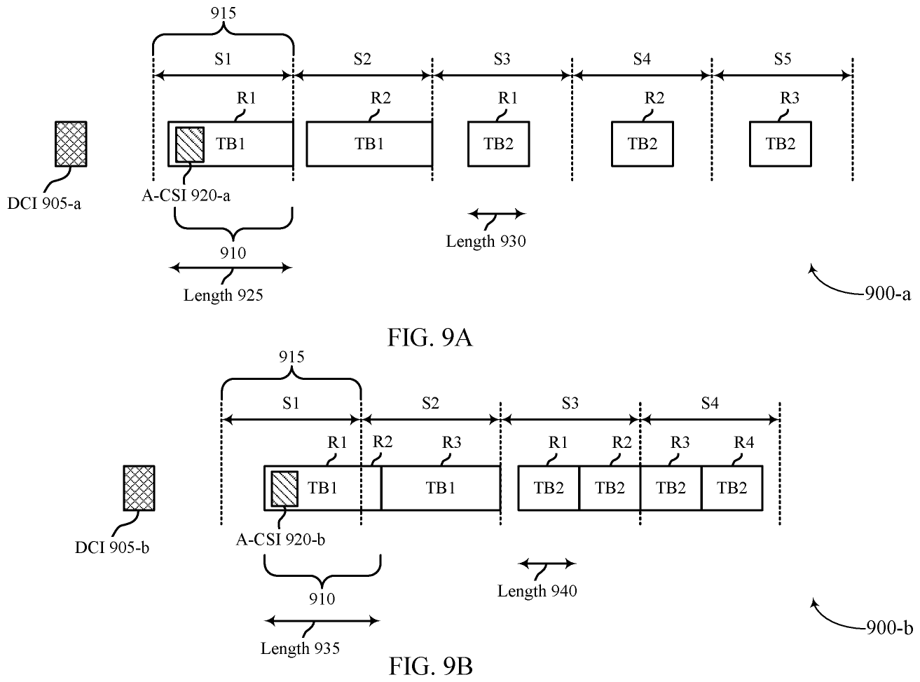

FIG. 9A illustrates an example of a multiplexing scheme 900-a that supports techniques for CSI multiplexing on multiple PUSCH repetitions in accordance with aspects of the present disclosure. The multiplexing scheme 900-a depicts DCI 905-a transmitted by a base station 105 that schedules multiple PUSCH repetitions over multiple transport blocks 910 according to a PUSCH repetition type A. For example, the DCI 905-a may schedule PUSCH repetitions over repetitions (e.g., R1, R2) of transport blocks 910 (e.g., TB1 and TB2) spanning a quantity of slots 915 in a time domain (e.g., spanning slots S1, S2, S3, S4, and S5). In the example of FIG. 9A, a first transport block 910 (e.g., TB1) may include a first repetition (e.g., R1) and a second repetition (e.g., R2), and a second transport block 910 (e.g., TB2) may include a first repetition R1, a second repetition R2, and a third repetition R3, with each slot 915 including a single repetition of a transport block 910.

Additionally, each transport block 910 may be associated with a length (e.g., a symbol length corresponding to a number of symbol periods of a transport block 910), for example, as indicated by a SLIV (e.g., via the DCI 905-a), where each repetition of a given transport block 910 may include a quantity of symbols corresponding to the length associated with the given transport block 910. For example, TB1 may be associated with a length 925 indicated by a first SLIV, and TB2 may be associated with a length 930 indicated by a second SLIV. That is, the repetitions of TB1 may each have the length 925 and the repetitions of TB2 may each have the length 930. In the example of FIG. 9A, the length 925 may be greater than the length 930.

In response to receiving the DCI 905-a, one or more rules may indicate for a UE 115 to multiplex A-CSI 920-a on a temporally first repetition of a transport block 910 associated with the greatest length (e.g., a greatest number of symbol periods). The UE 115 may determine that the length 925 is greater than the length 930. Accordingly, in accordance with the one or more rules, the UE 115 may multiplex the A-CSI 920-a on the first repetition (e.g., R1) of TB1 (e.g., corresponding to an earliest repetition of TB1 in the time domain) and may transmit the transport blocks 910 to the base station 105.

FIG. 9B illustrates an example of a multiplexing scheme 900-b that supports techniques for CSI multiplexing on multiple PUSCH repetitions in accordance with aspects of the present disclosure. The multiplexing scheme 900-b depicts DCI 905-b transmitted by a base station 105 that schedules multiple PUSCH repetitions over multiple transport blocks 910 according to a PUSCH repetition type B. For example, the DCI 905-b may schedule PUSCH repetitions over repetitions of transport blocks 910 (e.g., TB1 and TB2) spanning a quantity of slots 915 in a time domain (e.g., spanning slots S1, S2, S3, and S4). In the example of FIG. 9B, a first transport block 910 (e.g., TB1) may include two nominal repetitions and a second transport block 910 (e.g., TB2) may include four nominal repetitions, where the first nominal repetition of TB1 crosses a slot boundary (e.g., the S1 boundary). In this example, TB1 may include three actual repetitions R1, R2, and R3, and TB2 may include four actual repetitions R1, R2, R3, and R4 (e.g., corresponding to the four nominal repetitions).

Additionally, TB1 may be associated with a length 935 (e.g., a length of a number of symbols of a transport block 910) indicated by a first SLIV, and TB2 may be associated with a length 940 indicated by a second SLIV. Here, the first SLIV and the second SLIV may indicate the length of each nominal repetition of TB1 and TB2, respectively. In the example of FIG. 9B, the length 935 may be greater than the length 940.

In response to receiving the DCI 905-b, one or more rules may indicate for a UE 115 to multiplex A-CSI 920-b on a temporally first actual repetition of a transport block 910 associated with the greatest length (e.g., greatest length of a nominal repetition). The UE 115 may determine that the length 935 is greater than the length 940. Accordingly, in accordance with the one or more rules, the UE 115 may multiplex the A-CSI 920-b on R1 of TB1 (e.g., corresponding to earliest actual repetition of TB1 in the time domain) and may transmit the transport blocks 910 to the base station 105.

In some examples, the UE 115 may expect that the temporally first actual repetition of the transport block 910 associated with the greatest length has a threshold duration (e.g., a duration of two or more symbol periods). In some other examples, if the temporally first actual repetition of the transport block 910 associated with the greatest length has a duration (e.g., a single symbol duration), the one or more rules may indicate for the UE 115 to multiplex the A-CSI 920-b on the temporally first actual repetition of the transport block 910 associated with the greatest length that satisfies the threshold duration (e.g., a duration of at least two symbols). For example, if R1 of TB1 has a single symbol duration, the UE 115 may multiplex the A-CSI 920-b on R2 of TB1 if R2 of TB1 has a duration of at least two symbols.

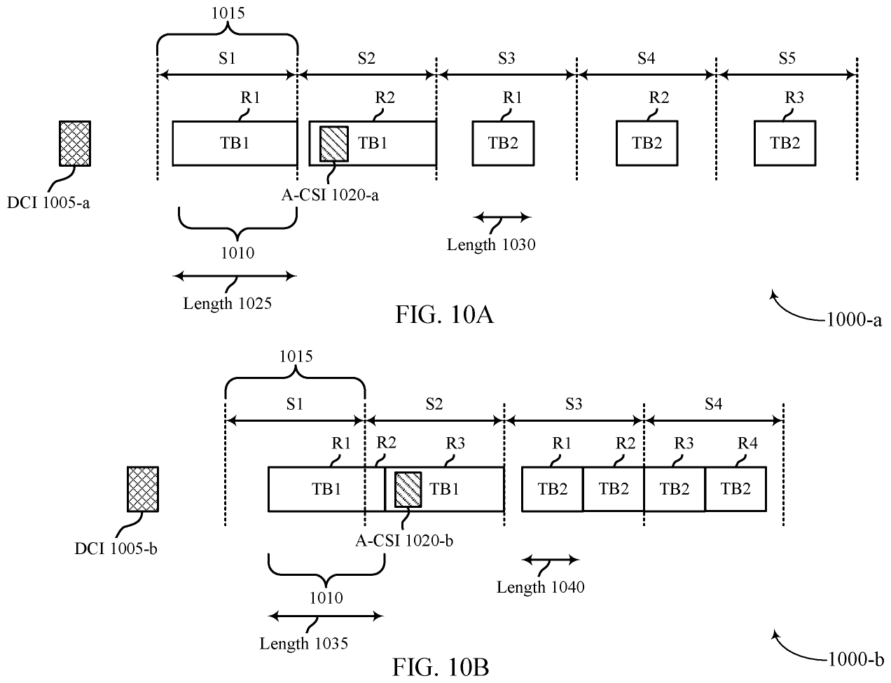

FIG. 10A illustrates an example of a multiplexing scheme 1000-a that supports techniques for CSI multiplexing on multiple PUSCH repetitions in accordance with aspects of the present disclosure. The multiplexing scheme 1000-a depicts DCI 1005-a transmitted by a base station 105 that schedules multiple PUSCH repetitions over multiple transport blocks 1010 according to a PUSCH repetition type A. For example, the DCI 1005-a may schedule PUSCH repetitions over repetitions (e.g., R1, R2, and so forth) of transport blocks 1010 (e.g., TB1 and TB2) spanning a quantity of slots 915 in a time domain (e.g., spanning slots S1, S2, S3, S4, and S5). In the example of FIG. 10A, a first transport block 1010 (e.g., TB1) may include a first repetition (e.g., R1) and a second repetition (e.g., R2), and a second transport block 1010 (e.g., TB2) may include a first repetition R1, a second repetition R2, and a third repetition R3, with each slot 1015 including a single repetition of a transport block 1010.

Additionally, TB1 may be associated with a length 1025 (e.g., a total length in terms of a number of symbols of a transport block 1010), for example, as indicated by a first SLIV, and TB2 may be associated with a length 1030 indicated by a second SLIV. Accordingly, the repetitions of TB1 may each have the length 1025, and the repetitions of TB2 may each have the length 1030. In the example of FIG. 10A, the length 1025 may be greater than the length 1030.

In response to receiving the DCI 1005-a, one or more rules may indicate for a UE 115 to multiplex A-CSI 1020-a on a temporally last repetition of a transport block 1010 associated with the greatest length. The UE 115 may determine that the length 1025 is greater than the length 1030 and, in accordance with the one or more rules, the UE 115 may multiplex the A-CSI 1020-a on R2 of TB1 (e.g., corresponding to a last repetition of TB1 in the time domain) and may transmit the transport blocks 1010 to the base station 105.

FIG. 10B illustrates an example of a multiplexing scheme 1000-b that supports techniques for CSI multiplexing on multiple PUSCH repetitions in accordance with aspects of the present disclosure. The multiplexing scheme 1000-b depicts DCI 1005-b transmitted by a base station 105 that schedules multiple PUSCH repetitions over multiple transport blocks 1010 according to a PUSCH repetition type B. For example, the DCI 1005-b may schedule PUSCH repetitions over repetitions of transport blocks 1010 (e.g., TB1 and TB2) spanning a quantity of slots 1015 in a time domain (e.g., spanning slots S1, S2, S3, and S4). In the example of FIG. 10B, a first transport block 1010 (e.g., TB1) may include two nominal repetitions and a second transport block 1010 (e.g., TB2) may include four nominal repetitions, where the first nominal repetition of TB1 crosses a slot boundary (e.g., the S1 boundary). Accordingly, in this example, TB1 may include three actual repetitions R1, R2, and R3, and TB2 may include four actual repetitions R1, R2, R3, and R4 (e.g., corresponding to the four nominal repetitions).

Additionally, TB1 may be associated with a length 1035 (e.g., a length of a transport block 1010 based on a number of symbol periods) indicated by a first SLIV, and TB2 may be associated with a length 1040 indicated by a second SLIV. Here, the first SLIV and the second SLIV may indicate the length of each nominal repetition of TB1 and TB2, respectively. In the example of FIG. 10B, the length 1035 may be greater than the length 1040.

In response to receiving the DCI 1005-b, one or more rules may indicate for a UE 115 to multiplex A-CSI 1020-b on a temporally last actual repetition of a transport block 1010 associated with the greatest length (e.g., greatest length of a nominal repetition). The UE 115 may determine that the length 1035 is greater than the length 1040. Thus, in accordance with the one or more rules, the UE 115 may multiplex the A-CSI 1020-b on R3 of TB1 (e.g., corresponding to a last actual repetition of TB1 in the time domain) and may transmit the transport blocks 1010 to the base station 105.

In some examples, the UE 115 may expect that the temporally last actual repetition of the transport block 1010 associated with the greatest length has a threshold duration (e.g., a minimum duration, a duration of at least two symbols). In some other examples, if the temporally last actual repetition of the transport block 1010 associated with the greatest length has some duration (e.g., a single symbol duration) that does not satisfy the threshold duration, the one or more rules may indicate for the UE 115 to multiplex the A-CSI 1020-b on the temporally last actual repetition of the transport block 1010 associated with the greatest length that satisfies the threshold duration (e.g., a duration of at least two symbols). For example, if R3 of TB1 has a single symbol duration, the UE 115 may multiplex the A-CSI 1020-b on R2 of TB1 if R2 of TB1 has a duration of at least two symbols.

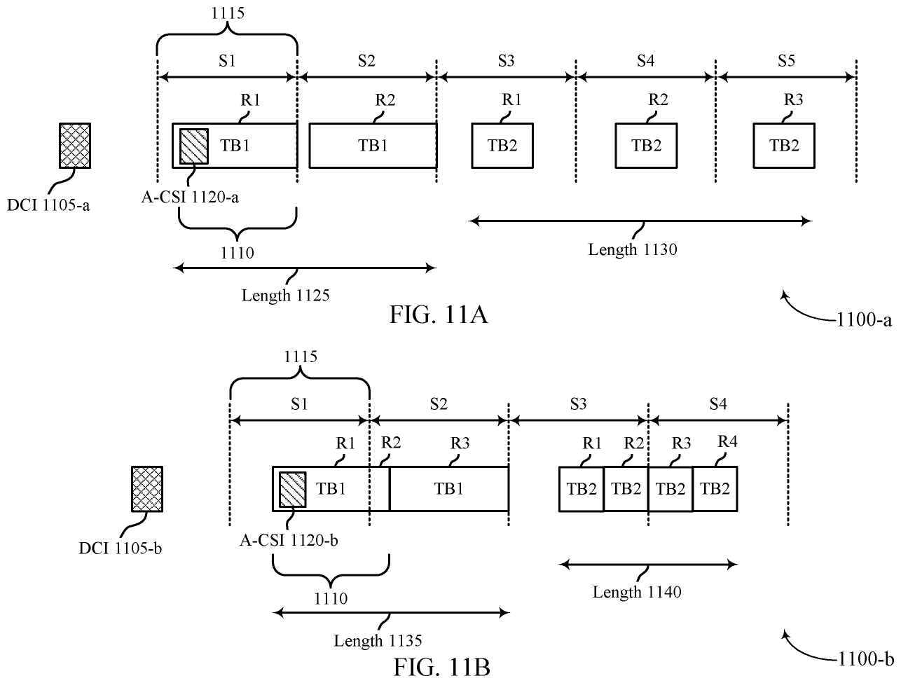

FIG. 11A illustrates an example of a multiplexing scheme 1100-a that supports techniques for CSI multiplexing on multiple PUSCH repetitions in accordance with aspects of the present disclosure. The multiplexing scheme 1100-a depicts DCI 1105-a transmitted by a base station 105 that schedules multiple PUSCH repetitions over multiple transport blocks 1110 according to a PUSCH repetition type A. For example, the DCI 1105-a may schedule PUSCH repetitions over repetitions (e.g., R1, R2, and so forth) of transport blocks 1110 (e.g., TB1 and TB2) spanning a quantity of slots 1115 in a time domain (e.g., spanning slots S1, S2, S3, S4, and S5). In the example of FIG. 11A, a first transport block 1110 (e.g., TB1) may include a first repetition (e.g., R1) and a second repetition (e.g., R2), and a second transport block 1110 (e.g., TB2) may include a first repetition R1, a second repetition R2, and a third repetition R3, with each slot 1115 including a single repetition of a transport block 1110.

Additionally, TB1 may be associated with a first length (e.g., a quantity of symbol periods) indicated by a first SLIV, and TB2 may be associated with a second length indicated by a second SLIV. Accordingly, the repetitions (e.g., R1, R2) of TB1 may each have the first length, and the repetitions (e.g., R1, R2, R3) of TB2 may each have the second length. TB1 may also be associated with a length 1125, which corresponds to the length across the repetitions of TB1. For example, if the first length is thirteen symbols, the length 1125 may correspond to a length of twenty-six symbols across the two repetitions of TB1. Additionally, TB2 may be associated with a length 1130 corresponding to the length across the repetitions of TB2. For example, if the second length is eight symbols, the length 1130 may correspond to a length of twenty-four symbols across the three repetitions of TB2. In the example of FIG. 11A, the length 1125 may be greater than the length 1130.

In response to receiving the DCI 1105-a, one or more rules may indicate for a UE 115 to multiplex A-CSI 1120-a on a temporally first repetition of a transport block 1110 having the greatest length across repetitions of the transport block 1110. The UE 115 may determine the length 1125 and the length 1130 and may determine that the length 1125 is greater than the length 1130. In accordance with the one or more rules, the UE 115 may multiplex the A-CSI 1120-a on the first repetition (e.g., R1) of TB1 (e.g., corresponding to an earliest repetition of TB1 in the time domain) and may transmit the transport blocks 1110 to the base station 105.

FIG. 11B illustrates an example of a multiplexing scheme 1100-b that supports techniques for CSI multiplexing on multiple PUSCH repetitions in accordance with aspects of the present disclosure. The multiplexing scheme 1100-b depicts DCI 1105-b transmitted by a base station 105 that schedules multiple PUSCH repetitions over multiple transport blocks 1110 according to a PUSCH repetition type B. For example, the DCI 1105-b may schedule PUSCH repetitions over repetitions of transport blocks 1110 (e.g., TB1 and TB2) spanning a quantity of slots 1115 in a time domain (e.g., spanning slots S1, S2, S3, and S4). In the example of FIG. 11B, a first transport block 1110 (e.g., TB1) may include two nominal repetitions and a second transport block 1110 (e.g., TB2) may include four nominal repetitions, where the first nominal repetition of TB1 crosses a slot boundary (e.g., the S1 boundary). Accordingly, TB1 may include three actual repetitions R1, R2, and R3, and TB2 may include four actual repetitions R1, R2, R3, and R4 (e.g., corresponding to the four nominal repetitions).

Additionally, TB1 may be associated with a first length indicated by a first SLIV, and TB2 may be associated with a second length indicated by a second SLIV. TB1 may also be associated with a length 1135 corresponding to the length (e.g., a number of symbol periods) across the repetitions of TB1. For example, if the first length is thirteen symbols, the length 1135 may correspond to a length of twenty-six symbols across the two nominal repetitions (e.g., three actual repetitions) of TB1. Additionally, TB2 may be associated with a length 1140 corresponding to the length across the repetitions of TB2. For example, if the second length is six symbols, the length 1130 may correspond to a length of twenty-four symbols across the four nominal repetitions (e.g., four actual repetitions) of TB2. In the example of FIG. 11B, the length 1135 may be greater than the length 1140.

In response to receiving the DCI 1105-b, one or more rules may indicate for a UE 115 to multiplex A-CSI 1120-b on a temporally first actual repetition of a transport block 1110 having the greatest length across repetitions of the transport block 1110. The UE 115 may determine the length 1135 and the length 1140 and may determine that the length 1135 is greater than the length 1140. Thus, in accordance with the one or more rules, the UE 115 may multiplex the A-CSI 1120-b on R1 of TB1 (e.g., corresponding to an earliest actual repetition of TB1 in the time domain) and may transmit the transport blocks 1110 to the base station 105.

In some examples, the UE 115 may expect that the temporally first actual repetition of the transport block 1110 having the greatest length across repetitions of the transport block 1110 has a threshold duration (e.g., a duration of at least two symbols). In some other examples, if the temporally first actual repetition of the transport block 1110 having the greatest length across repetitions of the transport block 1110 has a duration that does not satisfy the threshold duration (e.g., a single symbol duration), the one or more rules may indicate for the UE 115 to multiplex the A-CSI 1120-b on the temporally first actual repetition of the transport block 1110 having the greatest length across repetitions of the transport block 1110 that satisfies the threshold duration. For example, if R1 of TB1 has a single symbol duration, the UE 115 may multiplex the A-CSI 1120-b on R2 of TB1 if R2 of TB1 has a duration of at least two symbols.

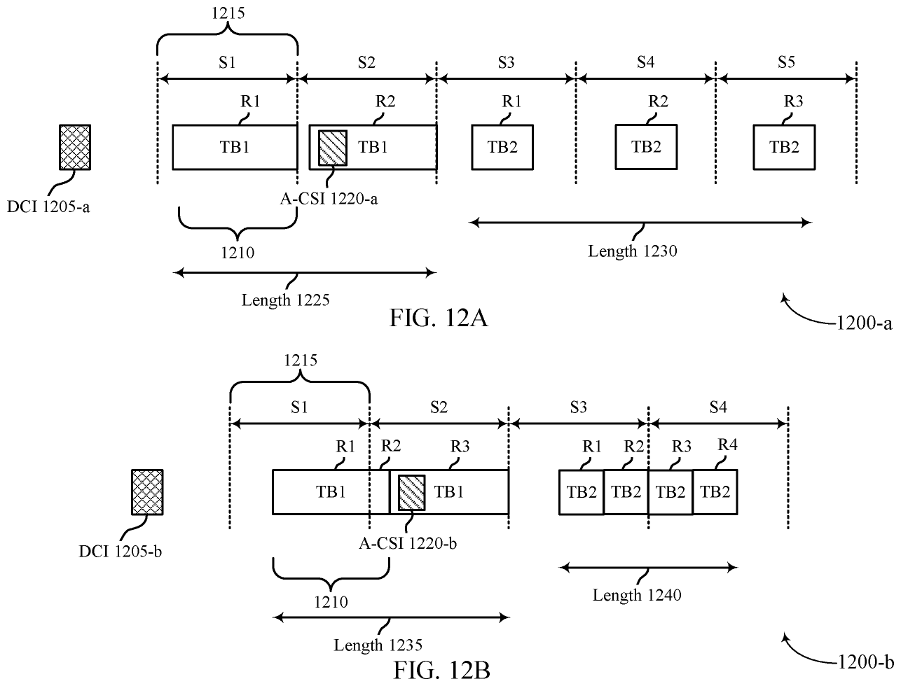

FIG. 12A illustrates an example of a multiplexing scheme 1200-a that supports techniques for CSI multiplexing on multiple PUSCH repetitions in accordance with aspects of the present disclosure. The multiplexing scheme 1200-a depicts DCI 1205-a transmitted by a base station 105 that schedules multiple PUSCH repetitions over multiple transport blocks 1210 according to a PUSCH repetition type A. For example, the DCI 1205-a may schedule PUSCH repetitions over repetitions (e.g., R1, R2, and so forth) of transport blocks 1210 (e.g., TB1 and TB2) spanning a quantity of slots 1215 in a time domain (e.g., spanning slots S1, S2, S3, S4, and S5). In the example of FIG. 12A, a first transport block 1210 (e.g., TB1) may include a first repetition (e.g., R1) and a second repetition (e.g., R2), and a second transport block 1210 (e.g., TB2) may include a first repetition R1, a second repetition R2, and a third repetition R3, with each slot 1215 including a single repetition of a transport block 1210.

Additionally, TB1 may be associated with a first length (e.g., a symbol length corresponding to a number of symbol periods of a transport block 1210), indicated by a first SLIV, and TB2 may be associated with a second length indicated by a second SLIV. TB1 may also be associated with a length 1225 corresponding to the length across the repetitions (e.g., R1, R2) of TB1. For example, if the first length is thirteen symbols, the length 1225 may correspond to a length of twenty-six symbols across the two repetitions of TB1. Additionally, TB2 may be associated with a length 1230 corresponding to the length across the repetitions (e.g., R1, R2, R3) of TB2. For example, if the second length is eight symbols, the length 1230 may correspond to a length of twenty-four symbols across the three repetitions of TB2. In the example of FIG. 12A, the length 1225 may be greater than the length 1230.

In response to receiving the DCI 1205-a, one or more rules may indicate for a UE 115 to multiplex A-CSI 1220-a on a temporally last repetition of a transport block 1210 having the greatest length across repetitions of the transport block 1210. The UE 115 may determine the length 1225 and the length 1230 and may determine that the length 1225 is greater than the length 1230. Accordingly, in accordance with the one or more rules, the UE 115 may multiplex the A-CSI 1220-a on a second repetition (e.g., R2) of TB1 (e.g., corresponding to a last repetition of TB1 in the time domain) and may transmit the transport blocks 1210 to the base station 105.

FIG. 12B illustrates an example of a multiplexing scheme 1200-b that supports techniques for CSI multiplexing on multiple PUSCH repetitions in accordance with aspects of the present disclosure. The multiplexing scheme 1200-b depicts DCI 1205-b transmitted by a base station 105 that schedules multiple PUSCH repetitions over multiple transport blocks 1210 according to a PUSCH repetition type B. For example, the DCI 1205-b may schedule PUSCH repetitions over repetitions of transport blocks 1210 (e.g., TB1 and TB2) spanning a quantity of slots 1215 in a time domain (e.g., spanning slots S1, S2, S3, and S4). In the example of FIG. 12B, a first transport block (e.g., TB1) may include two nominal repetitions and a second transport block (e.g., TB2) may include four nominal repetitions, where the first nominal repetition of TB1 crosses a slot boundary (e.g., the boundary between S1 and S2). Accordingly, TB1 may include three actual repetitions R1, R2, and R3, and TB2 may include four actual repetitions R1, R2, R3, and R4 (e.g., corresponding to the four nominal repetitions).

Additionally, TB1 may be associated with a first length indicated by a first SLIV, and TB2 may be associated with a second length indicated by a second SLIV. TB1 may also be associated with a length 1225 corresponding to the length across the repetitions of TB1. For example, if the first length is thirteen symbols, the length 1235 may correspond to a length of twenty-six symbols across the two nominal repetitions (e.g., three actual repetitions) of TB1. Additionally, TB2 may be associated with a length 1240 corresponding to the length across the repetitions of TB2. For example, if the second length is six symbols, the length 1240 may correspond to a length of twenty-four symbols across the four nominal repetitions (e.g., four actual repetitions) of TB2. In the example of FIG. 12B, the length 1235 may be greater than the length 1240.

In response to receiving the DCI 1205-b, one or more rules may indicate for a UE 115 to multiplex A-CSI 1220-b on a temporally last actual repetition of a transport block 1210 having the greatest length across repetitions of the transport block 1210. The UE 115 may determine the length 1235 and the length 1240 and may determine that the length 1235 is greater than the length 1240. In accordance with the one or more rules, the UE 115 may multiplex the A-CSI 1220-b on R3 of TB1 (e.g., corresponding to a last actual repetition of TB1 in the time domain) and may transmit the transport blocks 1210 to the base station 105.

In some examples, the UE 115 may expect that the temporally last actual repetition of the transport block 1210 having the greatest length across repetitions of the transport block 1210 has a threshold duration (e.g., a duration of at least two symbols). In some aspects, if the temporally last actual repetition of the transport block 1210 having the greatest length across repetitions of the transport block 1210 has a duration (e.g., a single symbol duration) that is less than the threshold duration, the one or more rules may indicate for the UE 115 to multiplex the A-CSI 1220-b on the temporally last actual repetition of the transport block 1210 having the greatest length across repetitions of the transport block 1210 that has the threshold duration (e.g., of at least two symbols). For example, if R3 of TB1 has a single symbol duration, the UE 115 may multiplex the A-CSI 1220-b on R2 of TB1 if R2 of TB1 has a duration of at least two symbols.

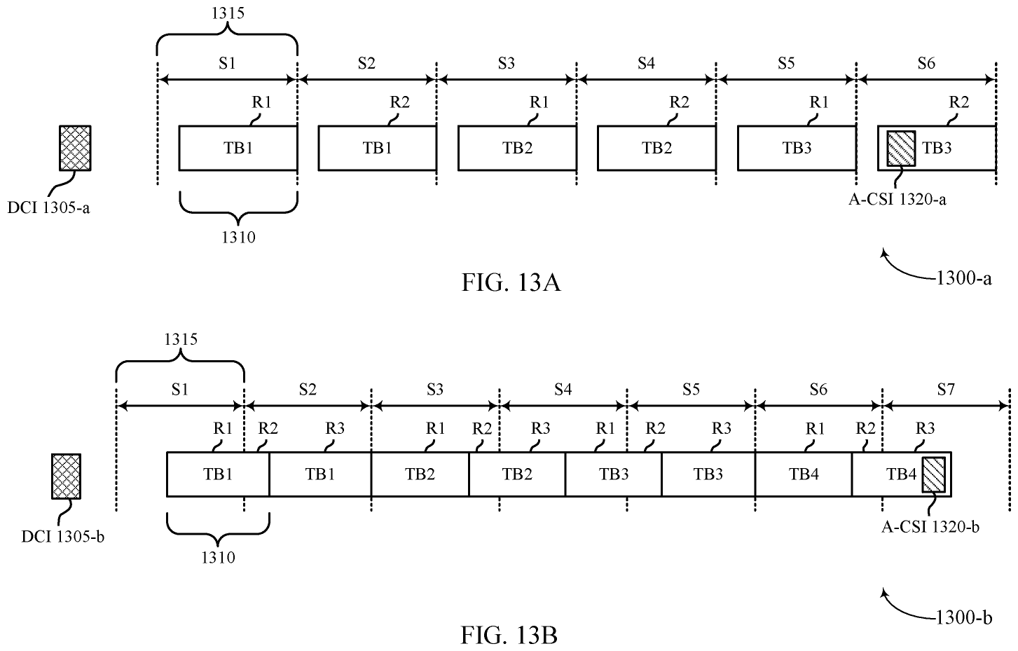

FIG. 13A illustrates an example of a multiplexing scheme 1300-a that supports techniques for CSI multiplexing on multiple PUSCH repetitions in accordance with aspects of the present disclosure. The multiplexing scheme 1300-a depicts DCI 1305-a transmitted by a base station 105 that schedules multiple PUSCH repetitions over multiple transport blocks 1310 according to a PUSCH repetition type A. For example, the DCI 1305-a may schedule PUSCH repetitions over repetitions (e.g., R1, R2, and so forth) of transport blocks 1310 (e.g., TB1, TB2, and TB3) spanning a quantity of slots 1315 in a time domain (e.g., spanning slots S1, S2, S3, S4, S5, and S6). In the example of FIG. 13A, each of the transport blocks 1310 may include a first repetition (e.g., R1) and a second repetition (e.g., R2) with each slot 1315 including a single repetition of a transport block 1310.

In response to receiving the DCI 1305-a, one or more rules may indicate for a UE 115 to multiplex A-CSI 1320-a on a temporally last repetition of a temporally last transport block 1310. That is, the one or more rules may indicate for the ULE 115 to multiplex the A-CSI 1320-a on a last repetition of a last transport block 1310 in the time domain. Accordingly, in accordance with the one or more rules, the UE 115 may multiplex the A-CSI 1320-a on a second repetition (e.g., R2) of TB3 (e.g., corresponding to the last repetition of TB3 in the time domain) and may transmit the transport blocks 1310 to the base station 105.

FIG. 13B illustrates an example of a multiplexing scheme 1300-b that supports techniques for CSI multiplexing on multiple PUSCH repetitions in accordance with aspects of the present disclosure. The multiplexing scheme 1300-b depicts DCI 1305-b transmitted by a base station 105 that schedules multiple PUSCH repetitions over multiple transport blocks 1310 according to a PUSCH repetition type B. For example, the DCI 1305-b may schedule PUSCH repetitions over repetitions of transport blocks 1310 (e.g., TB1, TB2, TB3, and TB4) spanning a quantity of slots 1315 in a time domain (e.g., spanning slots S1, S2, S3, S4, S5, S6, and S7). In the example of FIG. 13B, each of the transport blocks 1310 may include two nominal repetitions, where the first nominal repetition of TB1 crosses a slot boundary (e.g., a boundary between slot S1 and slot S2), the second nominal repetition of TB2 may cross a slot boundary (e.g., a boundary between slot S3 and slot S4), the first nominal repetition of TB3 crosses a slot boundary (e.g., a boundary between slot S4 and slot S5), and the second nominal repetition of TB4 crosses a slot boundary (e.g., a boundary between slot S6 and slot S7). Accordingly, in this example, each of the transport blocks TB1, TB2, TB3, and TB4 may include three actual repetitions R1, R2, and R3.

In response to receiving the DCI 1305-b, one or more rules may indicate for a UE 115 to multiplex A-CSI 1320-b on a temporally last actual repetition of a temporally last transport block 1310. That is, the one or more rules may indicate for the UE 115 to multiplex the A-CSI 1320-b on a last actual repetition of a last transport block 1310 in the time domain. Accordingly, in accordance with the one or more rules, the UE 115 may multiplex the A-CSI 1320-b on R3 of TB4 (e.g., corresponding to the last actual repetition of TB4) and may transmit the transport blocks 1310 to the base station 105.

In some examples, the UE 115 may expect that the temporally last actual repetition of the temporally last transport block 1310 has a threshold duration (e.g., duration of at least two symbols). In cases where the temporally last actual repetition of the temporally last transport block 1310 has a single symbol duration, the one or more rules may indicate for the UE 115 to multiplex the A-CSI 1320-b on the temporally last actual repetition of the temporally last transport block 1310 that has a duration of at least two symbols. For example, if R3 of TB4 has a single symbol duration, the UE 115 may multiplex the A-CSI 1320-b on R2 of TB4 if R2 of TB4 has a duration of at least two symbols.

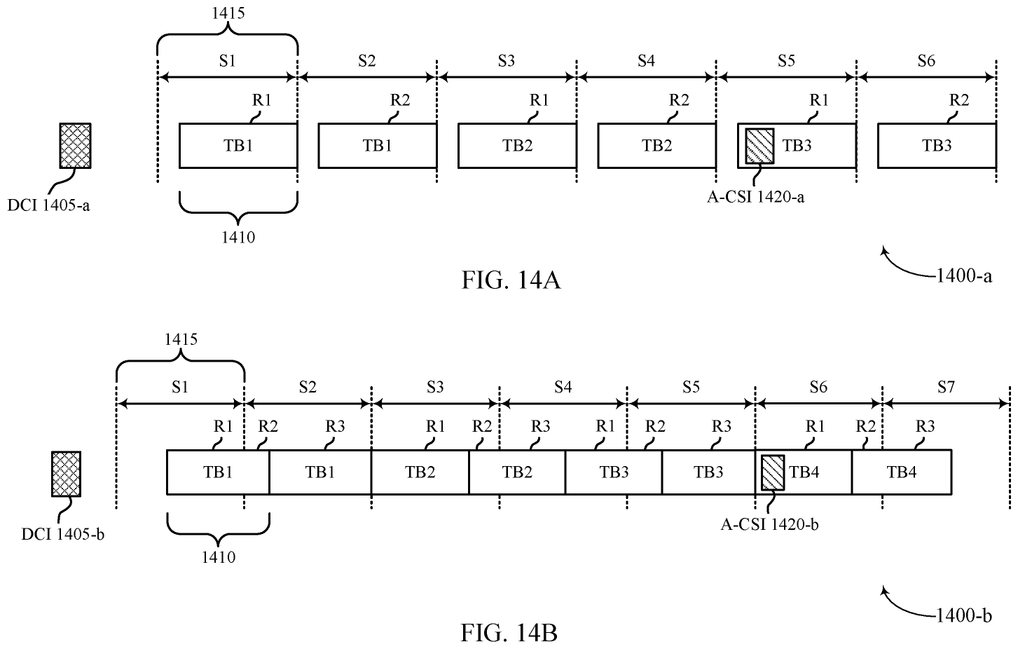

FIG. 14A illustrates an example of a multiplexing scheme 1400-a that supports techniques for CSI multiplexing on multiple PUSCH repetitions in accordance with aspects of the present disclosure. The multiplexing scheme 1400-a depicts DCI 1405-a transmitted by a base station 105 that schedules multiple PUSCH repetitions over multiple transport blocks 1410 according to a PUSCH repetition type A. For example, the DCI 1405-a may schedule PUSCH repetitions over repetitions (e.g., R1, R2) of transport blocks 1410 (e.g., TB1, TB2, and TB3) spanning a quantity of slots 1415 in a time domain (e.g., spanning slots S1, S2, S3, S4, S5, and S6). In the example of FIG. 14A, each of the transport blocks 1410 may include a first repetition (e.g., R1) and a second repetition (e.g., R2) with each slot 1415 including a single repetition of a transport block 1410.

In response to receiving the DCI 1405-a, one or more rules may indicate for a UE 115 to multiplex A-CSI 1420-a on a temporally first repetition of a temporally last transport block 1410. That is, the one or more rules may indicate for the ULE 115 to multiplex the A-CSI 1420-a on an earliest repetition of a last transport block 1410 in the time domain. As a result, in accordance with the one or more rules, the UE 115 may multiplex the A-CSI 1420-a on a first repetition (e.g., R1) of TB3 (e.g., corresponding to the earliest repetition of TB3 in the time domain) and may transmit the transport blocks 1410 to the base station 105.

FIG. 14B illustrates an example of a multiplexing scheme 1400-b that supports techniques for CSI multiplexing on multiple PUSCH repetitions in accordance with aspects of the present disclosure. The multiplexing scheme 1400-b depicts DCI 1405-b transmitted by a base station 105 that schedules multiple PUSCH repetitions over multiple transport blocks 1410 according to a PUSCH repetition type B. For example, the DCI 1405-b may schedule PUSCH repetitions over repetitions of transport blocks 1410 (e.g., TB1, TB2, TB3, and TB4) spanning a quantity of slots 1415 in a time domain (e.g., spanning slots S1, S2, S3, S4, S5, S6, and S7). In the example of FIG. 14B, each of the transport blocks 1410 may include two nominal repetitions, where the first nominal repetition of TB1 crosses a slot boundary (e.g., a boundary between slot S1 and slot S2), the second nominal repetition of TB2 crosses a slot boundary (e.g., a boundary between slot S3 and slot S4), the first nominal repetition of TB3 crosses a slot boundary (e.g., a boundary between slot S4 and slot S5), and the second nominal repetition of TB4 crosses a slot boundary (e.g., a boundary between slot S6 and slot S7). Accordingly, in this example, each of the transport blocks TB1, TB2, TB3, and TB4 may include three actual repetitions R1, R2, and R3.

In response to receiving the DCI 1405-b, one or more rules may indicate for a UE 115 to multiplex A-CSI 1420-b on a temporally first actual repetition of a temporally last transport block 1410. That is, the one or more rules may indicate for the UE 115 to multiplex the A-CSI 1420-b on a first actual repetition of a last transport block 1410 in the time domain. Accordingly, in accordance with the one or more rules, the UE 115 may multiplex the A-CSI 1420-b on R1 of TB4 (e.g., corresponding to the earliest actual repetition of TB4) and may transmit the transport blocks 1410 to the base station 105.

In some examples, the UE 115 may expect that the temporally first actual repetition of the temporally last transport block 1410 has a threshold duration (e.g., a minimum duration, a duration of at two or more symbols). In some other examples, if the temporally first actual repetition of the temporally last transport block 1410 has some duration (e.g., a single symbol duration) that does not satisfy the threshold duration, the one or more rules may indicate for the UE 115 to multiplex the A-CSI 1420-b on the temporally first actual repetition of the temporally last transport block 1410 that satisfies the threshold duration (e.g., two or more symbols). For example, if R1 of TB4 has a single symbol duration, the UE 115 may multiplex the A-CSI 1420-b on R2 of TB4 if R2 of TB4 has a duration of at least two symbols.

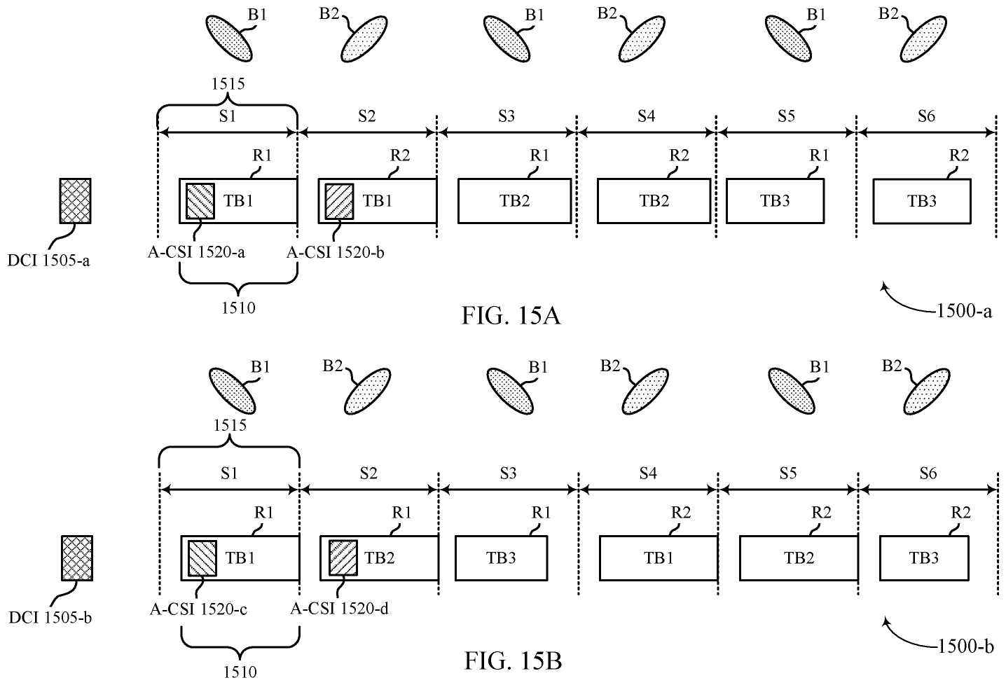

FIGS. 15A through 28B illustrate examples of multiplexing schemes that support techniques for CSI multiplexing on multiple PUSCH repetitions in accordance with aspects of the present disclosure. Specifically, the multiplexing schemes described with reference to FIGS. 15A, 15B, 16A, 16B, 17A, 17B, 18A, 18B, 19A, 19B, 20A, 20B, 21A, 21B, 22A, 22B, 23A, 23B, 24A, 24B, 25A, 25B, 26A, 26B, 27A, 27B, 28A, 28B, 29A, and 29B depict various rules for multiplexing A-CSI on multiple transport block repetitions in response to receiving DCI that schedules multiple PUSCHs (e.g., multiple repetitions of a single PUSCH, one or more repetitions of multiple PUSCHs) over multiple transport blocks (e.g., multiple repetitions of a single transport block, one or more repetitions of multiple transport blocks), where a first subset of the multiple transport blocks are transmitted using a first beam and a second subset of the multiple transport blocks are transmitted using a second beam different from the first beam. The multiplexing schemes may be implemented by aspects of the wireless communications system 100 and 200 as described with reference to FIGS. 1 and 2, respectively. For example, the multiplexing schemes may be implemented by a UE 115 and a base station 105 to support A-CSI reporting when PUSCH repetitions are scheduled over multiple transport blocks (e.g., repetitions of one or more transport blocks).

FIG. 15A illustrates an example of a multiplexing scheme 1500-a that supports techniques for CSI multiplexing on multiple PUSCH repetitions in accordance with aspects of the present disclosure. The multiplexing scheme 1500-a depicts DCI 1505-a transmitted by a base station 105 that schedules multiple PUSCH repetitions over multiple transport blocks 1510 according to a PUSCH repetition type A and a sequential transport block mapping. For example, the DCI 1505-a may schedule PUSCH repetitions over repetitions (e.g., R1, R2, and so forth) of transport blocks 1510 (e.g., TB1, TB2, and TB3) spanning a quantity of slots 1515 in a time domain (e.g., spanning slots S1, S2, S3, S4, S5, and S6). Additionally, the transport blocks 1510 may be sequentially mapped. That is, in the time domain, the repetitions of a first transport block 1510 may occur before the repetitions of another transport block 1510. For example, the repetitions of TB1 may be followed by the repetitions of TB2, which may be followed by the repetitions of TB3. In the example of FIG. 15A, each of the transport blocks 1510 may include a first repetition (e.g., R1) and a second repetition (e.g., R2) with each slot 1515 including a single repetition of a transport block 1510.

A UE 115 may be configured (e.g., via the DCI 1505-a) to transmit a first subset of the repetitions of the transport blocks 1510 using a first beam (e.g., B1) and a second subset of the repetitions of the transport blocks 1510 using a second beam (e.g., B2), where B1 and B2 may be different beams. For example, the UE 115 may be configured to transmit R1 of TB1, R1 of TB2, and R1 of TB3 using B1 and R2 of TB1, R2 of TB2, and R2 of TB3 using B2.

In response to receiving the DCI 1505-a, the UE 115 may multiplex A-CSI 1520 on transmission occasions for each beam (e.g., B1, B2) in accordance with one or more rules. In the example of FIG. 15A, the one or more rules may indicate for the UE 115 to multiplex A-CSI 1520 on temporally first transmission occasions associated with each beam. For example, the one or more rules may indicate for the UE 115 to multiplex A-CSI 1520-a on a temporally first transmission occasion that is transmitted using B1 and A-CSI 1520-b on a temporally first transmission occasion that is transmitted using B2. Accordingly, in accordance with the one or more rules, the UE 115 may multiplex the A-CSI 1520-a on R1 of TB1 and A-CSI 1520-b on R2 of TB1 and may transmit the transport blocks 1510 to the base station 105 using B1 and B2. In this way, the UE 115 may reduce a latency associated with reporting the A-CSI 1520.

FIG. 15B illustrates an example of a multiplexing scheme 1500-b that supports techniques for CSI multiplexing on multiple PUSCH repetitions in accordance with aspects of the present disclosure. The multiplexing scheme 1500-b depicts DCI 1505-b transmitted by a base station 105 that schedules multiple PUSCH repetitions over multiple transport blocks 1510 according to a PUSCH repetition type A and an interlaced transport block mapping. For example, the DCI 1505-b may schedule PUSCH repetitions over repetitions (e.g., R1, R2, and so forth) of transport blocks 1510 (e.g., TB1, TB2, and TB3) spanning a quantity of slots 1515 in a time domain (e.g., spanning slots S1, S2, S3, S4, S5, and S6) and indicate an interlaced mapping for the transport blocks 1510. An interlaced mapping may correspond to, in the time domain, a first repetition for each transport block 1510 occurring before a next repetition for each transport block 1510. For example, each of the transport blocks 1510 may include a first repetition (e.g., R1) and a second repetition (e.g., R2) with each slot 1515 including a single repetition of a transport block 1510. In accordance with the interlaced mapping, R1 of each of TB1, TB2, and TB3 may be followed by R2 of each of TB1, TB2, and TB3.

A UE 115 may be configured (e.g., via the DCI 1505-b) to transmit a first subset of the repetitions of the transport blocks 1510 using a first beam (e.g., B1) and a second subset of the repetitions of the transport blocks 1510 using a second beam (e.g., B2), where B1 and B2 may correspond to different directional beams. For example, the UE 115 may be configured to transmit R1 of TB1, R1 of TB3, and R2 of TB2 using B1 and R1 of TB2, R2 of TB1, and R2 of TB3 using B2.

In response to receiving the DCI 1505-b, the UE 115 may multiplex A-CSI 1520 on transmission occasions for each beam in accordance with one or more rules that indicate for the UE 115 to multiplex A-CSI 1520 on temporally first transmission occasions associated with each beam. For example, the one or more rules may indicate for the UE 115 to multiplex A-CSI 1520-c on a temporally first transmission occasion that is transmitted using B1 and A-CSI 1520-d on a temporally first transmission occasion that is transmitted using B2. Accordingly, in accordance with the one or more rules, the UE 115 may multiplex the A-CSI 1520-c on R1 of TB1 and A-CSI 1520-d on R1 of TB2 and may transmit the transport blocks 1510 to the base station 105 using B1 and B2. In this way, the UE 115 may reduce a latency associated with reporting the A-CSI 1520.

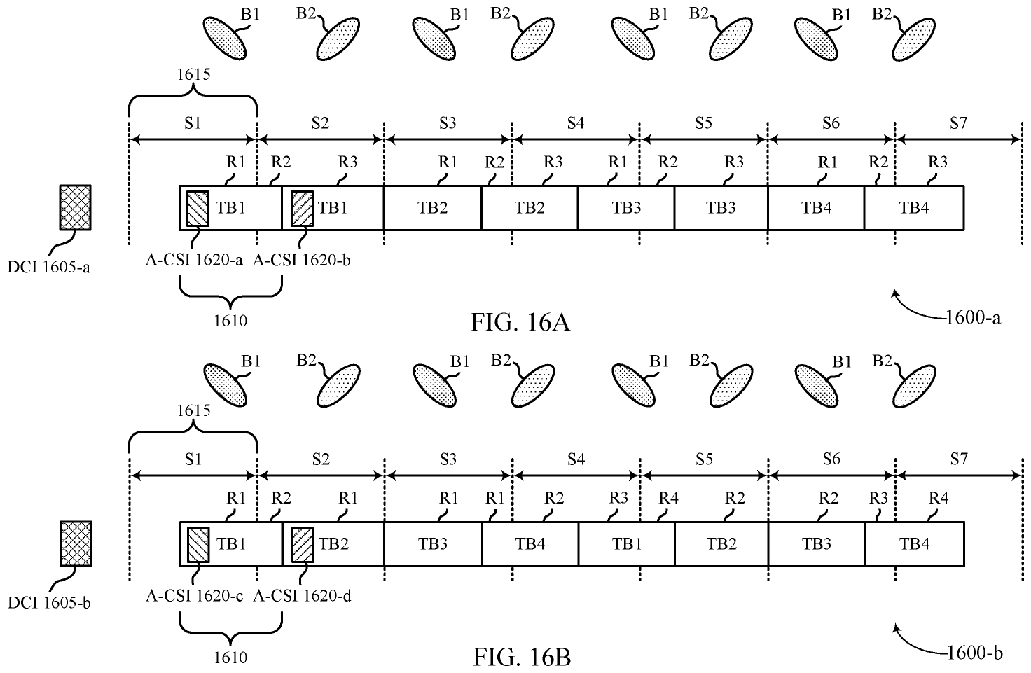

FIG. 16A illustrates an example of a multiplexing scheme 1600-a that supports techniques for CSI multiplexing on multiple PUSCH repetitions in accordance with aspects of the present disclosure. The multiplexing scheme 1600-a depicts DCI 1605-a transmitted by a base station 105 that schedules multiple PUSCH repetitions over multiple transport blocks 1610 according to a PUSCH repetition type B and a sequential transport block mapping. For example, the DCI 1605-a may schedule PUSCH repetitions over repetitions of transport blocks 1610 (e.g., TB1, TB2, TB3, and TB4) spanning a quantity of slots 1615 in a time domain (e.g., spanning slots S1, S2, S3, S4, S5, S6, and S7) and indicate that the repetitions of the TB1, TB2, TB3, and TB4 are sequentially mapped. In the example of FIG. 16B, each of the transport blocks 1610 may include two nominal repetitions, where the first nominal repetition of TB1 crosses a slot boundary (e.g., the S1 boundary), the second nominal repetition of TB2 crosses a slot boundary (e.g., the S3 boundary), the first nominal repetition of TB3 crosses a slot boundary (e.g., the S4 boundary), and the second nominal repetition of TB4 crosses a slot boundary (e.g., the S6 boundary). Accordingly, in this example, each of the transport blocks TB1, TB2, TB3, and TB4 may include three actual repetitions R1, R2, and R3.

A UE 115 may be configured (e.g., via the DCI 1605-a) to transmit a first subset of the repetitions of the transport blocks 1610 using a first beam (e.g., B1) and a second subset of the repetitions of the transport blocks 1610 using a second beam (e.g., B2). That is, different repetitions of transport blocks 1610 may be transmitted using different beams. In some examples, the first subset and the second subset may correspond to the nominal repetitions of TB1, TB2, TB3, and TB4. For example, the UE 115 may be configured to transmit the first nominal repetition of TB1, TB2, TB3, and TB4 using B1 and the second nominal repetition of TB1, TB2, TB3, and TB4 using B2. As a result, the UE 115 may transmit R1 of TB1, R2 of TB1, R1 of TB2, R1 of TB3, R2 of TB3, and R1 of TB4 using B1 and R3 of TB1, R2 of TB2, R3 of TB2, R3 of TB3, R2 of TB4, and R3 of TB4 using B2.

In response to receiving the DCI 1605-a, the UE 115 may multiplex A-CSI 1620 on transmission occasions for each beam in accordance with one or more rules that indicate for the UE 115 to multiplex A-CSI 1620 on temporally first transmission occasions associated with each beam (e.g., that have a duration of at least two symbols). For example, the one or more rules may indicate for the UE 115 to multiplex A-CSI 1620-a on a temporally first transmission occasion that is transmitted using B1 and A-CSI 1620-b on a temporally first transmission occasion that is transmitted using B2. In accordance with the one or more rules, the UE 115 may multiplex the A-CSI 1620-a on R1 of TB1 (e.g., corresponding to the temporally first actual repetition of the temporally first transport block 1610 associated with B1) and A-CSI 1620-b on R3 of TB1 (e.g., corresponding to the temporally first actual repetition of the temporally first transport block 1610 associated with B2) and may transmit the transport blocks 1610 to the base station 105 using B1 and B2. In this way, the UE 115 may reduce a latency associated with reporting the A-CSI 1620. In some examples, the UE 115 may expect that the temporally first transmission occasions associated with each beam have a threshold duration (e.g., a duration of at least two symbols).

FIG. 16B illustrates an example of a multiplexing scheme 1600-b that supports techniques for CSI multiplexing on multiple PUSCH repetitions in accordance with aspects of the present disclosure. The multiplexing scheme 1600-b depicts DCI 1605-b transmitted by a base station 105 that schedules multiple PUSCH repetitions over multiple transport blocks 1610 according to a PUSCH repetition type B and an interlaced transport block mapping. For example, the DCI 1605-b may schedule PUSCH repetitions over repetitions of transport blocks 1610 (e.g., TB1, TB2, TB3, and TB4) spanning a quantity of slots 1615 in a time domain (e.g., spanning slots S1, S2, S3, S4, S5, S6, and S7) and indicate an interlaced mapping for the transport blocks 1610. In the example of FIG. 16B, each of the transport blocks 1610 may include two nominal repetitions, where the first nominal repetition of TB1 crosses a slot boundary (e.g., the S1 boundary), the first nominal repetition of TB4 crosses a slot boundary (e.g., the S3 boundary), the second nominal repetition of TB1 crosses a slot boundary (e.g., the S4 boundary), and the second nominal repetition of TB4 crosses a slot boundary (e.g., the S6 boundary). Accordingly, TB1 and TB4 may include four actual repetitions R1, R2, R3, and R4, and TB2 and TB3 may include two actual repetitions R1 and R2.

A UE 115 may be configured (e.g., via the DCI 1605-b) to transmit a first subset of the repetitions of the transport blocks 1610 using a first beam (e.g., B1) and a second subset of the repetitions of the transport blocks 1610 using a second beam (e.g., B2), where the beams B1 and B2 may be different directional beams formed by the UE 115. In some examples, the first subset and the second subset may correspond to the nominal repetitions of TB1, TB2, TB3, and TB4. For example, the UE 115 may be configured to transmit the first and second nominal repetitions of TB1 and TB3 using B1 and the first and second nominal repetitions of TB2 and TB4 using B2. As a result, the UE 115 may transmit R1 of TB1, R2 of TB1, R3 of TB1, R4 of TB1, R1 of TB3, and R2 of TB3 using B1 and R1 of TB2, R2 of TB2, R1 of TB4, R2 of TB4, R3 of TB4, and R4 of TB4 using B2.

In response to receiving the DCI 1605-b, the UE 115 may multiplex A-CSI 1620 on transmission occasions for each beam in accordance with one or more rules that indicate for the UE 115 to multiplex A-CSI 1620 on temporally first transmission occasions associated with each beam (e.g., that have a duration of at least two symbols). For example, the one or more rules may indicate for the UE 115 to multiplex A-CSI 1620-c on a temporally first transmission occasion that is transmitted using B1 and A-CSI 1620-d on a temporally first transmission occasion that is transmitted using B2. Accordingly, in accordance with the one or more rules, the UE 115 may multiplex the A-CSI 1620-c on R1 of TB1 (e.g., corresponding to the temporally first actual repetition of the temporally first transport block 1610 associated with B1) and A-CSI 1620-d on R1 of TB2 (e.g., corresponding to the temporally first actual repetition of the temporally first transport block 1610 associated with B2) and may transmit the transport blocks 1610 to the base station 105 using B1 and B2. In this way, the UE 115 may reduce a latency associated with reporting the A-CSI 1620. In some examples, the UE 115 may expect that the temporally first transmission occasions associated with each beam have a threshold duration (e.g., a duration of at least two symbols).

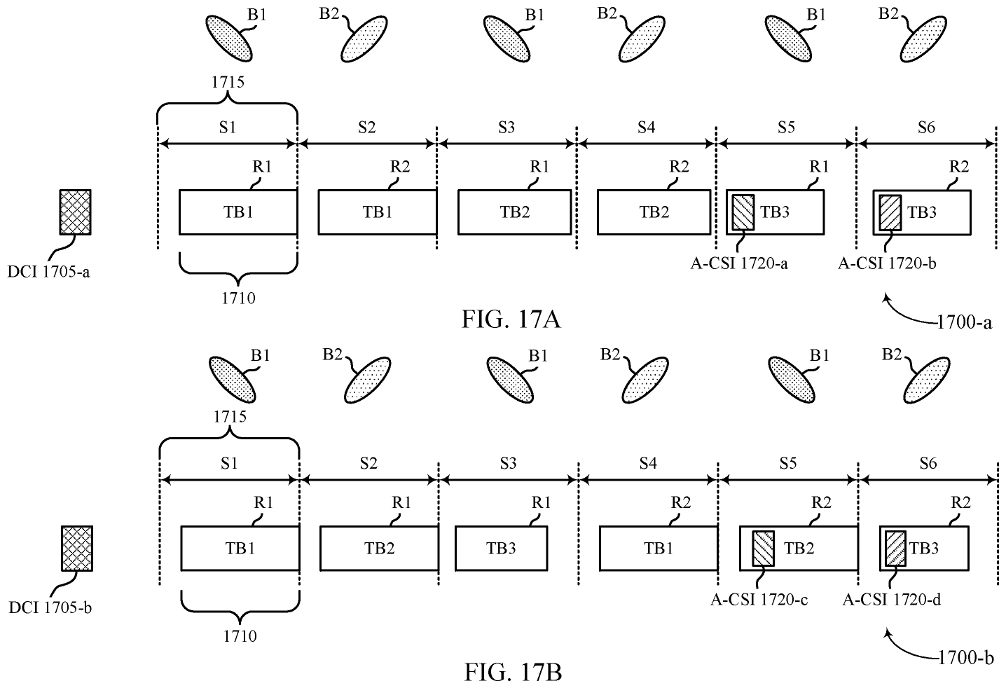

FIG. 17A illustrates an example of a multiplexing scheme 1700-a that supports techniques for CSI multiplexing on multiple PUSCH repetitions in accordance with aspects of the present disclosure. The multiplexing scheme 1700-a depicts DCI 1705-a transmitted by a base station 105 that schedules multiple PUSCH repetitions over multiple transport blocks 1710 according to a PUSCH repetition type A and a sequential transport block mapping. For example, the DCI 1705-a may schedule PUSCH repetitions over repetitions of transport blocks 1710 (e.g., TB1, TB2, and TB3) spanning a quantity of slots 1715 in a time domain (e.g., spanning slots S1, S2, S3, S4, S5, and S6) and indicate that the repetitions of the TB1, TB2, and TB3 are sequentially mapped. In the example of FIG. 17A, each of the transport blocks 1710 may include a first repetition R1 and a second repetition R2 with each slot 1715 including a single repetition of a transport block 1710.

A UE 115 may be configured (e.g., via the DCI 1705-a) to transmit a first subset of the repetitions of the transport blocks 1710 using a first beam (e.g., B1) and a second subset of the repetitions of the transport blocks 1710 using a second beam (e.g., B2), where the beams B1 and B2 may be different directional beams formed by the UE 115. For example, the UE 115 may be configured to transmit R1 of TB1, R1 of TB2, and R1 of TB3 using B1 and R2 of TB1, R2 of TB2, and R2 of TB3 using B2.

In response to receiving the DCI 1705-a, the UE 115 may multiplex A-CSI 1720 on transmission occasions for each beam in accordance with one or more rules that indicate for the UE 115 to multiplex A-CSI 1720 on temporally last transmission occasions associated with each beam. For example, the one or more rules may indicate for the UE 115 to multiplex A-CSI 1720-a on a temporally last transmission occasion that is transmitted using B1 and A-CSI 1720-b on a temporally last transmission occasion that is transmitted using B2. Accordingly, in accordance with the one or more rules, the UE 115 may multiplex the A-CSI 1720-a on R1 of TB3 and A-CSI 1720-b on R2 of TB3 and may transmit the transport blocks 1710 to the base station 105 using B1 and B2.

FIG. 17B illustrates an example of a multiplexing scheme 1700-b that supports techniques for CSI multiplexing on multiple PUSCH repetitions in accordance with aspects of the present disclosure. The multiplexing scheme 1700-b depicts DCI 1705-b transmitted by a base station 105 that schedules multiple PUSCH repetitions over multiple transport blocks 1710 according to a PUSCH repetition type A and an interlaced transport block mapping. For example, the DCI 1705-b may schedule PUSCH repetitions over repetitions of transport blocks 1710 (e.g., TB1, TB2, and TB3) spanning a quantity of slots 1715 in a time domain (e.g., spanning slots S1, S2, S3, S4, S5, and S6) and indicate an interlaced mapping for the transport blocks 1710. In the example of FIG. 17B, each of the transport blocks 1710 may include a first repetition R1 and a second repetition R2 with each slot 1715 including a single repetition of a transport block 1710.

A UE 115 may be configured (e.g., via the DCI 1705-b) to transmit a first subset of the repetitions of the transport blocks 1710 using a first beam (e.g., B1) and a second subset of the repetitions of the transport blocks 1710 using a second beam (e.g., B2), where the beams B1 and B2 may be different directional beams formed by the UE 115. For example, the UE 115 may be configured to transmit R1 of TB1, R1 of TB3, and R2 of TB2 using B1 and R1 of TB2, R2 of TB1, and R2 of TB3 using B2.

In response to receiving the DCI 1705-b, the UE 115 may multiplex A-CSI 1720 on transmission occasions for each beam in accordance with one or more rules that indicate for the UE 115 to multiplex A-CSI 1720 on temporally last transmission occasions associated with each beam. For example, the one or more rules may indicate for the UE 115 to multiplex A-CSI 1720-c on a temporally last transmission occasion that is transmitted using B1 and A-CSI 1720-d on a temporally last transmission occasion that is transmitted using B2. Accordingly, in accordance with the one or more rules, the UE 115 may multiplex the A-CSI 1720-c on R2 of TB2 and A-CSI 1720-d on R2 of TB3 and may transmit the transport blocks 1710 to the base station 105 using B1 and B2.

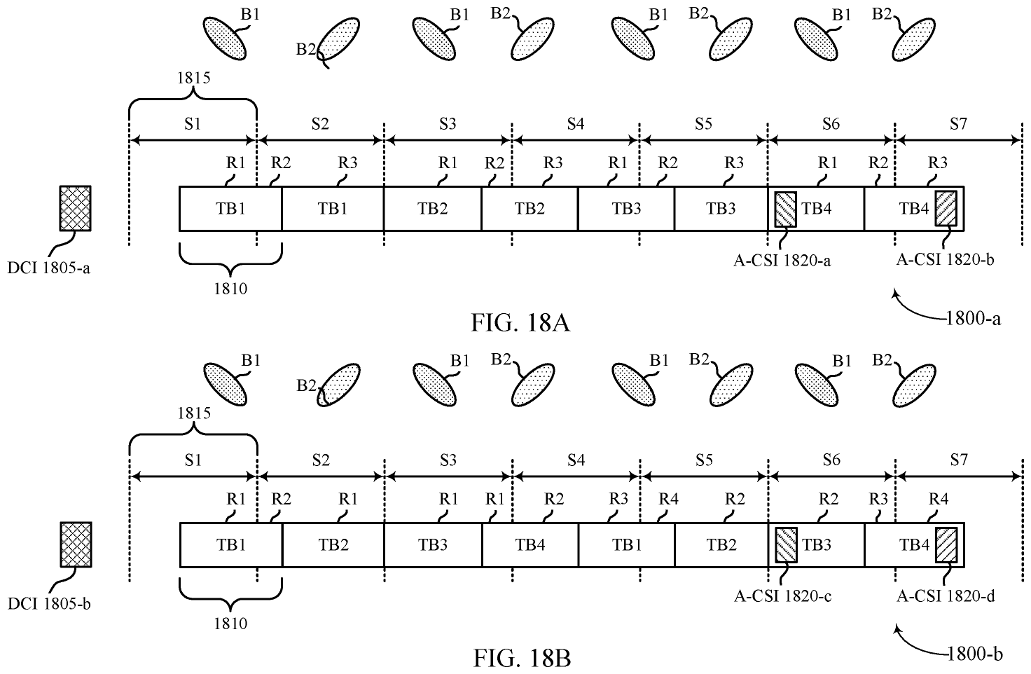

FIG. 18A illustrates an example of a multiplexing scheme 1800-a that supports techniques for CSI multiplexing on multiple PUSCH repetitions in accordance with aspects of the present disclosure. The multiplexing scheme 1800-a depicts DCI 1805-a transmitted by a base station 105 that schedules multiple PUSCH repetitions over multiple transport blocks 1810 according to a PUSCH repetition type B and a sequential transport block mapping. For example, the DCI 1805-a may schedule PUSCH repetitions over repetitions of transport blocks 1810 (e.g., TB1, TB2, TB3, and TB4) spanning a quantity of slots 1815 in a time domain (e.g., spanning slots S1, S2, S3, S4, S5, S6, and S7) and indicate that the repetitions of the TB1, TB2, TB3, and TB4 are sequentially mapped. In the example of FIG. 18A, each of the transport blocks 1810 may include two nominal repetitions, where the first nominal repetition of TB1 crosses a slot boundary (e.g., the S1 boundary), the second nominal repetition of TB2 crosses a slot boundary (e.g., the S3 boundary), the first nominal repetition of TB3 crosses a slot boundary (e.g., the S4 boundary), and the second nominal repetition of TB4 crosses a slot boundary (e.g., the S6 boundary). In such examples, each of the transport blocks TB1, TB2, TB3, and TB4 may include three actual repetitions R1, R2, and R3.

A UE 115 may be configured (e.g., via the DCI 1805-a) to transmit a first subset of the repetitions of the transport blocks 1810 using a first beam (e.g., B1) and a second subset of the repetitions of the transport blocks 1810 using a second beam (e.g., B2), where the beams B1 and B2 may be different directional beams formed by the UE 115. In some examples, the first subset and the second subset may correspond to the nominal repetitions of TB1, TB2, TB3, and TB4. For example, the UE 115 may be configured to transmit the first nominal repetition of TB1, TB2, TB3, and TB4 using B1 and the second nominal repetition of TB1, TB2, TB3, and TB4 using B2. As a result, the UE 115 may transmit R1 of TB1, R2 of TB1, R1 of TB2, R1 of TB3, R2 of TB3, and R1 of TB4 using B1 and R3 of TB1, R2 of TB2, R3 of TB2, R3 of TB3, R2 of TB4, and R3 of TB4 using B2.

In response to receiving the DCI 1805-a, the UE 115 may multiplex A-CSI 1820 on transmission occasions for each beam in accordance with one or more rules that indicate for the UE 115 to multiplex A-CSI 1820 on temporally last transmission occasions associated with each beam (e.g., that have a duration of at least two symbols). For example, the one or more rules may indicate for the UE 115 to multiplex A-CSI 1820-a on a temporally last transmission occasion that is transmitted using B1 and A-CSI 1820-b on a temporally last transmission occasion that is transmitted using B2. Accordingly, in accordance with the one or more rules, the UE 115 may multiplex the A-CSI 1820-a on R1 of TB4 (e.g., corresponding to the temporally last actual transmission occasion associated with B1) and A-CSI 1820-b on R3 of TB4 (e.g., corresponding to the temporally last actual transmission occasion associated with B2) and may transmit the transport blocks 1810 to the base station 105 using B1 and B2. In some examples, the UE 115 may expect that the temporally last transmission occasions associated with each beam have a threshold duration (e.g., a duration of at two or more symbols).

FIG. 18B illustrates an example of a multiplexing scheme 1800-b that supports techniques for CSI multiplexing on multiple PUSCH repetitions in accordance with aspects of the present disclosure. The multiplexing scheme 1800-b depicts DCI 1805-b transmitted by a base station 105 that schedules multiple PUSCH repetitions over multiple transport blocks 1810 according to a PUSCH repetition type B and an interlaced transport block mapping. For example, the DCI 1805-b may schedule PUSCH repetitions over repetitions of transport blocks 1810 (e.g., TB1, TB2, TB3, and TB4) spanning a quantity of slots 1815 in a time domain (e.g., spanning slots S1, S2, S3, S4, S5, S6, and S7) and indicate an interlaced mapping for the transport blocks 1810. In the example of FIG. 18B, each of the transport blocks 1810 may include two nominal repetitions, where the first nominal repetition of TB1 crosses a slot boundary (e.g., the S1 boundary), the first nominal repetition of TB4 crosses a slot boundary (e.g., the S3 boundary), the second nominal repetition of TB1 crosses a slot boundary (e.g., the S4 boundary), and the second nominal repetition of TB4 crosses a slot boundary (e.g., the S6 boundary). Accordingly, in such examples, TB1 and TB4 may include four actual repetitions R1, R2, R3, and R4, and TB2 and TB3 may include two actual repetitions R1 and R2.

A UE 115 may be configured (e.g., via the DCI 1805-b) to transmit a first subset of the repetitions of the transport blocks 1810 using a first beam (e.g., B1) and a second subset of the repetitions of the transport blocks 1810 using a second beam (e.g., B2), where the beams B1 and B2 may be different directional beams formed by the UE 115. In some examples, the first subset and the second subset may correspond to the nominal repetitions of TB1, TB2, TB3, and TB4. For example, the UE 115 may be configured to transmit the first and second nominal repetitions of TB1 and TB3 using B1 and the first and second nominal repetitions of TB2 and TB4 using B2. As a result, the UE 115 may transmit R1 of TB1, R2 of TB1, R3 of TB1, R4 of TB1, R1 of TB3, and R2 of TB3 using B1 and R1 of TB2, R2 of TB2, R1 of TB4, R2 of TB4, R3 of TB4, and R4 of TB4 using B2.

In response to receiving the DCI 1805-b, the UE 115 may multiplex A-CSI 1820 on transmission occasions for each beam in accordance with one or more rules that indicate for the UE 115 to multiplex A-CSI 1820 on temporally last transmission occasions associated with each beam (e.g., that have a duration of at least two symbols). For example, the one or more rules may indicate for the UE 115 to multiplex A-CSI 1820-c on a temporally last transmission occasion that is transmitted using B1 and A-CSI 1820-d on a temporally last transmission occasion that is transmitted using B2. Accordingly, in accordance with the one or more rules, the UE 115 may multiplex the A-CSI 1820-c on R2 of TB3 (e.g., corresponding to the temporally last actual transmission occasion associated with B1) and A-CSI 1820-d on R4 of TB4 (e.g., corresponding to the temporally last actual transmission occasion associated with B2) and may transmit the transport blocks 1810 to the base station 105 using B1 and B2. In some examples, the UE 115 may expect that the temporally last transmission occasions associated with each beam have a threshold duration (e.g., a duration of at least two symbols).

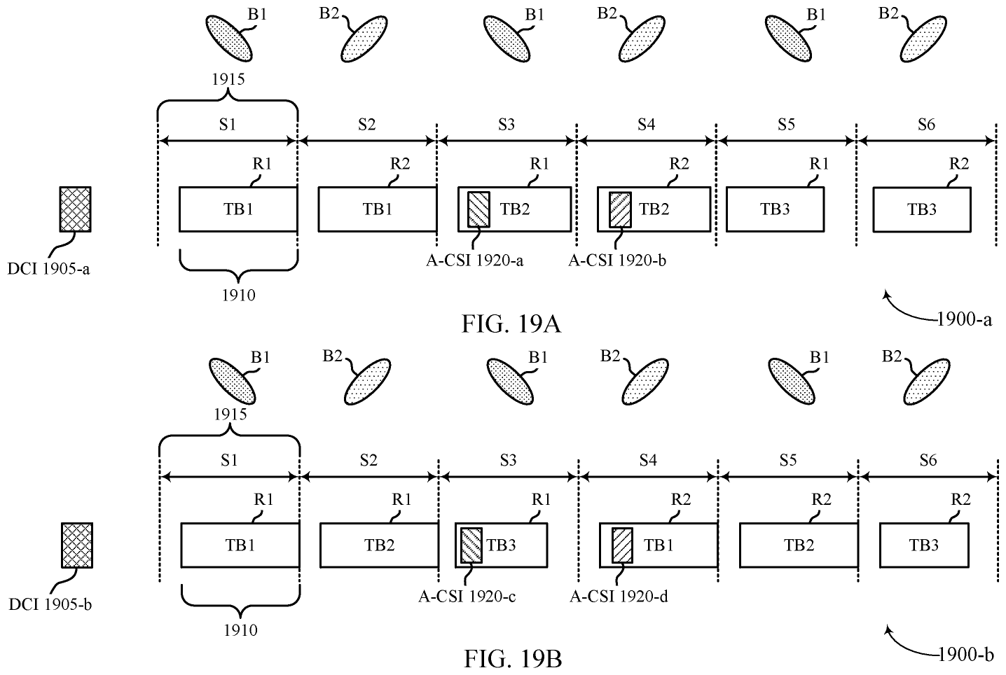

FIG. 19A illustrates an example of a multiplexing scheme 1900-a that supports techniques for CSI multiplexing on multiple PUSCH repetitions in accordance with aspects of the present disclosure. The multiplexing scheme 1900-a depicts DCI 1905-a transmitted by a base station 105 that schedules multiple PUSCH repetitions over multiple transport blocks 1910 according to a PUSCH repetition type A and a sequential transport block mapping. For example, the DCI 1905-a may schedule PUSCH repetitions over repetitions of transport blocks 1910 (e.g., TB1, TB2, and TB3) spanning a quantity of slots 1915 in a time domain (e.g., spanning slots S1, S2, S3, S4, S5, and S6) and indicate that the repetitions of the TB1, TB2, TB3, and TB4 are sequentially mapped. In the example of FIG. 19A, each of the transport blocks 1910 may include a first repetition R1 and a second repetition R2 with each slot 1915 including a single repetition of a transport block 1910.

A UE 115 may be configured (e.g., via the DCI 1905-a) to transmit a first subset of the repetitions of the transport blocks 1910 using a first beam (e.g., B1) and a second subset of the repetitions of the transport blocks 1910 using a second beam (e.g., B2), where the beams B1 and B2 may be different directional beams formed by the UE 115. For example, the UE 115 may be configured to transmit R1 of TB1, R1 of TB2, and R1 of TB3 using B1 and R2 of TB1, R2 of TB2, and R2 of TB3 using B2.

In response to receiving the DCI 1905-a, the UE 115 may multiplex A-CSI 1920 on transmission occasions for each beam in accordance with one or more rules that indicate for the UE 115 to multiplex A-CSI 1920 on penultimate transmission occasions associated with each beam. For example, the one or more rules may indicate for the UE 115 to multiplex A-CSI 1920-a on a penultimate transmission occasion that is transmitted using B1 and A-CSI 1920-b on a penultimate transmission occasion that is transmitted using B2. Accordingly, in accordance with the one or more rules, the UE 115 may multiplex the A-CSI 1920-a on R1 of TB2 and A-CSI 1920-b on R2 of TB2 and may transmit the transport blocks 1910 to the base station 105 using B1 and B2.

FIG. 19B illustrates an example of a multiplexing scheme 1900-b that supports techniques for CSI multiplexing on multiple PUSCH repetitions in accordance with aspects of the present disclosure. The multiplexing scheme 1900-b depicts DCI 1905-b transmitted by a base station 105 that schedules multiple PUSCH repetitions over multiple transport blocks 1910 according to a PUSCH repetition type A and an interlaced transport block mapping. For example, the DCI 1905-b may schedule PUSCH repetitions over repetitions of transport blocks 1910 (e.g., TB1, TB2, and TB3) spanning a quantity of slots 1915 in a time domain (e.g., spanning slots S1, S2, S3, S4, S5, and S6) and indicate an interlaced mapping for the transport blocks 1910. In the example of FIG. 19B, each of the transport blocks 1910 may include a first repetition R1 and a second repetition R2 with each slot 1915 including a single repetition of a transport block 1910.

A UE 115 may be configured (e.g., via the DCI 1905-b) to transmit a first subset of the repetitions of the transport blocks 1910 using a first beam (e.g., B1) and a second subset of the repetitions of the transport blocks 1910 using a second beam (e.g., B2), where the beams B1 and B2 may be different directional beams formed by the UE 115. For example, the UE 115 may be configured to transmit R1 of TB1, R1 of TB3, and R2 of TB2 using B1 and R1 of TB2, R2 of TB1, and R2 of TB3 using B2.

In response to receiving the DCI 1905-b, the UE 115 may multiplex A-CSI 1920 on transmission occasions for each beam in accordance with one or more rules that indicate for the UE 115 to multiplex A-CSI 1920 on penultimate transmission occasions associated with each beam. For example, the one or more rules may indicate for the UE 115 to multiplex A-CSI 1920-c on a penultimate transmission occasion that is transmitted using B1 and A-CSI 1920-d on a penultimate transmission occasion that is transmitted using B2. Accordingly, in accordance with the one or more rules, the UE 115 may multiplex the A-CSI 1920-c on R1 of TB3 and A-CSI 1920-d on R2 of TB1 and may transmit the transport blocks 1910 to the base station 105 using B1 and B2.

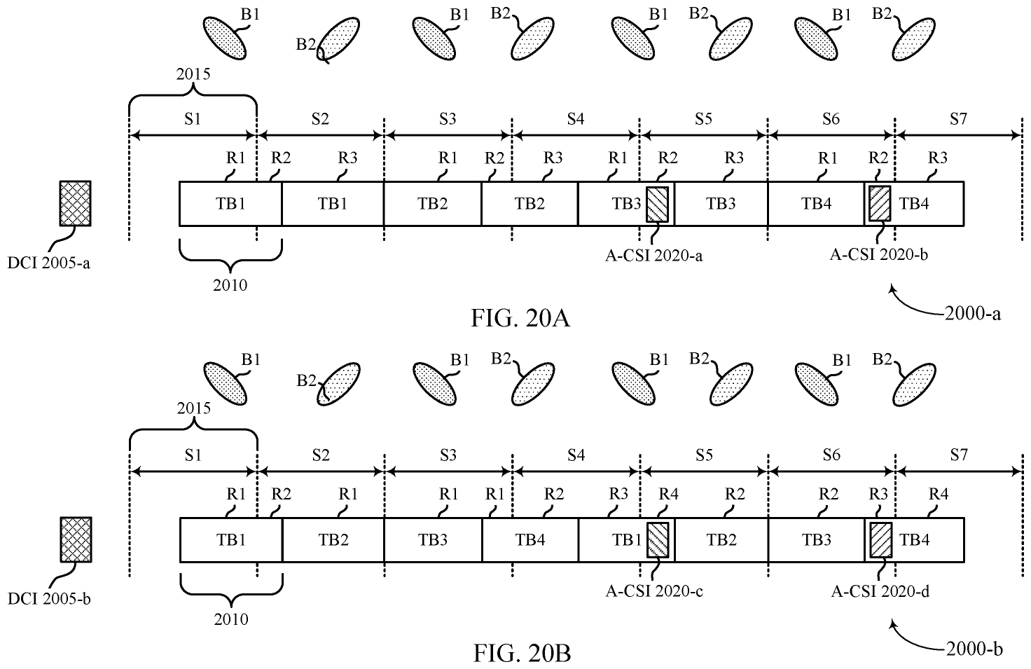

FIG. 20A illustrates an example of a multiplexing scheme 2000-a that supports techniques for CSI multiplexing on multiple PUSCH repetitions in accordance with aspects of the present disclosure. The multiplexing scheme 2000-a depicts DCI 2005-a transmitted by a base station 105 that schedules multiple PUSCH repetitions over multiple transport blocks 2010 according to a PUSCH repetition type B and a sequential transport block mapping. For example, the DCI 2005-a may schedule PUSCH repetitions over repetitions of transport blocks 2010 (e.g., TB1, TB2, TB3, and TB4) spanning a quantity of slots 2015 in a time domain (e.g., spanning slots S1, S2, S3, S4, S5, S6, and S7) and indicate that the repetitions of the TB1, TB2, TB3, and TB4 are sequentially mapped. In the example of FIG. 20A, each of the transport blocks 2010 may include two nominal repetitions, where the first nominal repetition of TB1 crosses a slot boundary (e.g., the S1 boundary), the second nominal repetition of TB2 crosses a slot boundary (e.g., the S3 boundary), the first nominal repetition of TB3 crosses a slot boundary (e.g., the S4 boundary), and the second nominal repetition of TB4 crosses a slot boundary (e.g., the S6 boundary). Accordingly, each of the transport blocks TB1, TB2, TB3, and TB4 may include three actual repetitions R1, R2, and R3.

A UE 115 may be configured (e.g., via the DCI 2005-a) to transmit a first subset of the repetitions of the transport blocks 2010 using a first beam (e.g., B1) and a second subset of the repetitions of the transport blocks 2010 using a second beam (e.g., B2), where the beams B1 and B2 may be different directional beams formed by the UE 115. In some examples, the first subset and the second subset may correspond to the nominal repetitions of TB1, TB2, TB3, and TB4. For example, the UE 115 may be configured to transmit the first nominal repetition of TB1, TB2, TB3, and TB4 using B1 and the second nominal repetition of TB1, TB2, TB3, and TB4 using B2. As a result, the UE 115 may transmit R1 of TB1, R2 of TB1, R1 of TB2, R1 of TB3, R2 of TB3, and R1 of TB4 using B1 and R3 of TB1, R2 of TB2, R3 of TB2, R3 of TB3, R2 of TB4, and R3 of TB4 using B2.

In response to receiving the DCI 2005-a, the UE 115 may multiplex A-CSI 2020 on transmission occasions for each beam in accordance with one or more rules that indicate for the UE 115 to multiplex A-CSI 2020 on penultimate transmission occasions associated with each beam (e.g., that have a duration of at least two symbols). For example, the one or more rules may indicate for the UE 115 to multiplex A-CSI 2020-a on a penultimate transmission occasion that is transmitted using B1 and A-CSI 2020-b on a penultimate transmission occasion that is transmitted using B2. Accordingly, in accordance with the one or more rules, the UE 115 may multiplex the A-CSI 2020-a on R2 of TB3 (e.g., corresponding to the penultimate actual transmission occasion associated with B1) and A-CSI 2020-b on R2 of TB4 (e.g., corresponding to the penultimate actual transmission occasion associated with B2) and may transmit the transport blocks 2010 to the base station 105 using B1 and B2. In some examples, the UE 115 may expect that the penultimate transmission occasions associated with each beam have a threshold duration (e.g., a minimum duration, a duration of at least two symbols).

FIG. 20B illustrates an example of a multiplexing scheme 2000-b that supports techniques for CSI multiplexing on multiple PUSCH repetitions in accordance with aspects of the present disclosure. The multiplexing scheme 2000-b depicts DCI 2005-b transmitted by a base station 105 that schedules multiple PUSCH repetitions over multiple transport blocks 2010 according to a PUSCH repetition type B and an interlaced transport block mapping. For example, the DCI 2005-b may schedule PUSCH repetitions over repetitions of transport blocks 2010 (e.g., TB1, TB2, TB3, and TB4) spanning a quantity of slots 2015 in a time domain (e.g., spanning slots S1, S2, S3, S4, S5, S6, and S7) and indicate an interlaced mapping for the transport blocks 2010. In the example of FIG. 20B, each of the transport blocks 2010 may include two nominal repetitions, where TB1 and TB4 may include four actual repetitions R1, R2, R3, and R4, and TB2 and TB3 may include two actual repetitions R1 and R2.

A UE 115 may be configured (e.g., via the DCI 2005-b) to transmit a first subset of the repetitions of the transport blocks 2010 using a first beam (e.g., B1) and a second subset of the repetitions of the transport blocks 2010 using a second beam (e.g., B2), where the beams B1 and B2 may be different directional beams formed by the UE 115. In some examples, the first subset and the second subset may correspond to the nominal repetitions of TB1, TB2, TB3, and TB4. For example, the UE 115 may be configured to transmit the first and second nominal repetitions of TB1 and TB3 using B1 and the first and second nominal repetitions of TB2 and TB4 using B2. As a result, the UE 115 may transmit R1 of TB1, R2 of TB1, R3 of TB1, R4 of TB1, R1 of TB3, and R2 of TB3 using B1 and R1 of TB2, R2 of TB2, R1 of TB4, R2 of TB4, R3 of TB4, and R4 of TB4 using B2.

In response to receiving the DCI 2005-b, the UE 115 may multiplex A-CSI 2020 on transmission occasions for each beam in accordance with one or more rules that indicate for the UE 115 to multiplex A-CSI 2020 on penultimate transmission occasions associated with each beam (e.g., that have a duration of at least two symbols). For example, the one or more rules may indicate for the UE 115 to multiplex A-CSI 2020-c on a penultimate transmission occasion that is transmitted using B1 and A-CSI 2020-d on a penultimate transmission occasion that is transmitted using B2. Accordingly, in accordance with the one or more rules, the UE 115 may multiplex the A-CSI 2020-c on R4 of TB1 (e.g., corresponding to the penultimate actual transmission occasion associated with B1) and A-CSI 2020-d on R3 of TB4 (e.g., corresponding to the penultimate actual transmission occasion associated with B2) and may transmit the transport blocks 2010 to the base station 105 using B1 and B2. In some examples, the UE 115 may expect that the penultimate transmission occasions associated with each beam have a threshold duration (e.g., a duration of at least two symbols).

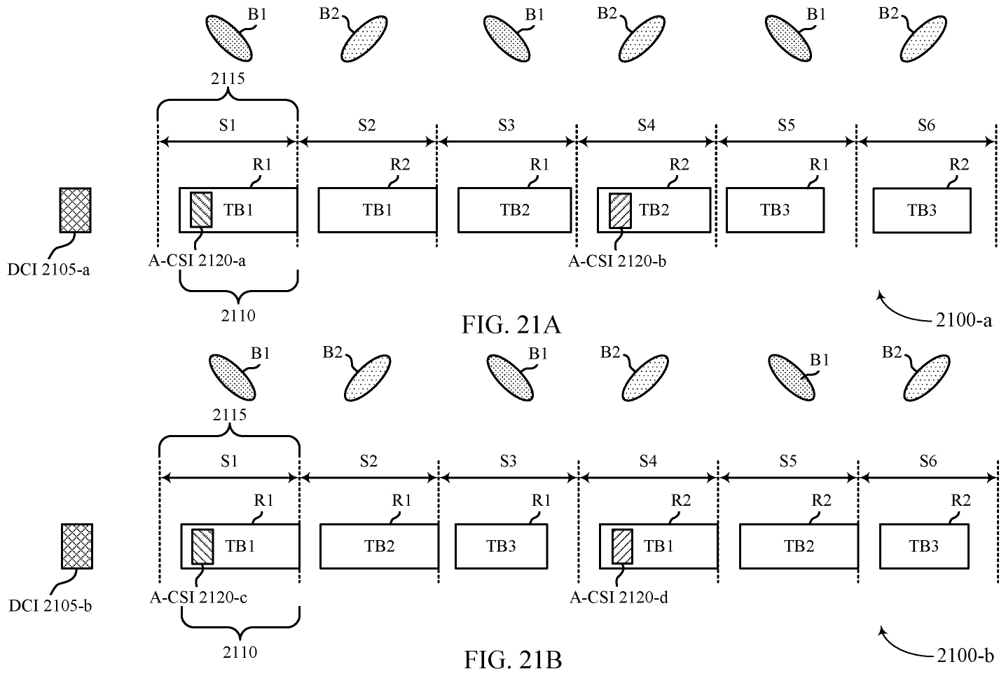

FIG. 21A illustrates an example of a multiplexing scheme 2100-a that supports techniques for CSI multiplexing on multiple PUSCH repetitions in accordance with aspects of the present disclosure. The multiplexing scheme 2100-a depicts DCI 2105-a transmitted by a base station 105 that schedules multiple PUSCH repetitions over multiple transport blocks 2110 according to a PUSCH repetition type A and a sequential transport block mapping. For example, the DCI 2105-a may schedule PUSCH repetitions over repetitions of transport blocks 2110 (e.g., TB1, TB2, and TB3) spanning a quantity of slots 2115 in a time domain (e.g., spanning slots S1, S2, S3, S4, S5, and S6) and indicate that the repetitions of the TB1, TB2, TB3, and TB4 are sequentially mapped. In the example of FIG. 21A, each of the transport blocks 2110 may include a first repetition R1 and a second repetition R2 with each slot 2115 including a single repetition of a transport block 2110.

A UE 115 may be configured (e.g., via the DCI 2105-a) to transmit a first subset of the repetitions of the transport blocks 2110 using a first beam (e.g., B1) and a second subset of the repetitions of the transport blocks 2010 using a second beam (e.g., B2), where the beams B1 and B2 may be different directional beams formed by the UE 115. For example, the UE 115 may be configured to transmit R1 of TB1, R1 of TB2, and R1 of TB3 using B1 and R2 of TB1, R2 of TB2, and R2 of TB3 using B2.

In response to receiving the DCI 2105-a, the UE 115 may multiplex A-CSI 2120 on transmission occasions for each beam in accordance with one or more rules that indicate for the UE 115 to multiplex A-CSI 2120 on transmission occasions associated with each beam that include a relatively largest quantity of resource elements for A-CSI 2120 (e.g., for A-CSI 2120 multiplexing) relative to other transmission occasions associated with each beam. For example, the one or more rules may indicate for the UE 115 to multiplex A-CSI 2120-a on a transmission occasion that is transmitted using B1 and includes a largest quantity of resource elements for A-CSI 2120 of the transmission occasions transmitted using B1. Additionally, the one or more rules may indicate for the UE 115 to multiplex A-CSI 2120-b on a transmission occasion that is transmitted using B2 and includes a largest quantity of resource elements for A-CSI 2120 of the transmission occasions transmitted using B1.

Based on the one or more rules, the UE 115 may determine a quantity of resource elements for A-CSI 2120 included in each transmission occasion and may determine which transmission occasion includes the largest quantity of resource elements for A-CSI 2120 for each beam. For example, the UE 115 may determine that R1 of TB1 includes the largest quantity of resource elements for A-CSI 2120 of the repetitions that are transmitted using B1 and may determine that R2 of TB2 includes the largest quantity of resource elements for A-CSI 2120 of the repetitions that are transmitted using B2. Accordingly, in accordance with the one or more rules, the UE 115 may multiplex the A-CSI 2120-a on R1 of TB1 and the A-CSI 2120-b on R2 of TB2 and may transmit the transport blocks 2110 to the base station 105 using B1 and B2.

FIG. 21B illustrates an example of a multiplexing scheme 2100-b that supports techniques for CSI multiplexing on multiple PUSCH repetitions in accordance with aspects of the present disclosure. The multiplexing scheme 2100-b depicts DCI 2105-b transmitted by a base station 105 that schedules multiple PUSCH repetitions over multiple transport blocks 2110 according to a PUSCH repetition type A and an interlaced transport block mapping. For example, the DCI 2105-b may schedule PUSCH repetitions over repetitions of transport blocks 2110 (e.g., TB1, TB2, and TB3) spanning a quantity of slots 2115 in a time domain (e.g., spanning slots S1, S2, S3, S4, S5, and S6) and indicate an interlaced mapping for the transport blocks 2110. In the example of FIG. 21B, each of the transport blocks 2110 may include a first repetition R1 and a second repetition R2 with each slot 2115 including a single repetition of a transport block 2110.

A UE 115 may be configured (e.g., via the DCI 2105-b) to transmit a first subset of the repetitions of the transport blocks 2110 using a first beam (e.g., B1) and a second subset of the repetitions of the transport blocks 2110 using a second beam (e.g., B2), where the beams B1 and B2 may be different directional beams formed by the UE 115. For example, the UE 115 may be configured to transmit R1 of TB1, R1 of TB3, and R2 of TB2 using B1 and R1 of TB2, R2 of TB1, and R2 of TB3 using B2.

In response to receiving the DCI 2105-b, the UE 115 may multiplex A-CSI 2120 on transmission occasions for each beam in accordance with one or more rules that indicate for the UE 115 to multiplex A-CSI 2120 on transmission occasions associated with each beam that include a largest quantity of resource elements for A-CSI 2120 (e.g., A-CSI 2120 multiplexing) relative to other transmission occasions associated with each beam. Based on the one or more rules, the UE 115 may determine a quantity of resource elements for A-CSI 2120 included in each transmission occasion and may determine which transmission occasion includes the largest quantity of resource elements for A-CSI 2120 for each beam. For example, the UE 115 may determine that R1 of TB1 includes the largest quantity of resource elements for A-CSI 2120 of the repetitions that are transmitted using B1 and may determine that R2 of TB1 includes the largest quantity of resource elements for A-CSI 2120 of the repetitions that are transmitted using B2. Accordingly, in accordance with the one or more rules, the UE 115 may multiplex A-CSI 2120-c on R1 of TB1 and A-CSI 2120-d on R2 of TB1 and may transmit the transport blocks 2110 to the base station 105 using B1 and B2.

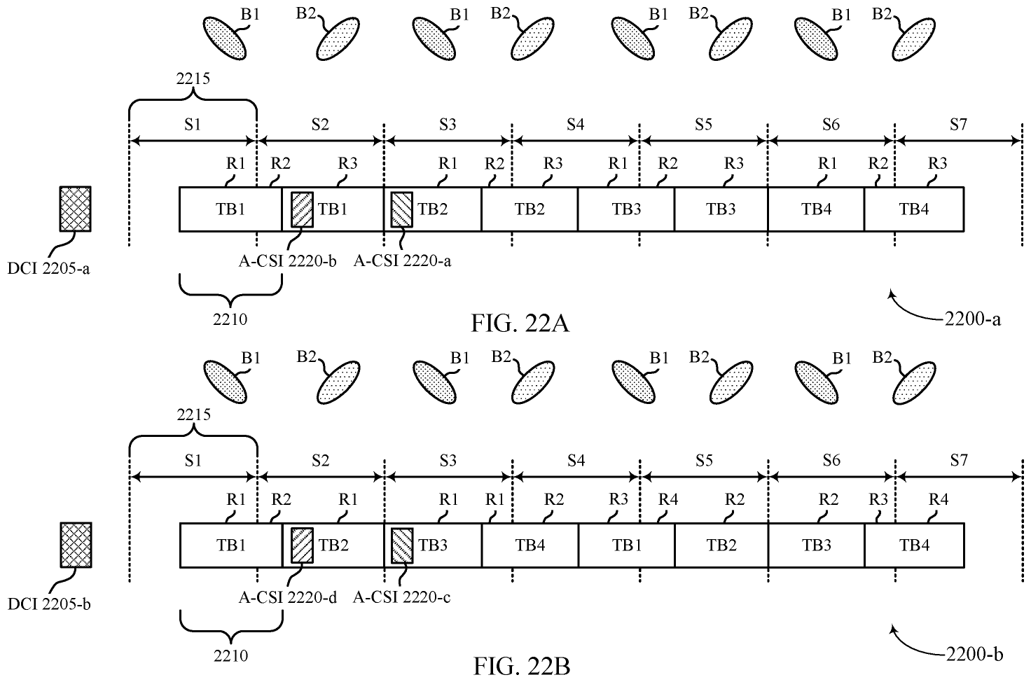

FIG. 22A illustrates an example of a multiplexing scheme 2200-a that supports techniques for CSI multiplexing on multiple PUSCH repetitions in accordance with aspects of the present disclosure. The multiplexing scheme 2200-a depicts DCI 2205-a transmitted by a base station 105 that schedules multiple PUSCH repetitions over multiple transport blocks 2210 according to a PUSCH repetition type B and a sequential transport block mapping. For example, the DCI 2205-a may schedule PUSCH repetitions over repetitions of transport blocks 2210 (e.g., TB1, TB2, TB3, and TB4) spanning a quantity of slots 2115 in a time domain (e.g., spanning slots S1, S2, S3, S4, S5, S6, and S7) and indicate that the repetitions of the TB1, TB2, TB3, and TB4 are sequentially mapped. In the example of FIG. 22A, each of the transport blocks 2210 may include two nominal repetitions, and each of the transport blocks TB1, TB2, TB3, and TB4 may include three actual repetitions R1, R2, and R3.

A UE 115 may be configured (e.g., via the DCI 2205-a) to transmit a first subset of the repetitions of the transport blocks 2210 using a first beam (e.g., B1) and a second subset of the repetitions of the transport blocks 2210 using a second beam (e.g., B2), where the beams B1 and B2 may be different directional beams formed by the UE 115. In some examples, the first subset and the second subset may correspond to the nominal repetitions of TB1, TB2, TB3, and TB4. For example, the UE 115 may be configured to transmit the first nominal repetition of TB1, TB2, TB3, and TB4 using B1 and the second nominal repetition of TB1, TB2, TB3, and TB4 using B2. As a result, the UE 115 may transmit R1 of TB1, R2 of TB1, R1 of TB2, R1 of TB3, R2 of TB3, and R1 of TB4 using B1 and R3 of TB1, R2 of TB2, R3 of TB2, R3 of TB3, R2 of TB4, and R3 of TB4 using B2.

In response to receiving the DCI 2205-a, the UE 115 may multiplex A-CSI 1820 on transmission occasions for each beam in accordance with one or more rules that indicate for the UE 115 to multiplex A-CSI 2220 on transmission occasions associated with each beam that include a largest quantity of resource elements for A-CSI 2220 (e.g., A-CSI 2220 multiplexing) relative to other transmission occasions associated with each beam. Based on the one or more rules, the UE 115 may determine a quantity of resource elements for A-CSI 2220 included in each transmission occasion and may determine which transmission occasion includes the largest quantity of resource elements for A-CSI 2220 for each beam. For example, the UE 115 may determine that R1 of TB2 includes the largest quantity of resource elements for A-CSI 2220 of the repetitions that are transmitted using B1 and may determine that R3 of TB1 includes the largest quantity of resource elements for A-CSI 2220 of the repetitions that are transmitted using B2. Accordingly, in accordance with the one or more rules, the UE 115 may multiplex A-CSI 2220-a on R1 of TB2 and A-CSI 2220-b on R3 of TB1 and may transmit the transport blocks 2210 to the base station 105 using the beams B1 and B2.

FIG. 22B illustrates an example of a multiplexing scheme 2200-b that supports techniques for CSI multiplexing on multiple PUSCH repetitions in accordance with aspects of the present disclosure. The multiplexing scheme 2200-b depicts DCI 2205-b transmitted by a base station 105 that schedules multiple PUSCH repetitions over multiple transport blocks 2210 according to a PUSCH repetition type B and an interlaced transport block mapping. For example, the DCI 2205-b may schedule PUSCH repetitions over repetitions of transport blocks 2210 (e.g., TB1, TB2, TB3, and TB4) spanning a quantity of slots 2115 in a time domain (e.g., spanning slots S1, S2, S3, S4, S5, S6, and S7) and indicate an interlaced mapping for the transport blocks 2210. In the example of FIG. 22B, each of the transport blocks 2210 may include two nominal repetitions, and TB1 and TB4 may include four actual repetitions R1, R2, R3, and R4, and TB2 and TB3 may include two actual repetitions R1 and R2.

A UE 115 may be configured (e.g., via the DCI 2205-b) to transmit a first subset of the repetitions of the transport blocks 2210 using a first beam (e.g., B1) and a second subset of the repetitions of the transport blocks 2210 using a second beam (e.g., B2), where the beams B1 and B2 may be different directional beams formed by the UE 115. In some examples, the first subset and the second subset may correspond to the nominal repetitions of TB1, TB2, TB3, and TB4. For example, the UE 115 may be configured to transmit the first and second nominal repetitions of TB1 and TB3 using B1 and the first and second nominal repetitions of TB2 and TB4 using B2. As a result, the UE 115 may transmit R1 of TB1, R2 of TB1, R3 of TB1, R4 of TB1, R1 of TB3, and R2 of TB3 using B1 and R1 of TB2, R2 of TB2, R1 of TB4, R2 of TB4, R3 of TB4, and R4 of TB4 using B2.

In response to receiving the DCI 2205-b, the UE 115 may multiplex A-CSI 2020 on transmission occasions for each beam in accordance with one or more rules that indicate for the UE 115 to multiplex A-CSI 2220 on transmission occasions associated with each beam that include a largest quantity of resource elements for A-CSI 2220 (e.g., A-CSI 2220 multiplexing) relative to other transmission occasions associated with each beam. Based on the one or more rules, the UE 115 may determine a quantity of resource elements for A-CSI 2220 included in each transmission occasion and may determine which transmission occasion includes the largest quantity of resource elements for A-CSI 2220 for each beam. For example, the UE 115 may determine that R1 of TB3 includes the largest quantity of resource elements for A-CSI 2220 of the repetitions that are transmitted using B1 and may determine that R1 of TB2 includes the largest quantity of resource elements for A-CSI 2220 of the repetitions that are transmitted using B2. Accordingly, in accordance with the one or more rules, the UE 115 may multiplex A-CSI 2220-c on R1 of TB3 and A-CSI 2220-d on R1 of TB2 and may transmit the transport blocks 2210 to the base station 105 using B1 and B2.

In some examples, to support the rules described with reference to FIGS. 15A through 22B, additional rules may be defined (e.g., configured by a base station 105). In some cases, the additional rules may ensure that the transmissions occasions that include the multiplexed A-CSI for each beam includes a same quantity of resource elements for A-CSI (e.g., A-CSI multiplexing).

In a first example, the additional rules may indicate that a UE 115 is to multiplex A-CSI in accordance with one or more of the rules described with reference to FIGS. 15A through 22B if the first transmission occasion associated with B1 and the first transmission occasion associated with B2 correspond to an initial transmission for each beam, where the initial transmission corresponds to a first time a given transport block is scheduled (e.g., rather than a retransmission of the given transport block). The additional rules may also indicate for the UE 115 to multiple the A-CSI in accordance with the one or more of the rules if each of the first transmission occasions include a same quantity of symbols, are associated with a same MCS, include same quantity of resource blocks, include a same quantity of layers (e.g., spatial layers), include a same quantity resource elements for demodulation reference signals (DMRS), or a combination thereof. Additionally, or alternatively, the additional rules may indicate for the UE 115 to in accordance with one or more of the rules if uplink control information (UCI) different from A-CSI is excluded from each of the first transmission occasions. Therefore, if the additional rules are satisfied, the UE 115 may determine that first transmission occasion associated with B1 and the first transmission occasion associated with B2 include a same quantity of resource elements for A-CSI.

In a second example, the additional rules may indicate that a UE 115 is to multiplex A-CSI in accordance with one or more of the rules described with reference to FIGS. 15A through 22B based on an MCS index indicated by DCI. For example, if the DCI indicates an MCS index of 28, 29, 30, or 31, the UE 115 may multiplex A-CSI in accordance with one or more of the rules and may determine a transport block size of each of the transport blocks scheduled by the DCI based on DCI scheduling the initial transmission of the transport blocks. In some examples, one or both of the first transmission occasion associated with B1 and the first transmission occasion associated with B2 may correspond to initial transmissions. In some examples, the first transmission occasion associated with B1 and the first transmission occasion associated with B2 may each correspond to an initial transmission of a transport block or a retransmission of a transport block.

In a third example, the additional rules may indicate for the UE 115 to determine the quantity of resource elements for A-CSI of a temporally first transmission occasion associated with B1 (e.g., an earliest transmission occasion associated with B1 in a time domain) and multiplex first A-CSI on the temporally first transmission occasion associated with B1. The additional rules may also indicate for the UE 115 to determine a temporally first transmission occasion associated with B2 (e.g., the earliest transmission occasion associated with B2 in the time domain) that includes the same quantity of resource elements for A-CSI and multiplex second A-CSI on the temporally first transmission occasion associated with B2 that includes the same quantity of resource elements for A-CSI. In this way, the UE 115 may ensure that the same quantity of resource elements for A-CSI are included in each of the transmission occasions.

In a fourth example, the additional rules may indicate for the UE 115 to determine the quantity of resource elements for A-CSI of a temporally last transmission occasion associated with B1 (e.g., a last transmission occasion associated with B1 in the time domain) and multiplex first A-CSI on the temporally last transmission occasion associated with B1. The additional rules may also indicate for the UE 115 to determine a temporally last transmission occasion associated with B2 (e.g., the last transmission occasion associated with B2 in the time domain) that includes the same quantity of resource elements for A-CSI and multiplex second A-CSI on the temporally last transmission occasion associated with B2 that includes the same quantity of resource elements for A-CSI. In this way, the UE 115 may ensure that the same quantity of resource elements for A-CSI are included in each of the transmission occasions.

In a fifth example, the additional rules may indicate for the UE 115 to determine the quantity of resource elements for A-CSI of a penultimate transmission occasion associated with B1 and multiplex first A-CSI on the penultimate transmission occasion associated with B1. The additional rules may also indicate for the UE 115 to determine a penultimate transmission occasion associated with B2 that includes the same quantity of resource elements for A-CSI and multiplex second A-CSI on the penultimate transmission occasion associated with B2 that includes the same quantity of resource elements for A-CSI. In this way, the UE 115 may ensure that the same quantity of resource elements for A-CSI are included in each of the transmission occasions.

In a sixth example, the additional rules may indicate for the UE 115 to determine the quantity of resource elements for A-CSI of a temporally first, temporally last, or penultimate transmission occasion associated with B1 and multiplex first A-CSI on the temporally first, temporally last, or penultimate transmission occasion associated with B1 using the determined quantity of resource elements for A-CSI. The additional rules may also indicate for the UE 115 to use the determined quantity of resource elements for A-CSI to multiplex second A-CSI on a temporally first, temporally last, or penultimate transmission occasion associated with B2. In this way, the UE 115 may ensure that the same quantity of resource elements for A-CSI are used for each of the transmission occasions.

In some cases, if the additional rules fail to be satisfied or if the UE 115 is not configured to follow the additional rules, the UE 115 may be configured to multiplex first A-CSI on a temporally first transmission occasion associated with B1 and drop multiplexing of second A-CSI on a transmission occasion associated with B2.

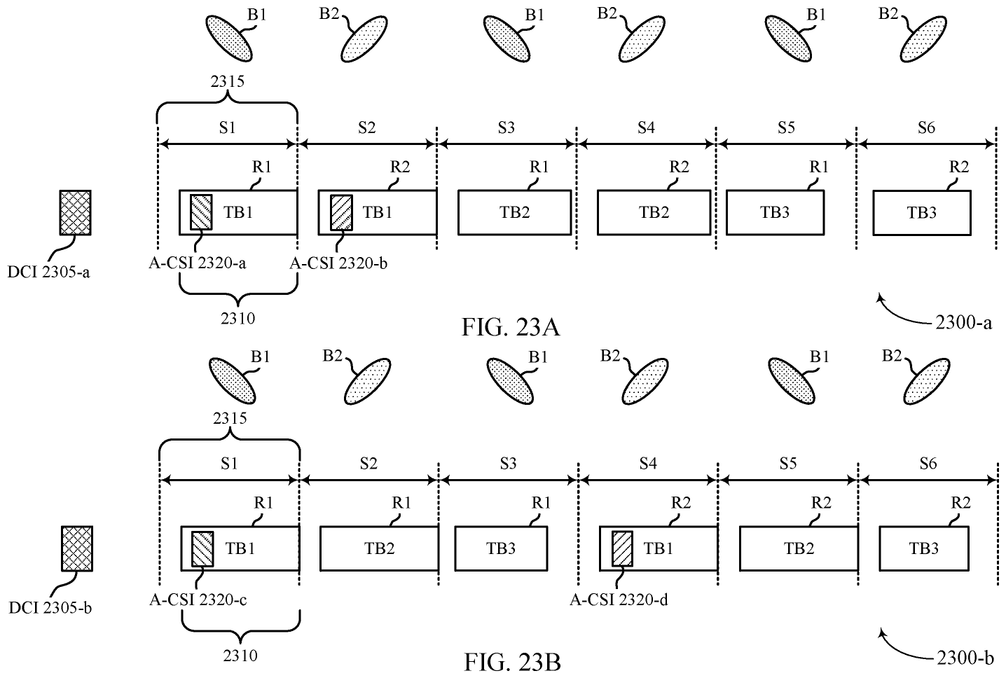

FIG. 23A illustrates an example of a multiplexing scheme 2300-a that supports techniques for CSI multiplexing on multiple PUSCH repetitions in accordance with aspects of the present disclosure. The multiplexing scheme 2300-a depicts DCI 2305-a transmitted by a base station 105 that schedules multiple PUSCH repetitions over multiple transport blocks 2310 according to a PUSCH repetition type A and a sequential transport block mapping. For example, the DCI 2305-a may schedule PUSCH repetitions over repetitions of transport blocks 2310 (e.g., TB1, TB2, and TB3) spanning a quantity of slots 2315 in a time domain (e.g., spanning slots S1, S2, S3, S4, S5, and S6) and indicate that the repetitions of the TB1, TB2, TB3, and TB4 are sequentially mapped. In the example of FIG. 23A, each of the transport blocks 2310 may include a first repetition R1 and a second repetition R2 with each slot 2315 including a single repetition of a transport block 2310.

A UE 115 may be configured (e.g., via the DCI 2305-a) to transmit a first subset of the repetitions of the transport blocks 2310 using a first beam (e.g., B1) and a second subset of the repetitions of the transport blocks 2310 using a second beam (e.g., B2), where the beams B1 and B2 may be different directional beams formed by the UE 115. For example, the UE 115 may be configured to transmit R1 of TB1, R1 of TB2, and R1 of TB3 using B1 and R2 of TB1, R2 of TB2, and R2 of TB3 using B2.

In response to receiving the DCI 2305-a, the UE 115 may multiplex A-CSI 2320 on transmission occasions for each beam in accordance with one or more rules that indicate for the UE 115 to multiplex A-CSI 2320 on repetitions of a same transport block 2310. For example, the one or more rules may indicate for the UE 115 to multiplex A-CSI 2320-a on a temporally first repetition of a temporally first transport block 2310 that is transmitted using B1 and A-CSI 2320-b on a temporally first repetition of the temporally first transport block 2310 that is transmitted using B2. Accordingly, in accordance with the one or more rules, the UE 115 may multiplex the A-CSI 2320-a on R1 of TB1 and A-CSI 2320-b on R2 of TB1 and may transmit the transport blocks 2310 to the base station 105 using B1 and B2.

FIG. 23B illustrates an example of a multiplexing scheme 2300-b that supports techniques for CSI multiplexing on multiple PUSCH repetitions in accordance with aspects of the present disclosure. The multiplexing scheme 2300-b depicts DCI 2305-b transmitted by a base station 105 that schedules multiple PUSCH repetitions over multiple transport blocks 2310 according to a PUSCH repetition type A and an interlaced transport block mapping. For example, the DCI 2305-b may schedule PUSCH repetitions over repetitions of transport blocks 2310 (e.g., TB1, TB2, and TB3) spanning a quantity of slots 2315 in a time domain (e.g., spanning slots S1, S2, S3, S4, S5, and S6) and indicate an interlaced mapping for the transport blocks 2310. In the example of FIG. 23B, each of the transport blocks 2310 may include a first repetition R1 and a second repetition R2 with each slot 2315 including a single repetition of a transport block 2310.

A UE 115 may be configured (e.g., via the DCI 2305-b) to transmit a first subset of the repetitions of the transport blocks 2310 using a first beam (e.g., B1) and a second subset of the repetitions of the transport blocks 2310 using a second beam (e.g., B2), where the beams B1 and B2 may be different directional beams formed by the UE 115. For example, the UE 115 may be configured to transmit R1 of TB1, R1 of TB3, and R2 of TB2 using B1 and R1 of TB2, R2 of TB1, and R2 of TB3 using B2.

In response to receiving the DCI 2305-b, the UE 115 may multiplex A-CSI 2320 on transmission occasions for each beam in accordance with one or more rules that indicate for the UE 115 to multiplex A-CSI 2320 on repetitions of a same transport block 2310. For example, the one or more rules may indicate for the UE 115 to multiplex A-CSI 2320-c on a temporally first repetition of a temporally first transport block 2310 that is transmitted using B1 and A-CSI 2320-d on a temporally first repetition of the temporally first transport block 2310 that is transmitted using B2. Accordingly, in accordance with the one or more rules, the UE 115 may multiplex the A-CSI 2320-c on R1 of TB1 and A-CSI 2320-d on R2 of TB1 and may transmit the transport blocks 2310 to the base station 105 using B1 and B2.

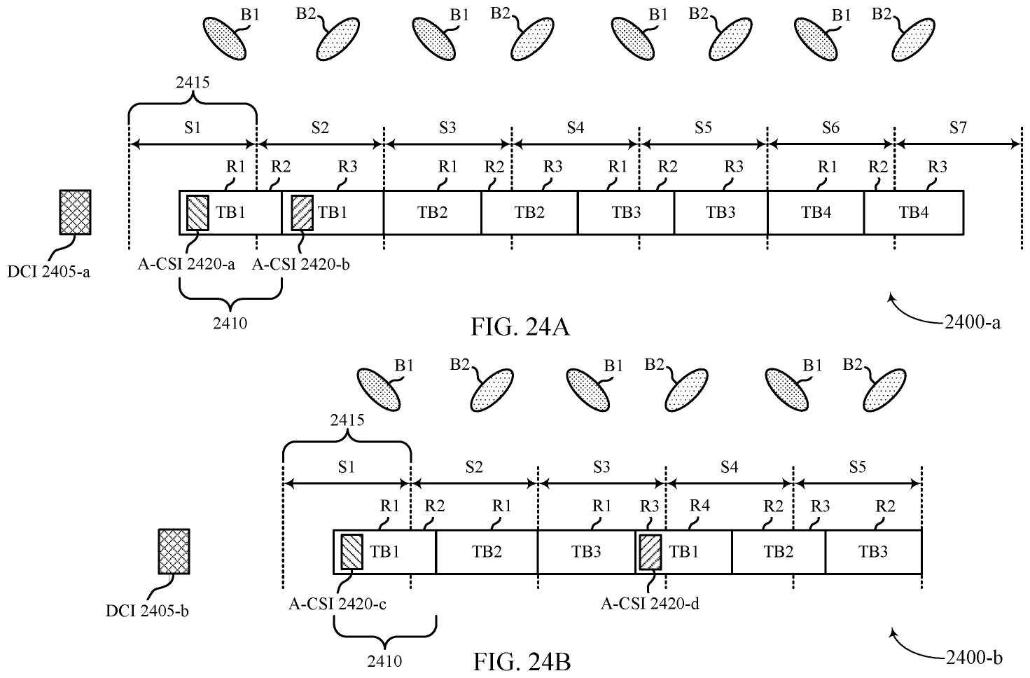

FIG. 24A illustrates an example of a multiplexing scheme 2400-a that supports techniques for CSI multiplexing on multiple PUSCH repetitions in accordance with aspects of the present disclosure. The multiplexing scheme 2400-a depicts DCI 2405-a transmitted by a base station 105 that schedules multiple PUSCH repetitions over multiple transport blocks 2410 according to a PUSCH repetition type B and a sequential transport block mapping. For example, the DCI 2405-a may schedule PUSCH repetitions over repetitions of transport blocks 2410 (e.g., TB1, TB2, TB3, and TB4) spanning a quantity of slots 2415 in a time domain (e.g., spanning slots S1, S2, S3, S4, S5, S6, and S7) and indicate that the repetitions of the TB1, TB2, TB3, and TB4 are sequentially mapped. In the example of FIG. 24A, each of the transport blocks 2410 may include two nominal repetitions, and each of the transport blocks TB1, TB2, TB3, and TB4 may include three actual repetitions R1, R2, and R3.

A UE 115 may be configured (e.g., via the DCI 2405-a) to transmit a first subset of the repetitions of the transport blocks 2410 using a first beam (e.g., B1) and a second subset of the repetitions of the transport blocks 2410 using a second beam (e.g., B2), where the beams B1 and B2 may be different directional beams formed by the UE 115. In some examples, the first subset and the second subset may correspond to the nominal repetitions of TB1, TB2, TB3, and TB4. For example, the UE 115 may be configured to transmit the first nominal repetition of TB1, TB2, TB3, and TB4 using B1 and the second nominal repetition of TB1, TB2, TB3, and TB4 using B2. As a result, the UE 115 may transmit R1 of TB1, R2 of TB1, R1 of TB2, R1 of TB3, R2 of TB3, and R1 of TB4 using B1 and R3 of TB1, R2 of TB2, R3 of TB2, R3 of TB3, R2 of TB4, and R3 of TB4 using B2.

In response to receiving the DCI 2405-a, the UE 115 may multiplex A-CSI 2420 on transmission occasions for each beam in accordance with one or more rules that indicate for the UE 115 to multiplex A-CSI 2420 on repetitions of a same transport block 2410. For example, the one or more rules may indicate for the UE 115 to multiplex A-CSI 2420-a on a temporally first actual repetition of a temporally first transport block 2410 that is transmitted using B1 and A-CSI 2420-b on a temporally first actual repetition of the temporally first transport block 2410 that is transmitted using B2. Accordingly, in accordance with the one or more rules, the UE 115 may multiplex the A-CSI 2420-a on R1 of TB1 and A-CSI 2420-b on R3 of TB1 and may transmit the transport blocks 2410 to the base station 105 using B1 and B2.

FIG. 24B illustrates an example of a multiplexing scheme 2400-b that supports techniques for CSI multiplexing on multiple PUSCH repetitions in accordance with aspects of the present disclosure. The multiplexing scheme 2400-b depicts DCI 2405-b transmitted by a base station 105 that schedules multiple PUSCH repetitions over multiple transport blocks 2410 according to a PUSCH repetition type B and an interlaced transport block mapping. For example, the DCI 2405-b may schedule PUSCH repetitions over repetitions of transport blocks 2410 (e.g., TB1, TB2, and TB3) spanning a quantity of slots 2415 in a time domain (e.g., spanning slots S1, S2, S3, S4, and S5) and indicate an interlaced mapping for the transport blocks 2410. In the example of FIG. 24B, each of the transport blocks 2410 may include two nominal repetitions, where TB1 may include four actual repetitions R1, R2, R3, and R4, TB2 may include three actual repetitions R1, R2, and R3, and TB3 may include two actual repetitions R1 and R2.

A UE 115 may be configured (e.g., via the DCI 2405-b) to transmit a first subset of the repetitions of the transport blocks 2410 using a first beam (e.g., B1) and a second subset of the repetitions of the transport blocks 2410 using a second beam (e.g., B2), where the beams B1 and B2 may be different directional beams formed by the UE 115. In some examples, the first subset and the second subset may correspond to the nominal repetitions of TB1, TB2, and TB3. For example, the UE 115 may be configured to transmit the first nominal repetitions of TB1 and TB3 and the second nominal repetition of TB2 using B1 and to transmit the first nominal repetition of TB2 and the second nominal repetitions of TB1 and TB3 using B2. As a result, the ULE 115 may transmit R1 of TB1, R2 of TB1, R1 of TB3, R2 of TB2, and R3 of TB2 using B1 and R1 of TB2, R3 of TB1, R4 of TB1, and R2 of TB3 using B2.

In response to receiving the DCI 2405-b, the UE 115 may multiplex A-CSI 2420 on transmission occasions for each beam in accordance with one or more rules that indicate for the UE 115 to multiplex A-CSI 2420 on repetitions of a same transport block 2410. For example, the one or more rules may indicate for the UE 115 to multiplex A-CSI 2420-a on a temporally first actual repetition of a temporally first transport block 2410 that is transmitted using B1 and A-CSI 2420-b on a temporally first actual repetition of the temporally first transport block 2410 that is transmitted using B2. Accordingly, in accordance with the one or more rules, the UE 115 may multiplex the A-CSI 2420-c on R1 of TB1 and A-CSI 2420-d on R3 of TB1 and may transmit the transport blocks 2410 to the base station 105 using B1 and B2.

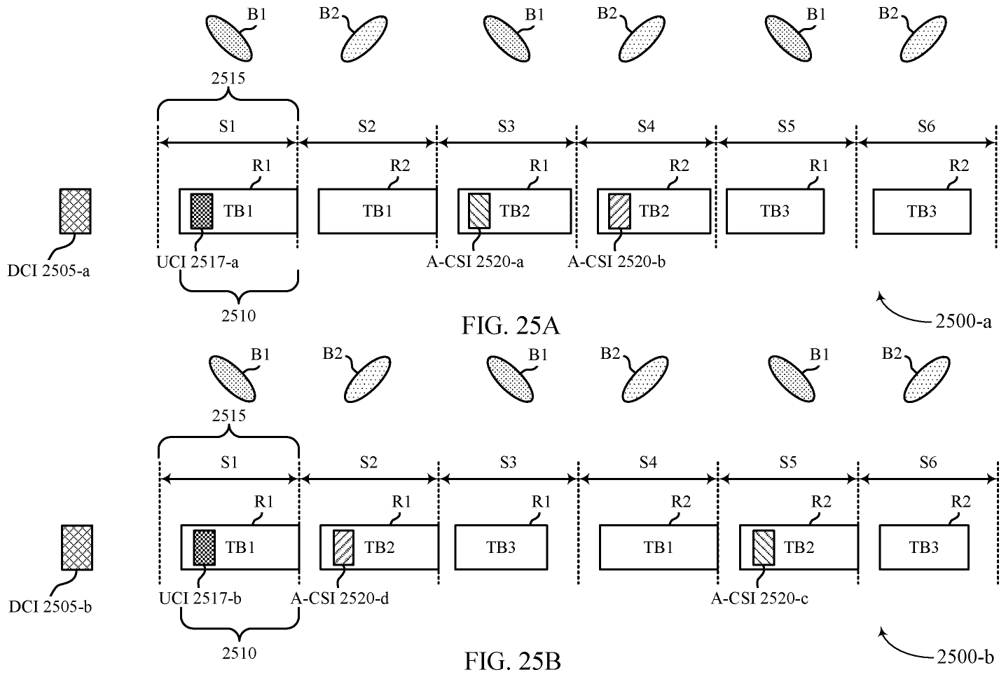

FIG. 25A illustrates an example of a multiplexing scheme 2500-a that supports techniques for CSI multiplexing on multiple PUSCH repetitions in accordance with aspects of the present disclosure. The multiplexing scheme 2500-a depicts DCI 2505-a transmitted by a base station 105 that schedules multiple PUSCH repetitions over multiple transport blocks 2510 according to a PUSCH repetition type A and a sequential transport block mapping. For example, the DCI 2505-a may schedule PUSCH repetitions over repetitions of transport blocks 2510 (e.g., TB1, TB2, and TB3) spanning a quantity of slots 2515 in a time domain (e.g., spanning slots S1, S2, S3, S4, S5, and S6) and indicate that the repetitions of the TB1, TB2, TB3, and TB4 are sequentially mapped. In the example of FIG. 25A, each of the transport blocks 2510 may include a first repetition R1 and a second repetition R2 with each slot 2515 including a single repetition of a transport block 2510.

A UE 115 may be configured (e.g., via the DCI 2505-a) to transmit a first subset of the repetitions of the transport blocks 2510 using a first beam (e.g., B1) and a second subset of the repetitions of the transport blocks 2510 using a second beam (e.g., B2), where the beams B1 and B2 may be different directional beams formed by the UE 115. For example, the UE 115 may be configured to transmit R1 of TB1, R1 of TB2, and R1 of TB3 using B1 and R2 of TB1, R2 of TB2, and R2 of TB3 using B2.

In response to receiving the DCI 2505-a, the UE 115 may multiplex A-CSI 2520 on transmission occasions for each beam in accordance with one or more rules that indicate for the UE 115 to multiplex A-CSI 2520 on repetitions of a same transport block 2510. For example, the one or more rules may indicate for the UE 115 to multiplex A-CSI 2520-a on a temporally first repetition of a temporally first transport block 2510 that is transmitted using B1, where the temporally first transport block 2510 corresponds to a temporally first transport block 2510 that excludes UCI on one or more repetitions R. For example, the UE 115 may multiplex UCI 2517-a on R1 of TB1. Accordingly, the temporally first transport block 2510 that excludes UCI may correspond to TB2. The one or more rules may also indicate for the UE 115 to multiplex A-CSI 2520-b on a temporally first repetition of the temporally first transport block 2510 that is transmitted using B2. Accordingly, in accordance with the one or more rules, the UE 115 may multiplex the A-CSI 2520-a on R1 of TB2 and A-CSI 2520-b on R2 of TB2 and may transmit the transport blocks 2510 to the base station 105 using B1 and B2.

FIG. 25B illustrates an example of a multiplexing scheme 2500-b that supports techniques for CSI multiplexing on multiple PUSCH repetitions in accordance with aspects of the present disclosure. The multiplexing scheme 2500-b depicts DCI 2505-b transmitted by a base station 105 that schedules multiple PUSCH repetitions over multiple transport blocks 2510 according to a PUSCH repetition type A and an interlaced transport block mapping. For example, the DCI 2505-b may schedule PUSCH repetitions over repetitions of transport blocks 2510 (e.g., TB1, TB2, and TB3) spanning a quantity of slots 2515 in a time domain (e.g., spanning slots S1, S2, S3, S4, S5, and S6) and indicate an interlaced mapping for the transport blocks 2510. In the example of FIG. 25B, each of the transport blocks 2510 may include a first repetition R1 and a second repetition R2 with each slot 2515 including a single repetition of a transport block 2510.

A UE 115 may be configured (e.g., via the DCI 2505-b) to transmit a first subset of the repetitions of the transport blocks 2510 using a first beam (e.g., B1) and a second subset of the repetitions of the transport blocks 2510 using a second beam (e.g., B2), where the beams B1 and B2 may be different directional beams formed by the UE 115. For example, the UE 115 may be configured to transmit R1 of TB1, R1 of TB3, and R2 of TB2 using B1 and R1 of TB2, R2 of TB1, and R2 of TB3 using B2.

In response to receiving the DCI 2505-b, the UE 115 may multiplex A-CSI 2520 on transmission occasions for each beam in accordance with one or more rules that indicate for the UE 115 to multiplex A-CSI 2520 on repetitions of a same transport block 2510. For example, the one or more rules may indicate for the UE 115 to multiplex A-CSI 2520-c on a temporally first repetition of a temporally first transport block 2510 that is transmitted using B1, where the temporally first transport block 2510 corresponds to a temporally first transport block 2510 that excludes UCI on one or more repetitions R. For example, the UE 115 may multiplex UCI 2517-b on R1 of TB1. Accordingly, the temporally first transport block 2510 that excludes UCI may correspond to TB2. The one or more rules may also indicate for the UE 115 to multiplex A-CSI 2520-d on a temporally first repetition of the temporally first transport block 2510 that is transmitted using B2. Accordingly, in accordance with the one or more rules, the UE 115 may multiplex the A-CSI 2520-c on R2 of TB2 and A-CSI 2520-d on R1 of TB2 and may transmit the transport blocks 2510 to the base station 105 using B1 and B2.

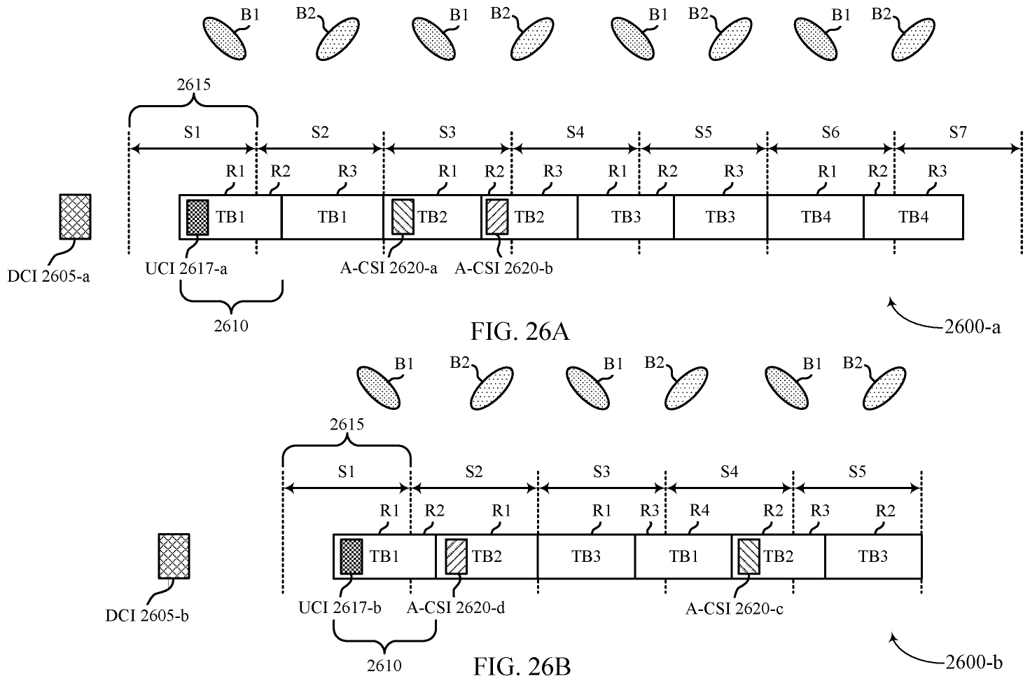

FIG. 26A illustrates an example of a multiplexing scheme 2600-a that supports techniques for CSI multiplexing on multiple PUSCH repetitions in accordance with aspects of the present disclosure. The multiplexing scheme 2600-a depicts DCI 2605-a transmitted by a base station 105 that schedules multiple PUSCH repetitions over multiple transport blocks 2610 according to a PUSCH repetition type B and a sequential transport block mapping. For example, the DCI 2605-a may schedule PUSCH repetitions over repetitions of transport blocks 2610 (e.g., TB1, TB2, TB3, and TB4) spanning a quantity of slots 2615 in a time domain (e.g., spanning slots S1, S2, S3, S4, S5, S6, and S7) and indicate that the repetitions of the TB1, TB2, TB3, and TB4 are sequentially mapped. In the example of FIG. 26A, each of the transport blocks 2610 may include two nominal repetitions, and each of the transport blocks TB1, TB2, TB3, and TB4 may include three actual repetitions R1, R2, and R3.

A UE 115 may be configured (e.g., via the DCI 2605-a) to transmit a first subset of the repetitions of the transport blocks 2610 using a first beam (e.g., B1) and a second subset of the repetitions of the transport blocks 2610 using a second beam (e.g., B2), where the beams B1 and B2 may be different directional beams formed by the UE 115. In some examples, the first subset and the second subset may correspond to the nominal repetitions of TB1, TB2, TB3, and TB4. For example, the UE 115 may be configured to transmit the first nominal repetition of TB1, TB2, TB3, and TB4 using B1 and the second nominal repetition of TB1, TB2, TB3, and TB4 using B2. As a result, the UE 115 may transmit R1 of TB1, R2 of TB1, R1 of TB2, R1 of TB3, R2 of TB3, and R1 of TB4 using B1 and R3 of TB1, R2 of TB2, R3 of TB2, R3 of TB3, R2 of TB4, and R3 of TB4 using B2.

In response to receiving the DCI 2605-a, the UE 115 may multiplex A-CSI 2620 on transmission occasions for each beam in accordance with one or more rules that indicate for the UE 115 to multiplex A-CSI 2620 on repetitions of a same transport block 2610. For example, the one or more rules may indicate for the UE 115 to multiplex A-CSI 2620-a on a temporally first actual repetition of a temporally first transport block 2610 that is transmitted using B1, where the temporally first transport block 2610 corresponds to a temporally first transport block 2610 that excludes UCI on one or more repetitions R. For example, the UE 115 may multiplex UCI 2617-a on R1 of TB1. Accordingly, the temporally first transport block 2610 that excludes UCI may correspond to TB2. The one or more rules may also indicate for the UE 115 to multiplex A-CSI 2620-b on a temporally first actual repetition of the temporally first transport block 2610 that is transmitted using B2. Accordingly, in accordance with the one or more rules, the UE 115 may multiplex the A-CSI 2620-a on R1 of TB2 and A-CSI 2620-b on R2 of TB2 and may transmit the transport blocks 2610 to the base station 105 using B1 and B2.

FIG. 26B illustrates an example of a multiplexing scheme 2600-b that supports techniques for CSI multiplexing on multiple PUSCH repetitions in accordance with aspects of the present disclosure. The multiplexing scheme 2600-b depicts DCI 2605-b transmitted by a base station 105 that schedules multiple PUSCH repetitions over multiple transport blocks 2610 according to a PUSCH repetition type B and an interlaced transport block mapping. For example, the DCI 2605-b may schedule PUSCH repetitions over repetitions of transport blocks 2610 (e.g., TB1, TB2, and TB3) spanning a quantity of slots 2615 in a time domain (e.g., spanning slots S1, S2, S3, S4, and S5) and indicate an interlaced mapping for the transport blocks 2610. In the example of FIG. 26B, each of the transport blocks 2610 may include two nominal repetitions, where TB1 may include four actual repetitions R1, R2, R3, and R4, TB2 may include three actual repetitions R1, R2, and R3, and TB3 may include two actual repetitions R1 and R2.

A UE 115 may be configured (e.g., via the DCI 2605-b) to transmit a first subset of the repetitions of the transport blocks 2610 using a first beam (e.g., B1) and a second subset of the repetitions of the transport blocks 2610 using a second beam (e.g., B2), where the beams B1 and B2 may be different directional beams formed by the UE 115. In some examples, the first subset and the second subset may correspond to the nominal repetitions of TB1, TB2, and TB3. For example, the UE 115 may be configured to transmit the first nominal repetitions of TB1 and TB3 and the second nominal repetition of TB2 using B1 and to transmit the first nominal repetition of TB2 and the second nominal repetitions of TB1 and TB3 using B2. As a result, the UE 115 may transmit R1 of TB1, R2 of TB1, R1 of TB3, R2 of TB2, and R3 of TB2 using B1 and R1 of TB2, R3 of TB1, R4 of TB1, and R2 of TB3 using B2.

In response to receiving the DCI 2605-b, the UE 115 may multiplex A-CSI 2620 on transmission occasions for each beam in accordance with one or more rules that indicate for the UE 115 to multiplex A-CSI 2620 on repetitions of a same transport block 2610. For example, the one or more rules may indicate for the UE 115 to multiplex A-CSI 2620-c on a temporally first actual repetition of a temporally first transport block 2610 that is transmitted using B1, where the temporally first transport block 2610 corresponds to a temporally first transport block 2610 that excludes UCI on one or more repetitions R. For example, the UE 115 may multiplex UCI 2617-b on R1 of TB1. Accordingly, the temporally first transport block 2610 that excludes UCI may correspond to TB2. The one or more rules may also indicate for the UE 115 to multiplex A-CSI 2620-d on a temporally first actual repetition of the temporally first transport block 2610 that is transmitted using B2. Accordingly, in accordance with the one or more rules, the UE 115 may multiplex the A-CSI 2620-c on R2 of TB2 and A-CSI 2620-d on R1 of TB2 and may transmit the transport blocks 2610 to the base station 105 using B1 and B2.

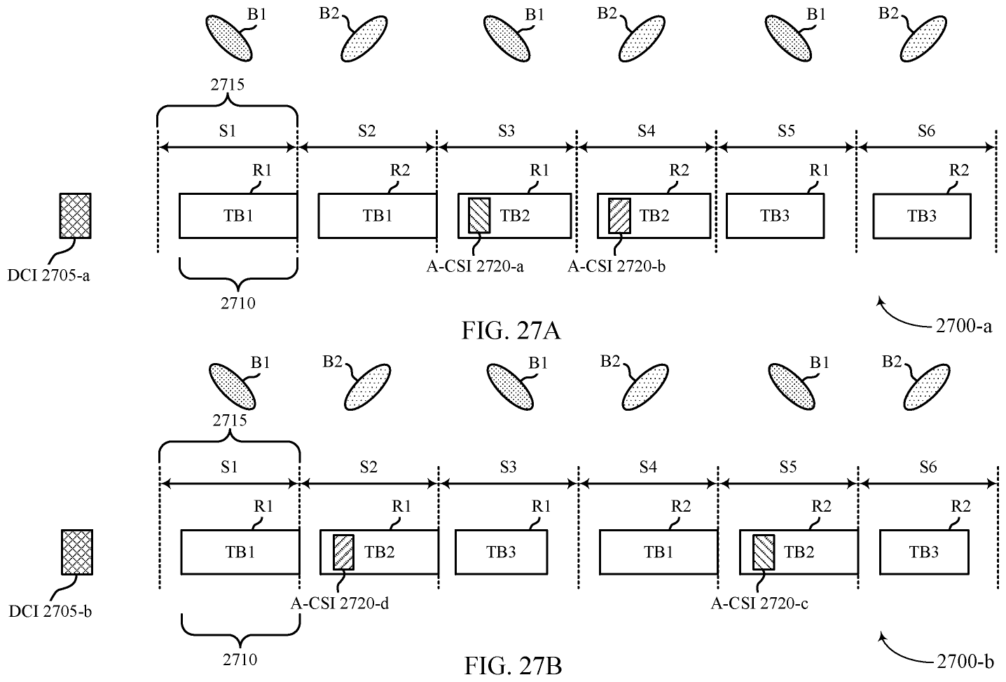

FIG. 27A illustrates an example of a multiplexing scheme 2700-a that supports techniques for CSI multiplexing on multiple PUSCH repetitions in accordance with aspects of the present disclosure. The multiplexing scheme 2700-a depicts DCI 2705-a transmitted by a base station 105 that schedules multiple PUSCH repetitions over multiple transport blocks 2710 according to a PUSCH repetition type A and a sequential transport block mapping. For example, the DCI 2705-a may schedule PUSCH repetitions over repetitions of transport blocks 2710 (e.g., TB1, TB2, and TB3) spanning a quantity of slots 2715 in a time domain (e.g., spanning slots S1, S2, S3, S4, S5, and S6) and indicate that the repetitions of the TB1, TB2, TB3, and TB4 are sequentially mapped. In the example of FIG. 27A, each of the transport blocks 2710 may include a first repetition R1 and a second repetition R2 with each slot 2715 including a single repetition of a transport block 2710.

A UE 115 may be configured (e.g., via the DCI 2705-a) to transmit a first subset of the repetitions of the transport blocks 2710 using a first beam (e.g., B1) and a second subset of the repetitions of the transport blocks 2710 using a second beam (e.g., B2), where the beams B1 and B2 may be different directional beams formed by the UE 115. For example, the UE 115 may be configured to transmit R1 of TB1, R1 of TB2, and R1 of TB3 using B1 and R2 of TB1, R2 of TB2, and R2 of TB3 using B2.

In response to receiving the DCI 2705-a, the UE 115 may multiplex A-CSI 2720 on transmission occasions for each beam in accordance with one or more rules that indicate for the UE 115 to multiplex A-CSI 2720 on repetitions of a same transport block 2710. For example, the one or more rules may indicate for the UE 115 to multiplex A-CSI 2720-a on a temporally first repetition of a penultimate transport block 2710 that is transmitted using B1 and A-CSI 2720-b on a temporally first repetition of the penultimate transport block 2710 that is transmitted using B2. Accordingly, in accordance with the one or more rules, the UE 115 may multiplex the A-CSI 2720-a on R1 of TB2 and A-CSI 2720-b on R2 of TB2 and may transmit the transport blocks 2710 to the base station 105 using B1 and B2.

In some examples, if the DCI 2705-a schedules the repetitions of TB1 and TB2 and does not schedule additional repetitions of additional transport blocks 2710 (e.g., R1 and R2 of TB3), the rules may indicate for the UE 115 to multiplex A-CSI 2720-a on a temporally first repetition of a temporally last transport block 2710 that is transmitted using B1 (e.g., R1 of TB2) and A-CSI 2720-b on a temporally first repetition of the temporally last transport block that is transmitted using B2 (e.g., R2 of TB2).

FIG. 27B illustrates an example of a multiplexing scheme 2700-b that supports techniques for CSI multiplexing on multiple PUSCH repetitions in accordance with aspects of the present disclosure. The multiplexing scheme 2700-b depicts DCI 2705-b transmitted by a base station 105 that schedules multiple PUSCH repetitions over multiple transport blocks 2710 according to a PUSCH repetition type A and an interlaced transport block mapping. For example, the DCI 2705-b may schedule PUSCH repetitions over repetitions of transport blocks 2710 (e.g., TB1, TB2, and TB3) spanning a quantity of slots 2715 in a time domain (e.g., spanning slots S1, S2, S3, S4, S5, and S6) and indicate an interlaced mapping for the transport blocks 2710. In the example of FIG. 27B, each of the transport blocks 2710 may include a first repetition R1 and a second repetition R2 with each slot 2715 including a single repetition of a transport block 2710.

A UE 115 may be configured (e.g., via the DCI 2705-b) to transmit a first subset of the repetitions of the transport blocks 2710 using a first beam (e.g., B1) and a second subset of the repetitions of the transport blocks 2710 using a second beam (e.g., B2), where the beams B1 and B2 may be different directional beams formed by the UE 115. For example, the UE 115 may be configured to transmit R1 of TB1, R1 of TB3, and R2 of TB2 using B1 and R1 of TB2, R2 of TB1, and R2 of TB3 using B2.

In response to receiving the DCI 2705-b, the UE 115 may multiplex A-CSI 2720 on transmission occasions for each beam in accordance with one or more rules that indicate for the UE 115 to multiplex A-CSI 2720 on repetitions of a same transport block 2710. For example, the one or more rules may indicate for the UE 115 to multiplex A-CSI 2720-c on a temporally first repetition of a penultimate transport block 2710 that is transmitted using B1 and A-CSI 2720-d on a temporally first repetition of the penultimate transport block 2710 that is transmitted using B2. Accordingly, in accordance with the one or more rules, the UE 115 may multiplex the A-CSI 2720-c on R2 of TB2 and the A-CSI 2720-d on R1 of TB2 and may transmit the transport blocks 2710 to the base station 105 using B1 and B2.

In some examples, if the DCI 2705-b schedules the repetitions of TB1 and TB2 and does not schedule additional repetitions of additional transport blocks 2710 (e.g., R1 and R2 of TB3), the rules may indicate for the UE 115 to multiplex A-CSI 2720-c on a temporally first repetition of a temporally last transport block 2710 that is transmitted using B1 (e.g., R2 of TB2) and A-CSI 2720-d on a temporally first repetition of the temporally last transport block that is transmitted using B2 (e.g., R1 of TB2).

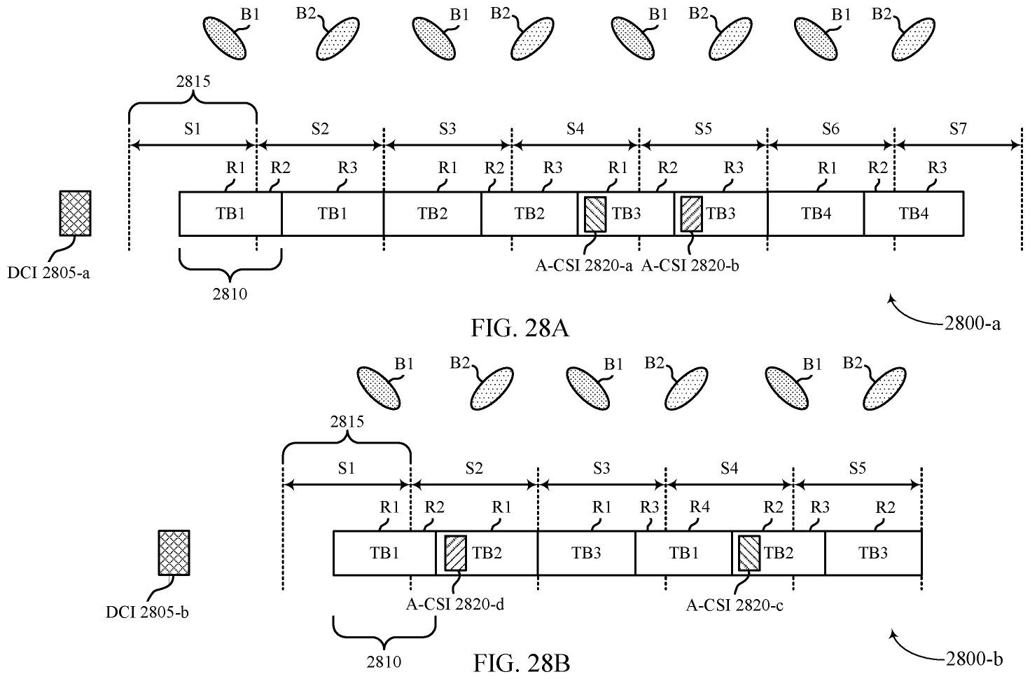

FIG. 28A illustrates an example of a multiplexing scheme 2800-a that supports techniques for CSI multiplexing on multiple PUSCH repetitions in accordance with aspects of the present disclosure. The multiplexing scheme 2800-a depicts DCI 2805-a transmitted by a base station 105 that schedules multiple PUSCH repetitions over multiple transport blocks 2810 according to a PUSCH repetition type B and a sequential transport block mapping. For example, the DCI 2805-a may schedule PUSCH repetitions over repetitions of transport blocks 2810 (e.g., TB1, TB2, TB3, and TB4) spanning a quantity of slots 2815 in a time domain (e.g., spanning slots S1, S2, S3, S4, S5, S6, and S7) and indicate that the repetitions of the TB1, TB2, TB3, and TB4 are sequentially mapped. In the example of FIG. 28A, each of the transport blocks 2810 may include two nominal repetitions, and each of the transport blocks TB1, TB2, TB3, and TB4 may include three actual repetitions R1, R2, and R3.

A UE 115 may be configured (e.g., via the DCI 2805-a) to transmit a first subset of the repetitions of the transport blocks 2810 using a first beam (e.g., B1) and a second subset of the repetitions of the transport blocks 2810 using a second beam (e.g., B2), where the beams B1 and B2 may be different directional beams formed by the UE 115. In some examples, the first subset and the second subset may correspond to the nominal repetitions of TB1, TB2, TB3, and TB4. For example, the UE 115 may be configured to transmit the first nominal repetition of TB1, TB2, TB3, and TB4 using B1 and the second nominal repetition of TB1, TB2, TB3, and TB4 using B2. As a result, the UE 115 may transmit R1 of TB1, R2 of TB1, R1 of TB2, R1 of TB3, R2 of TB3, and R1 of TB4 using B1 and R3 of TB1, R2 of TB2, R3 of TB2, R3 of TB3, R2 of TB4, and R3 of TB4 using B2.

In response to receiving the DCI 2805-a, the UE 115 may multiplex A-CSI 2820 on transmission occasions for each beam in accordance with one or more rules that indicate for the UE 115 to multiplex A-CSI 2820 on repetitions of a same transport block 2810. For example, the one or more rules may indicate for the UE 115 to multiplex A-CSI 2820-a on a temporally first actual repetition of a penultimate transport block 2810 that is transmitted using B1 and A-CSI 2820-b on a temporally first actual repetition of the penultimate transport block 2810 that is transmitted using B2. Accordingly, in accordance with the one or more rules, the UE 115 may multiplex the A-CSI 2820-a on R1 of TB3 and the A-CSI 2820-b on R3 of TB3 and may transmit the transport blocks 2810 to the base station 105 using B1 and B2.

In some examples, if the DCI 2805-a schedules the repetitions of TB1 and TB2 and does not schedule additional repetitions of additional transport blocks 2810 (e.g., repetitions of TB3 and TB4), the rules may indicate for the UE 115 to multiplex A-CSI 2820-a on a temporally first actual repetition of a temporally last transport block 2810 that is transmitted using B1 (e.g., R1 of TB2) and A-CSI 2820-b on a temporally first actual repetition of the temporally last transport block that is transmitted using B2 (e.g., R2 of TB2).

FIG. 28B illustrates an example of a multiplexing scheme 2800-b that supports techniques for CSI multiplexing on multiple PUSCH repetitions in accordance with aspects of the present disclosure. The multiplexing scheme 2800-b depicts DCI 2805-b transmitted by a base station 105 that schedules multiple PUSCH repetitions over multiple transport blocks 2810 according to a PUSCH repetition type B and an interlaced transport block mapping. For example, the DCI 2805-b may schedule PUSCH repetitions over repetitions of transport blocks 2810 (e.g., TB1, TB2, and TB3) spanning a quantity of slots 2815 in a time domain (e.g., spanning slots S1, S2, S3, S4, and S5) and indicate an interlaced mapping for the transport blocks 2810. In the example of FIG. 28B, each of the transport blocks 2810 may include two nominal repetitions, where TB1 may include four actual repetitions R1, R2, R3, and R4, TB2 may include three actual repetitions R1, R2, and R3, and TB3 may include two actual repetitions R1 and R2.

A UE 115 may be configured (e.g., via the DCI 2805-b) to transmit a first subset of the repetitions of the transport blocks 2810 using a first beam (e.g., B1) and a second subset of the repetitions of the transport blocks 2810 using a second beam (e.g., B2), where the beams B1 and B2 may be different directional beams formed by the UE 115. In some examples, the first subset and the second subset may correspond to the nominal repetitions of TB1, TB2, and TB3. For example, the UE 115 may be configured to transmit the first nominal repetitions of TB1 and TB3 and the second nominal repetition of TB2 using B1 and to transmit the first nominal repetition of TB2 and the second nominal repetitions of TB1 and TB3 using B2. As a result, the UE 115 may transmit R1 of TB1, R2 of TB1, R1 of TB3, R2 of TB2, and R3 of TB2 using B1 and R1 of TB2, R3 of TB1, R4 of TB1, and R2 of TB3 using B2.

In response to receiving the DCI 2805-b, the UE 115 may multiplex A-CSI 2820 on transmission occasions for each beam in accordance with one or more rules that indicate for the UE 115 to multiplex A-CSI 2820 on repetitions of a same transport block 2810. For example, the one or more rules may indicate for the UE 115 to multiplex A-CSI 2820-c on a temporally first actual repetition of a penultimate transport block 2810 that is transmitted using B1 and A-CSI 2820-d on a temporally first actual repetition of the penultimate transport block 2810 that is transmitted using B2. Accordingly, in accordance with the one or more rules, the UE 115 may multiplex the A-CSI 2820-c on R2 of TB2 and the A-CSI 2820-d on R1 of TB2 and may transmit the transport blocks 2810 to the base station 105 using B1 and B2.

In some examples, if the DCI 2805-b schedules the repetitions of TB1 and TB2 and does not schedule additional repetitions of additional transport blocks 2810 (e.g., repetitions of TB3), the rules may indicate for the UE 115 to multiplex A-CSI 2820-c on a temporally first actual repetition of a temporally last transport block 2810 that is transmitted using B1 (e.g., R2 of TB2) and A-CSI 2820-d on a temporally first actual repetition of the temporally last transport block that is transmitted using B2 (e.g., R1 of TB2).

In some examples, to support the rules described with reference to FIGS. 23A through 28B, additional rules may be defined (e.g., configured by a base station 105). In some cases, the additional rules may indicate that a UE 115 is to multiplex A-CSI in accordance with one or more of the rules described with reference to FIGS. 23A through 28B if the repetitions of the same transport block 2810 that include the multiplexed A-CSI include a same quantity of symbols and that UCI different from the A-CSI is excluded from each of the repetitions R. In some examples, if the additional rules fail to be satisfied or if the UE 115 is not configured to follow the additional rules, the UE 115 may be configured to multiplex first A-CSI on a temporally first transmission occasion associated with B1 and drop multiplexing of second A-CSI on a transmission occasion associated with B2.

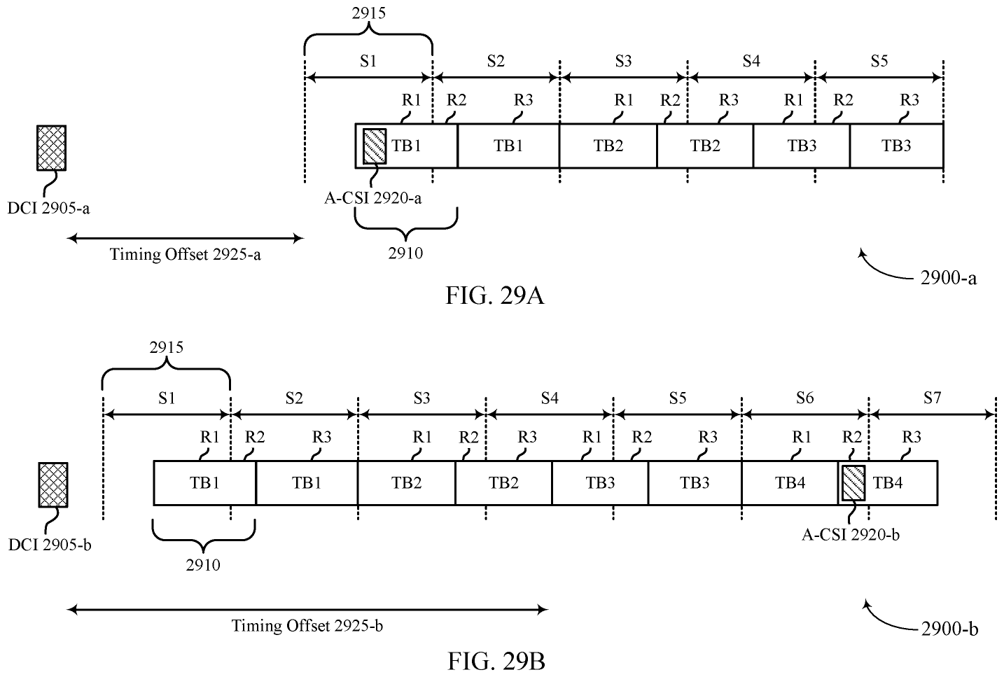

FIGS. 29A and 29B illustrate examples of multiplexing schemes 2900 that support techniques for CSI multiplexing on multiple PUSCH repetitions in accordance with aspects of the present disclosure. The multiplexing schemes 2900 may be implemented by aspects of the wireless communications system 100 and 200 as described with reference to FIGS. 1 and 2, respectively. For example, the multiplexing schemes 2900 may be implemented by a UE 115 and a base station 105 to support A-CSI multiplexing rule selection.

It is noted that, for illustrative purposes FIGS. 29A and 29B depict PUSCH repetitions scheduled over multiple transport blocks according to a PUSCH repetition type B and transmitted using a single beam. However, the principles disclosed herein may be adapted and applied for A-CSI multiplexing rules to be selected based on PUSCH repetitions scheduled over multiple transport blocks according to any PUSCH repetition type and transmitted using any quantity of beams.

FIG. 29A illustrates an example of a multiplexing scheme 2900-a that depicts DCI 2905-a transmitted by a base station 105 that schedules multiple PUSCH repetitions over multiple transport blocks 2910 according to a PUSCH repetition type B. For example, the DCI 2905-a may schedule PUSCH repetitions over repetitions of transport blocks 2910 (e.g., TB1, TB2, and TB3) spanning a quantity of slots 2915 in a time domain (e.g., spanning slots S1, S2, S3, S4, and S5). In the example of FIG. 29A, each of the transport blocks 2910 may include two nominal repetitions, where each of the transport blocks TB1, TB2, and TB3 may include three actual repetitions R1, R2, and R3.

The DCI 2905-a may indicate a timing offset 2925-a between reception of the DCI 2905-a and the transmission of the transport blocks 2910 that may be used to select one or more rules for multiplexing A-CSI 2920 on a repetition of a transport block 2910. For example, the UE 115 may select the one or more rules based on when the transport blocks 2910 are transmitted in relation to the timing offset 2925-a. In the example of FIG. 29A, the UE 115 may transmit the transport blocks 2910 after an expiration of the timing offset 2925-a. Accordingly, the UE 115 may determine that the timing offset 2925-a is satisfied and may select rules that indicate for the UE 115 to multiplex A-CSI 2920-a on a temporally first transmission occasion of the transport blocks (e.g., although selection of other rules described herein is possible). Thus, in accordance with the selected rules, the UE 115 may multiplex the A-CSI 2920-a on R1 of TB1 and may transmit the transport blocks 2910 to the base station 105.

FIG. 29B illustrates an example of a multiplexing scheme 2900-b that depicts DCI 2905-btransmitted by a base station 105 that schedules multiple PUSCH repetitions over multiple transport blocks 2910 according to a PUSCH repetition type B. For example, the DCI 2905-b may schedule PUSCH repetitions over repetitions of transport blocks 2910 (e.g., TB1, TB2, TB3, and TB4) spanning a quantity of slots 2915 in a time domain (e.g., spanning slots S1, S2, S3, S4, S5, S6, and S7). In the example of FIG. 29B, each of the transport blocks 2910 may include two nominal repetitions, and each of the transport blocks TB1, TB2, TB3, and TB4 may include three actual repetitions R1, R2, and R3.

The DCI 2905-b may indicate a timing offset 2925-b between reception of the DCI 2905-b and the transmission of the transport blocks 2910 that may be used to select one or more rules for multiplexing A-CSI 2920 on a repetition of a transport block 2910. For example, the UE 115 may select the one or more rules based on when the transport blocks 2910 are transmitted in relation to the timing offset 2925-b. In the example of FIG. 29B, the UE 115 may transmit at least some of the transport blocks 2910 before an expiration of the timing offset 2925-b. Accordingly, the UE 115 may determine that the timing offset 2925-b fails to be satisfied. Here, the UE 115 may select rules that indicate for the UE 115 to multiplex A-CSI 2920-b on a transmission occasion that occurs after the expiration of the timing offset 2925-b. For example, the UE 115 may select rules that indicate for the UE 115 to multiplex A-CSI 2920-a on a penultimate transmission occasion of the transport blocks (e.g., although selection of other rules described herein is possible). Thus, in accordance with the selected rules, the UE 115 may multiplex the A-CSI 2920-b on R2 of TB4 and may transmit the transport blocks 2910 to the base station 105.

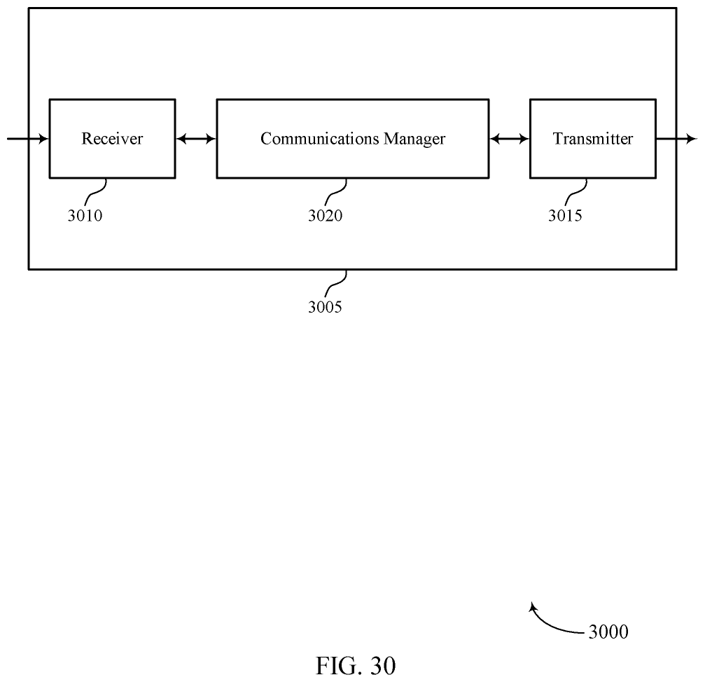

FIG. 30 shows a block diagram 3000 of a device 3005 that supports techniques for CSI multiplexing on multiple PUSCH repetitions in accordance with aspects of the present disclosure. The device 3005 may be an example of aspects of a UE 115 as described herein. The device 3005 may include a receiver 3010, a transmitter 3015, and a communications manager 3020. The device 3005 may also include a processor. Each of these components may be in communication with one another (e.g., via one or more buses).

The receiver 3010 may provide a means for receiving information such as packets, user data, control information, or any combination thereof associated with various information channels (e.g., control channels, data channels, information channels related to techniques for CSI multiplexing on multiple PUSCH repetitions). Information may be passed on to other components of the device 3005. The receiver 3010 may utilize a single antenna or a set of multiple antennas.

The transmitter 3015 may provide a means for transmitting signals generated by other components of the device 3005. For example, the transmitter 3015 may transmit information such as packets, user data, control information, or any combination thereof associated with various information channels (e.g., control channels, data channels, information channels related to techniques for CSI multiplexing on multiple PUSCH repetitions). In some examples, the transmitter 3015 may be co-located with a receiver 3010 in a transceiver module. The transmitter 3015 may utilize a single antenna or a set of multiple antennas.

The communications manager 3020, the receiver 3010, the transmitter 3015, or various combinations thereof or various components thereof may be examples of means for performing various aspects of techniques for CSI multiplexing on multiple PUSCH repetitions as described herein. For example, the communications manager 3020, the receiver 3010, the transmitter 3015, or various combinations or components thereof may support a method for performing one or more of the functions described herein.

In some examples, the communications manager 3020, the receiver 3010, the transmitter 3015, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 3020, the receiver 3010, the transmitter 3015, or various combinations or components thereof may be implemented in code (e.g., as communications management software or firmware) executed by a processor. If implemented in code executed by a processor, the functions of the communications manager 3020, the receiver 3010, the transmitter 3015, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 3020 may be configured to perform various operations (e.g., receiving, monitoring, transmitting) using or otherwise in cooperation with the receiver 3010, the transmitter 3015, or both. For example, the communications manager 3020 may receive information from the receiver 3010, send information to the transmitter 3015, or be integrated in combination with the receiver 3010, the transmitter 3015, or both to receive information, transmit information, or perform various other operations as described herein.

The communications manager 3020 may support wireless communication at a UE in accordance with examples as disclosed herein. For example, the communications manager 3020 may be configured as or otherwise support a means for receiving DCI scheduling a set of multiple uplink data transmissions over a set of multiple transport blocks, the set of multiple uplink data transmissions including at least one repetition of a PUSCH over two or more transport blocks of the set of multiple transport blocks. The communications manager 3020 may be configured as or otherwise support a means for multiplexing A-CSI on a transport block of the set of multiple transport blocks in accordance with a type of repetition of the PUSCH and one or more rules associated with the set of multiple transport blocks. The communications manager 3020 may be configured as or otherwise support a means for transmitting, to a base station, the set of multiple transport blocks including the transport block including the multiplexed A-CSI.

By including or configuring the communications manager 3020 in accordance with examples as described herein, the device 3005 (e.g., a processor controlling or otherwise coupled to the receiver 3010, the transmitter 3015, the communications manager 3020, or a combination thereof) may support techniques for reduced processing and more efficient utilization of communication resources by managing A-CSI multiplexing associated with the transmission of multiple transport blocks (e.g., repetitions of a transport block, repetitions of multiple transport blocks, or both).

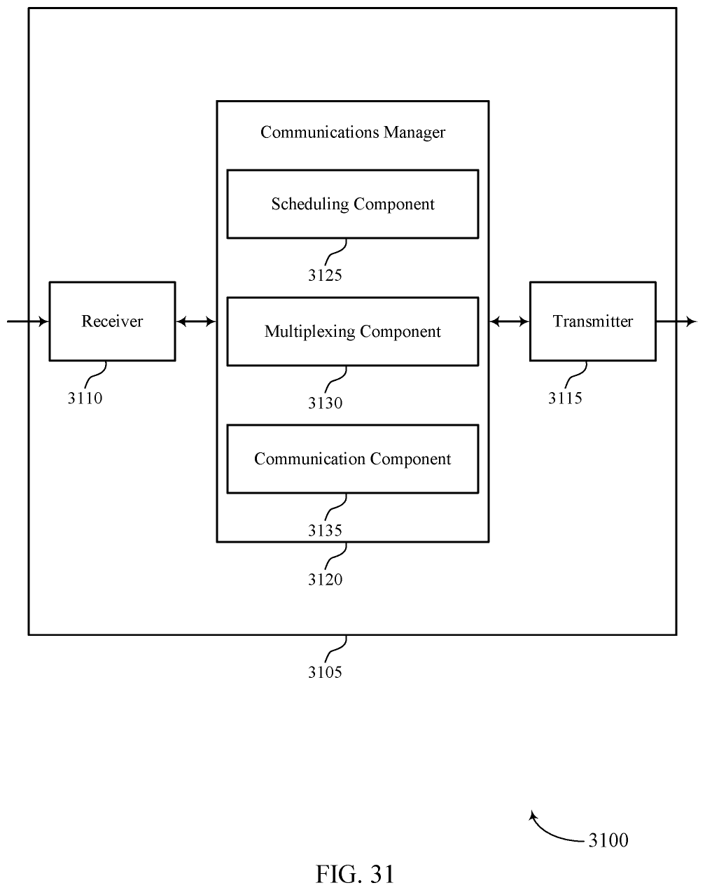

FIG. 31 shows a block diagram 3100 of a device 3105 that supports techniques for CSI multiplexing on multiple PUSCH repetitions in accordance with aspects of the present disclosure. The device 3105 may be an example of aspects of a device 3005 or a UE 115 as described herein. The device 3105 may include a receiver 3110, a transmitter 3115, and a communications manager 3120. The device 3105 may also include a processor. Each of these components may be in communication with one another (e.g., via one or more buses).

The receiver 3110 may provide a means for receiving information such as packets, user data, control information, or any combination thereof associated with various information channels (e.g., control channels, data channels, information channels related to techniques for CSI multiplexing on multiple PUSCH repetitions). Information may be passed on to other components of the device 3105. The receiver 3110 may utilize a single antenna or a set of multiple antennas.

The transmitter 3115 may provide a means for transmitting signals generated by other components of the device 3105. For example, the transmitter 3115 may transmit information such as packets, user data, control information, or any combination thereof associated with various information channels (e.g., control channels, data channels, information channels related to techniques for CSI multiplexing on multiple PUSCH repetitions). In some examples, the transmitter 3115 may be co-located with a receiver 3110 in a transceiver module. The transmitter 3115 may utilize a single antenna or a set of multiple antennas.

The device 3105, or various components thereof, may be an example of means for performing various aspects of techniques for CSI multiplexing on multiple PUSCH repetitions as described herein. For example, the communications manager 3120 may include a scheduling component 3125, a multiplexing component 3130, a communication component 3135, or any combination thereof. The communications manager 3120 may be an example of aspects of a communications manager 3020 as described herein. In some examples, the communications manager 3120, or various components thereof, may be configured to perform various operations (e.g., receiving, monitoring, transmitting) using or otherwise in cooperation with the receiver 3110, the transmitter 3115, or both. For example, the communications manager 3120 may receive information from the receiver 3110, send information to the transmitter 3115, or be integrated in combination with the receiver 3110, the transmitter 3115, or both to receive information, transmit information, or perform various other operations as described herein.

The communications manager 3120 may support wireless communication at a UE in accordance with examples as disclosed herein. The scheduling component 3125 may be configured as or otherwise support a means for receiving DCI scheduling a set of multiple uplink data transmissions over a set of multiple transport blocks, the set of multiple uplink data transmissions including at least one repetition of a PUSCH over two or more transport blocks of the set of multiple transport blocks. The multiplexing component 3130 may be configured as or otherwise support a means for multiplexing A-CSI on a transport block of the set of multiple transport blocks in accordance with a type of repetition of the PUSCH and one or more rules associated with the set of multiple transport blocks. The communication component 3135 may be configured as or otherwise support a means for transmitting, to a base station, the set of multiple transport blocks including the transport block including the multiplexed A-CSI.

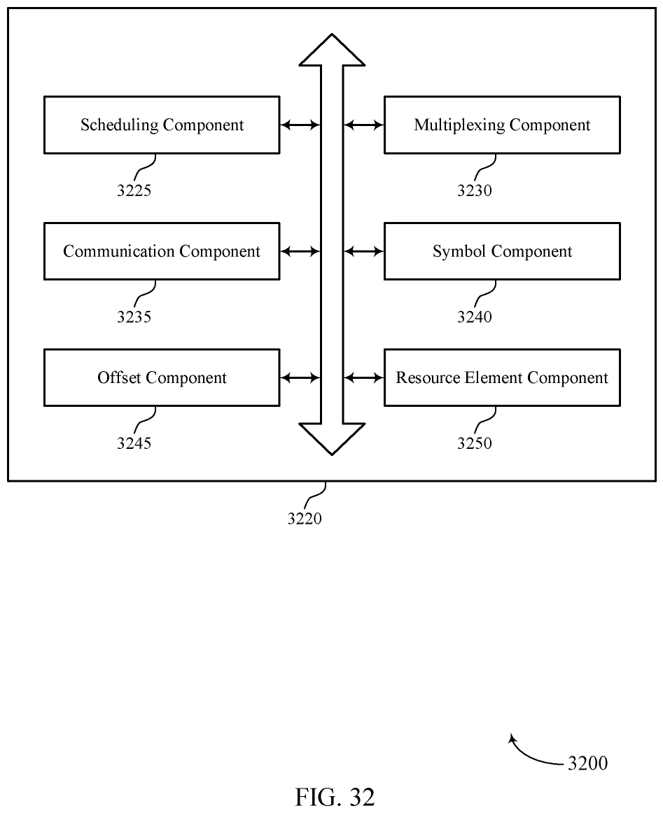

FIG. 32 shows a block diagram 3200 of a communications manager 3220 that supports techniques for CSI multiplexing on multiple PUSCH repetitions in accordance with aspects of the present disclosure. The communications manager 3220 may be an example of aspects of a communications manager 3020, a communications manager 3120, or both, as described herein. The communications manager 3220, or various components thereof, may be an example of means for performing various aspects of techniques for CSI multiplexing on multiple PUSCH repetitions as described herein. For example, the communications manager 3220 may include a scheduling component 3225, a multiplexing component 3230, a communication component 3235, a symbol component 3240, an offset component 3245, a resource element component 3250, or any combination thereof. Each of these components may communicate, directly or indirectly, with one another (e.g., via one or more buses).

The communications manager 3220 may support wireless communication at a UE in accordance with examples as disclosed herein. The scheduling component 3225 may be configured as or otherwise support a means for receiving DCI scheduling a set of multiple uplink data transmissions over a set of multiple transport blocks, the set of multiple uplink data transmissions including at least one repetition of a PUSCH over two or more transport blocks of the set of multiple transport blocks. The multiplexing component 3230 may be configured as or otherwise support a means for multiplexing A-CSI on a transport block of the set of multiple transport blocks in accordance with a type of repetition of the PUSCH and one or more rules associated with the set of multiple transport blocks. The communication component 3235 may be configured as or otherwise support a means for transmitting, to a base station, the set of multiple transport blocks including the transport block including the multiplexed A-CSI.

In some examples, to support multiplexing the A-CSI on the transport block, the multiplexing component 3230 may be configured as or otherwise support a means for multiplexing the A-CSI on a temporally first repetition of a temporally first transport block of the set of multiple transport blocks, the transport block corresponding to the temporally first repetition.

In some examples, the set of multiple transport blocks includes two repetitions of a same transport block or repetitions of different transport blocks. In some examples, to support multiplexing the A-CSI on the transport block, the multiplexing component 3230 may be configured as or otherwise support a means for multiplexing the A-CSI on a temporally second repetition of the two repetitions of the same transport block or on a temporally second transport block of the different transport blocks, the transport block corresponding to the temporally second repetition or the temporally second transport block.

In some examples, to support multiplexing the A-CSI on the transport block, the multiplexing component 3230 may be configured as or otherwise support a means for multiplexing the A-CSI on a penultimate transmission occasion associated with the set of multiple transport blocks based on the set of multiple transport blocks including at least three repetitions of a first transport block, at least three transport blocks, or a combination thereof, the transport block corresponding to the penultimate transmission occasion, where a transmission occasion corresponds to a single repetition of a single transport block of the set of multiple transport blocks.

In some examples, the set of multiple transport blocks includes repetitions of two different transport blocks. In some examples, to support multiplexing the A-CSI on the transport block, the multiplexing component 3230 may be configured as or otherwise support a means for multiplexing the A-CSI on a temporally first repetition of a temporally last transport block of the two different transport blocks based on the set of multiple transport blocks including the repetitions of the two different transport blocks, the transport block corresponding to the temporally first repetition.

In some examples, the set of multiple transport blocks includes repetitions of at least three different transport blocks. In some examples, to support multiplexing the A-CSI on the transport block, the multiplexing component 3230 may be configured as or otherwise support a means for multiplexing the A-CSI on a temporally first repetition of a penultimate transport block of the set of multiple transport blocks based on the set of multiple transport blocks including at least three different transport blocks, the transport block corresponding to the temporally first repetition.

In some examples, to support multiplexing the A-CSI on the transport block, the multiplexing component 3230 may be configured as or otherwise support a means for multiplexing the A-CSI on a penultimate repetition of a first transport block of the set of multiple transport blocks based on the first transport block being associated with a largest quantity of repetitions relative to remaining transport blocks of the set of multiple transport blocks, the transport block corresponding to the penultimate repetition of the first transport block.

In some examples, to support multiplexing the A-CSI on the transport block, the multiplexing component 3230 may be configured as or otherwise support a means for multiplexing the A-CSI on a temporally first repetition of a first transport block of the set of multiple transport blocks or on a temporally last repetition of the first transport block based on the first transport block being associated with a greatest symbol length indicated by a SLIV relative to remaining transport blocks of the set of multiple transport blocks, the transport block corresponding to the temporally first repetition or the temporally last repetition.

In some examples, the symbol component 3240 may be configured as or otherwise support a means for determining, for each transport block of the set of multiple transport blocks, a symbol length across repetitions of a respective transport block. In some examples, to multiplex the A-CSI on the transport block, the multiplexing component 3230 may be configured as or otherwise support a means for multiplexing the A-CSI on a temporally first repetition of a first transport block of the set of multiple transport blocks or on a temporally last repetition of the first transport block, the first transport block having a greatest symbol length across repetitions of the first transport block relative to remaining transport blocks of the set of multiple transport blocks, the transport block corresponding to the temporally first repetition or the temporally last repetition.

In some examples, to support multiplexing the A-CSI on the transport block, the multiplexing component 3230 may be configured as or otherwise support a means for multiplexing the A-CSI on a temporally last repetition of a temporally last transport block of the set of multiple transport blocks or on a temporally first repetition of the temporally last transport block, the transport block corresponding to the temporally last repetition or the temporally first repetition.

In some examples, the multiplexing component 3230 may be configured as or otherwise support a means for multiplexing second A-CSI on a second transport block of the set of multiple transport blocks in accordance with the type of repetition of the PUSCH and the one or more rules. In some examples, to transmit the set of multiple transport blocks, the communication component 3235 may be configured as or otherwise support a means for transmitting the transport block using a first beam for communicating with the base station and the communication component 3235 may be configured as or otherwise support a means for transmitting, to the base station using a second beam for communicating with the base station, the second transport block including the multiplexed second A-CSI, where the second beam is different from the first beam.

In some examples, to support multiplexing the A-CSI on the transport block, the multiplexing component 3230 may be configured as or otherwise support a means for multiplexing the A-CSI on a temporally first transmission occasion associated with the first beam, the transport block corresponding to the temporally first transmission occasion associated with the first beam, where a transmission occasion corresponds to a single repetition of a single transport block of the set of multiple transport blocks. In some examples, to multiplex the second A-CSI on the second transport block, the multiplexing component 3230 may be configured as or otherwise support a means for multiplexing the second A-CSI on a temporally first transmission occasion associated with the second beam, the second transport block corresponding to the temporally first transmission occasion associated with the second beam.

In some examples, to support multiplexing the A-CSI on the transport block, the multiplexing component 3230 may be configured as or otherwise support a means for multiplexing the A-CSI on a temporally last transmission occasion associated with the first beam, the transport block corresponding to the temporally last transmission occasion associated with the first beam, where a transmission occasion corresponds to a single repetition of a single transport block of the set of multiple transport blocks. In some examples, to multiplex the second A-CSI on the second transport block, the multiplexing component 3230 may be configured as or otherwise support a means for multiplexing the second A-CSI on a temporally last transmission occasion associated with the second beam, the second transport block corresponding to the temporally last transmission occasion associated with the second beam.

In some examples, to support multiplexing the A-CSI on the transport block, the multiplexing component 3230 may be configured as or otherwise support a means for multiplexing the A-CSI on a penultimate transmission occasion associated with the first beam, the transport block corresponding to the penultimate transmission occasion associated with the first beam, where a transmission occasion corresponds to a single repetition of a single transport block of the set of multiple transport blocks. In some examples, to multiplex the second A-CSI on the second transport block, the multiplexing component 3230 may be configured as or otherwise support a means for multiplexing the second A-CSI on a penultimate transmission occasion associated with the second beam, the second transport block corresponding to the penultimate transmission occasion associated with the second beam.

In some examples, to support multiplexing the A-CSI on the transport block, the multiplexing component 3230 may be configured as or otherwise support a means for multiplexing the A-CSI on a first transmission occasion associated with the first beam and including a largest quantity of resource elements for A-CSI multiplexing relative to other transmission occasions associated with the first beam, the transport block corresponding to the first transmission occasion associated with the first beam, where a transmission occasion corresponds to a single repetition of a single transport block of the set of multiple transport blocks. In some examples, to multiplex the second A-CSI on the second transport block, the multiplexing component 3230 may be configured as or otherwise support a means for multiplexing the second A-CSI on a second transmission occasion associated with the second beam and including a largest quantity of resource elements for A-CSI multiplexing relative to other transmission occasions associated with the second beam, the second transport block corresponding to the second transmission occasion associated with the second beam.

In some examples, the transport block and the second transport block include a same quantity of resource elements for A-CSI multiplexing. In some examples, the resource element component 3250 may be configured as or otherwise support a means for determining that the transport block and the second transport block include a same quantity of resource elements for A-CSI multiplexing based on: UCI different from the A-CSI and the second A-CSI being excluded from the transport block and the second transport block; or the transport block and the second transport block each corresponding to respective initial transmissions or retransmissions associated with the first beam and the second beam, including a same quantity of symbols, being associated with a same modulation and coding scheme, including a same quantity of resource blocks, including a same quantity of layers, including a same quantity of resource elements for DMRSs, or a combination thereof.

In some examples, the resource element component 3250 may be configured as or otherwise support a means for determining a quantity of resource elements for A-CSI associated with the transport block. In some examples, the resource element component 3250 may be configured as or otherwise support a means for determining a temporally first transmission occasion associated with the second beam that includes the quantity of resource elements, a temporally last transmission occasion associated with the second beam that includes the quantity of resource elements, or a temporally penultimate transmission occasion associated with the second beam that includes the quantity of resource elements, where a transmission occasion corresponds to a single repetition of a single transport block of the set of multiple transport blocks, and where the second transport block corresponds to the temporally first transmission occasion, the temporally last transmission occasion, or the temporally penultimate transmission occasion.

In some examples, the resource element component 3250 may be configured as or otherwise support a means for determining a quantity of resource elements for A-CSI associated with the transport block, where the A-CSI and the second A-CSI are multiplexed using the determined quantity of resource elements.

In some examples, to support multiplexing the A-CSI on the transport block, the multiplexing component 3230 may be configured as or otherwise support a means for multiplexing the A-CSI on a temporally first repetition of a first transport block of the set of multiple transport blocks that is associated with the first beam, the transport block corresponding to the temporally first repetition associated with the first beam. In some examples, to multiplex the second A-CSI on the second transport block, the multiplexing component 3230 may be configured as or otherwise support a means for multiplexing the second A-CSI on a temporally first repetition of the first transport block that is associated with the second beam, the second transport block corresponding to the temporally first repetition associated with the second beam.

In some examples, the first transport block corresponds to a temporally first transport block of the set of multiple transport blocks, a penultimate transport block of the set of multiple transport blocks, or a temporally last transport block of the set of multiple transport blocks. In some examples, the first transport block corresponds to a temporally first transport block of the set of multiple transport blocks that excludes UCI different from the A-CSI and the second A-CSI.

In some examples, the DCI indicates a timing offset between the reception of the DCI and the transmission of the set of multiple transport blocks. In some examples, the offset component 3245 may be configured as or otherwise support a means for selecting the one or more rules based on the timing offset being satisfied, where the A-CSI is multiplexed on the transport block based on the timing offset.

In some examples, the DCI indicates a timing offset between the reception of the DCI and the transmission of the set of multiple transport blocks. In some examples, the offset component 3245 may be configured as or otherwise support a means for selecting the one or more rules based on the timing offset failing to be satisfied, where the A-CSI is multiplexed on the transport block based on the timing offset. In some examples, the transport block has a duration of at least two symbols.

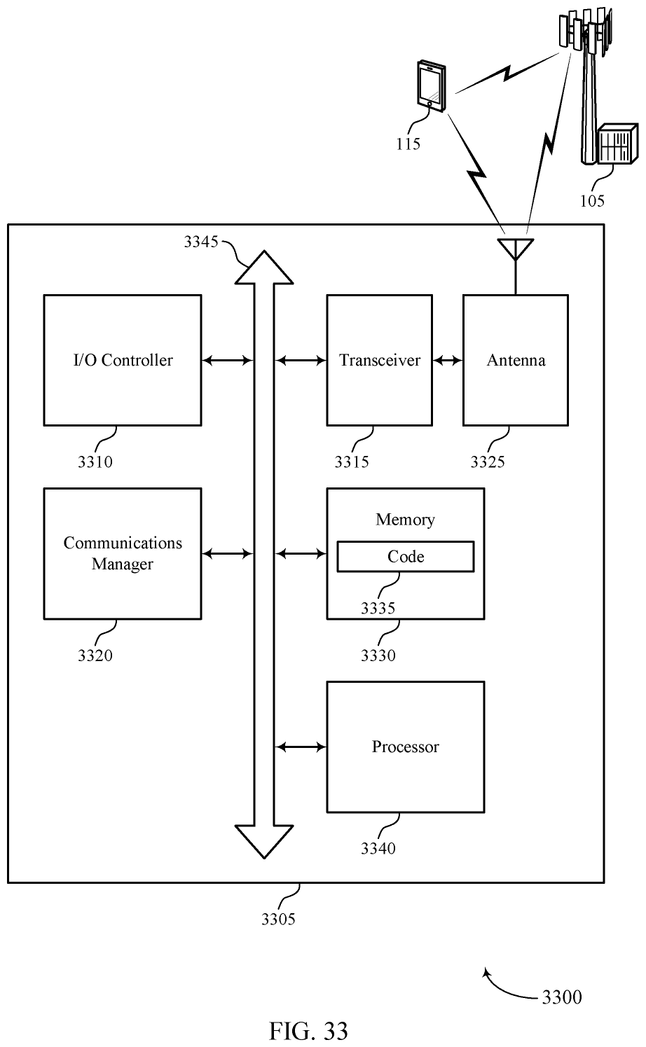

FIG. 33 shows a diagram of a system 3300 including a device 3305 that supports techniques for CSI multiplexing on multiple PUSCH repetitions in accordance with aspects of the present disclosure. The device 3305 may be an example of or include the components of a device 3005, a device 3105, or a UE 115 as described herein. The device 3305 may communicate wirelessly with one or more base stations 105, UEs 115, or any combination thereof. The device 3305 may include components for bi-directional voice and data communications including components for transmitting and receiving communications, such as a communications manager 3320, an input/output (I/O) controller 3310, a transceiver 3315, an antenna 3325, a memory 3330, code 3335, and a processor 3340. These components may be in electronic communication or otherwise coupled (e.g., operatively, communicatively, functionally, electronically, electrically) via one or more buses (e.g., a bus 3345).

The I/O controller 3310 may manage input and output signals for the device 3305. The I/O controller 3310 may also manage peripherals not integrated into the device 3305. In some cases, the I/O controller 3310 may represent a physical connection or port to an external peripheral. In some cases, the I/O controller 3310 may utilize an operating system such as iOS®, ANDROID®, MS-DOS®, MS-WINDOWS®, OS/2®, UNIX®, LINUX®, or another known operating system. Additionally or alternatively, the I/O controller 3310 may represent or interact with a modem, a keyboard, a mouse, a touchscreen, or a similar device. In some cases, the I/O controller 3310 may be implemented as part of a processor, such as the processor 3340. In some cases, a user may interact with the device 3305 via the I/O controller 3310 or via hardware components controlled by the I/O controller 3310.

In some cases, the device 3305 may include a single antenna 3325. However, in some other cases, the device 3305 may have more than one antenna 3325, which may be capable of concurrently transmitting or receiving multiple wireless transmissions. The transceiver 3315 may communicate bi-directionally, via the one or more antennas 3325, wired, or wireless links as described herein. For example, the transceiver 3315 may represent a wireless transceiver and may communicate bi-directionally with another wireless transceiver. The transceiver 3315 may also include a modem to modulate the packets, to provide the modulated packets to one or more antennas 3325 for transmission, and to demodulate packets received from the one or more antennas 3325. The transceiver 3315, or the transceiver 3315 and one or more antennas 3325, may be an example of a transmitter 3015, a transmitter 3115, a receiver 3010, a receiver 3110, or any combination thereof or component thereof, as described herein.

The memory 3330 may include random access memory (RAM) and read-only memory (ROM). The memory 3330 may store computer-readable, computer-executable code 3335 including instructions that, when executed by the processor 3340, cause the device 3305 to perform various functions described herein. The code 3335 may be stored in a non-transitory computer-readable medium such as system memory or another type of memory. In some cases, the code 3335 may not be directly executable by the processor 3340 but may cause a computer (e.g., when compiled and executed) to perform functions described herein. In some cases, the memory 3330 may contain, among other things, a basic I/O system (BIOS) which may control basic hardware or software operation such as the interaction with peripheral components or devices.

The processor 3340 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 3340 may be configured to operate a memory array using a memory controller. In some other cases, a memory controller may be integrated into the processor 3340. The processor 3340 may be configured to execute computer-readable instructions stored in a memory (e.g., the memory 3330) to cause the device 3305 to perform various functions (e.g., functions or tasks supporting techniques for CSI multiplexing on multiple PUSCH repetitions). For example, the device 3305 or a component of the device 3305 may include a processor 3340 and memory 3330 coupled to the processor 3340, the processor 3340 and memory 3330 configured to perform various functions described herein.

The communications manager 3320 may support wireless communication at a UE in accordance with examples as disclosed herein. For example, the communications manager 3320 may be configured as or otherwise support a means for receiving DCI scheduling a set of multiple uplink data transmissions over a set of multiple transport blocks, the set of multiple uplink data transmissions including at least one repetition of a PUSCH over two or more transport blocks of the set of multiple transport blocks. The communications manager 3320 may be configured as or otherwise support a means for multiplexing A-CSI on a transport block of the set of multiple transport blocks in accordance with a type of repetition of the PUSCH and one or more rules associated with the set of multiple transport blocks. The communications manager 3320 may be configured as or otherwise support a means for transmitting, to a base station, the set of multiple transport blocks including the transport block including the multiplexed A-CSI.

By including or configuring the communications manager 3320 in accordance with examples as described herein, the device 3305 may support techniques for improved reliability, latency, data rates, resource utilization, spectral efficiency, and coordination between devices, among other benefits.

In some examples, the communications manager 3320 may be configured to perform various operations (e.g., receiving, monitoring, transmitting) using or otherwise in cooperation with the transceiver 3315, the one or more antennas 3325, or any combination thereof. Although the communications manager 3320 is illustrated as a separate component, in some examples, one or more functions described with reference to the communications manager 3320 may be supported by or performed by the processor 3340, the memory 3330, the code 3335, or any combination thereof. For example, the code 3335 may include instructions executable by the processor 3340 to cause the device 3305 to perform various aspects of techniques for CSI multiplexing on multiple PUSCH repetitions as described herein, or the processor 3340 and the memory 3330 may be otherwise configured to perform or support such operations.

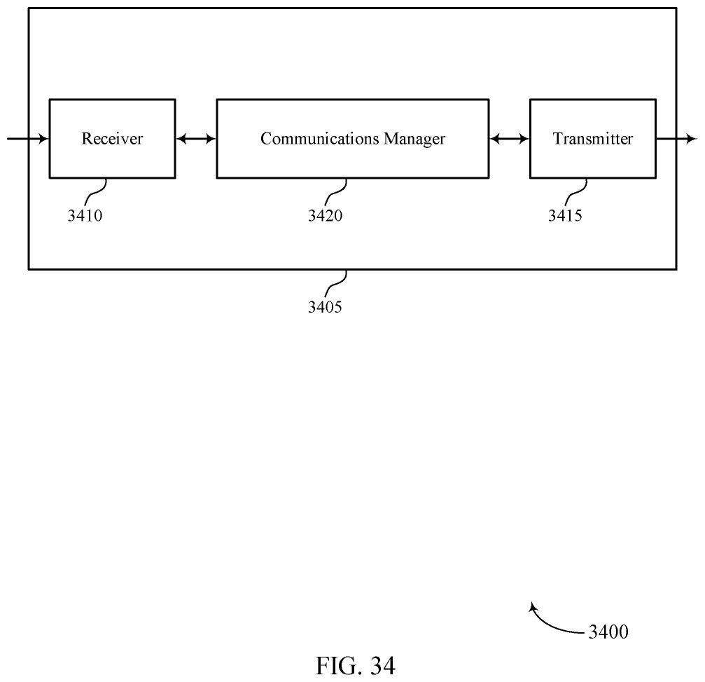

FIG. 34 shows a block diagram 3400 of a device 3405 that supports techniques for CSI multiplexing on multiple PUSCH repetitions in accordance with aspects of the present disclosure. The device 3405 may be an example of aspects of a base station 105 as described herein. The device 3405 may include a receiver 3410, a transmitter 3415, and a communications manager 3420. The device 3405 may also include a processor. Each of these components may be in communication with one another (e.g., via one or more buses).

The receiver 3410 may provide a means for receiving information such as packets, user data, control information, or any combination thereof associated with various information channels (e.g., control channels, data channels, information channels related to techniques for CSI multiplexing on multiple PUSCH repetitions). Information may be passed on to other components of the device 3405. The receiver 3410 may utilize a single antenna or a set of multiple antennas.

The transmitter 3415 may provide a means for transmitting signals generated by other components of the device 3405. For example, the transmitter 3415 may transmit information such as packets, user data, control information, or any combination thereof associated with various information channels (e.g., control channels, data channels, information channels related to techniques for CSI multiplexing on multiple PUSCH repetitions). In some examples, the transmitter 3415 may be co-located with a receiver 3410 in a transceiver module. The transmitter 3415 may utilize a single antenna or a set of multiple antennas.

The communications manager 3420, the receiver 3410, the transmitter 3415, or various combinations thereof or various components thereof may be examples of means for performing various aspects of techniques for CSI multiplexing on multiple PUSCH repetitions as described herein. For example, the communications manager 3420, the receiver 3410, the transmitter 3415, or various combinations or components thereof may support a method for performing one or more of the functions described herein.

In some examples, the communications manager 3420, the receiver 3410, the transmitter 3415, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 3420, the receiver 3410, the transmitter 3415, or various combinations or components thereof may be implemented in code (e.g., as communications management software or firmware) executed by a processor. If implemented in code executed by a processor, the functions of the communications manager 3420, the receiver 3410, the transmitter 3415, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 3420 may be configured to perform various operations (e.g., receiving, monitoring, transmitting) using or otherwise in cooperation with the receiver 3410, the transmitter 3415, or both. For example, the communications manager 3420 may receive information from the receiver 3410, send information to the transmitter 3415, or be integrated in combination with the receiver 3410, the transmitter 3415, or both to receive information, transmit information, or perform various other operations as described herein.

The communications manager 3420 may support wireless communication at a base station in accordance with examples as disclosed herein. For example, the communications manager 3420 may be configured as or otherwise support a means for transmitting, to a UE, DCI scheduling a set of multiple uplink data transmissions over a set of multiple transport blocks, the set of multiple uplink data transmissions including at least one repetition of a PUSCH over two or more transport blocks of the set of multiple transport blocks. The communications manager 3420 may be configured as or otherwise support a means for receiving, from the UE, the set of multiple transport blocks including a transport block including A-CSI that is multiplexed in accordance with a type of repetition of the PUSCH and one or more rules associated with the set of multiple transport blocks.

By including or configuring the communications manager 3420 in accordance with examples as described herein, the device 3405 (e.g., a processor controlling or otherwise coupled to the receiver 3410, the transmitter 3415, the communications manager 3420, or a combination thereof) may support techniques for reduced processing and more efficient utilization of communication resources by supporting A-CSI multiplexing associated with the transmission of multiple transport blocks (e.g., or repetitions of a transport block, or both).

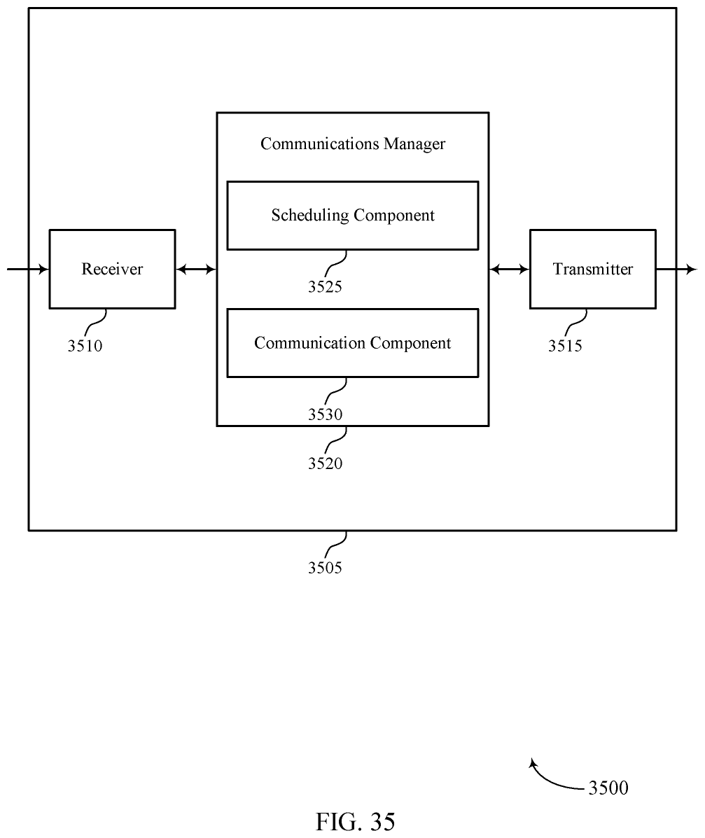

FIG. 35 shows a block diagram 3500 of a device 3505 that supports techniques for CSI multiplexing on multiple PUSCH repetitions in accordance with aspects of the present disclosure. The device 3505 may be an example of aspects of a device 3405 or a base station 105 as described herein. The device 3505 may include a receiver 3510, a transmitter 3515, and a communications manager 3520. The device 3505 may also include a processor. Each of these components may be in communication with one another (e.g., via one or more buses).

The receiver 3510 may provide a means for receiving information such as packets, user data, control information, or any combination thereof associated with various information channels (e.g., control channels, data channels, information channels related to techniques for CSI multiplexing on multiple PUSCH repetitions). Information may be passed on to other components of the device 3505. The receiver 3510 may utilize a single antenna or a set of multiple antennas.

The transmitter 3515 may provide a means for transmitting signals generated by other components of the device 3505. For example, the transmitter 3515 may transmit information such as packets, user data, control information, or any combination thereof associated with various information channels (e.g., control channels, data channels, information channels related to techniques for CSI multiplexing on multiple PUSCH repetitions). In some examples, the transmitter 3515 may be co-located with a receiver 3510 in a transceiver module. The transmitter 3515 may utilize a single antenna or a set of multiple antennas.

The device 3505, or various components thereof, may be an example of means for performing various aspects of techniques for CSI multiplexing on multiple PUSCH repetitions as described herein. For example, the communications manager 3520 may include a scheduling component 3525 a communication component 3530, or any combination thereof. The communications manager 3520 may be an example of aspects of a communications manager 3420 as described herein. In some examples, the communications manager 3520, or various components thereof, may be configured to perform various operations (e.g., receiving, monitoring, transmitting) using or otherwise in cooperation with the receiver 3510, the transmitter 3515, or both. For example, the communications manager 3520 may receive information from the receiver 3510, send information to the transmitter 3515, or be integrated in combination with the receiver 3510, the transmitter 3515, or both to receive information, transmit information, or perform various other operations as described herein.

The communications manager 3520 may support wireless communication at a base station in accordance with examples as disclosed herein. The scheduling component 3525 may be configured as or otherwise support a means for transmitting, to a UE, DCI scheduling a set of multiple uplink data transmissions over a set of multiple transport blocks, the set of multiple uplink data transmissions including at least one repetition of a PUSCH over two or more transport blocks of the set of multiple transport blocks. The communication component 3530 may be configured as or otherwise support a means for receiving, from the UE, the set of multiple transport blocks including a transport block including A-CSI that is multiplexed in accordance with a type of repetition of the PUSCH and one or more rules associated with the set of multiple transport blocks.

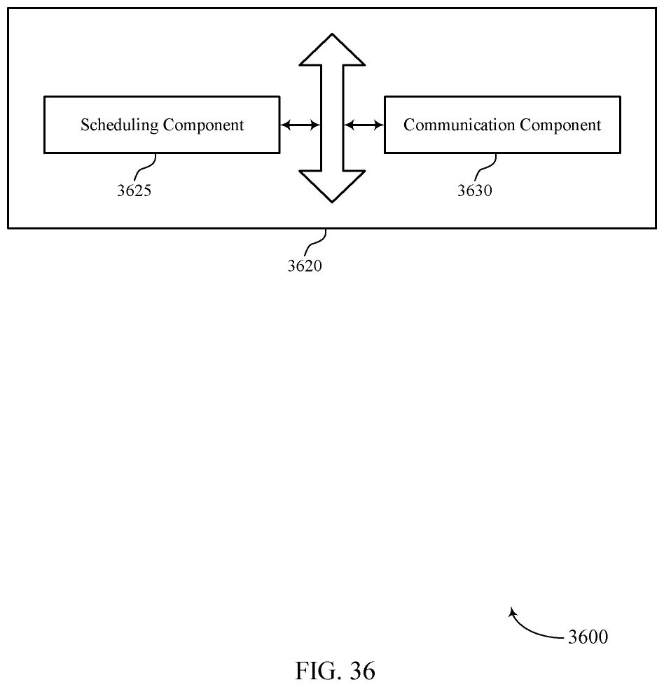

FIG. 36 shows a block diagram 3600 of a communications manager 3620 that supports techniques for CSI multiplexing on multiple PUSCH repetitions in accordance with aspects of the present disclosure. The communications manager 3620 may be an example of aspects of a communications manager 3420, a communications manager 3520, or both, as described herein. The communications manager 3620, or various components thereof, may be an example of means for performing various aspects of techniques for CSI multiplexing on multiple PUSCH repetitions as described herein. For example, the communications manager 3620 may include a scheduling component 3625 a communication component 3630, or any combination thereof. Each of these components may communicate, directly or indirectly, with one another (e.g., via one or more buses).

The communications manager 3620 may support wireless communication at a base station in accordance with examples as disclosed herein. The scheduling component 3625 may be configured as or otherwise support a means for transmitting, to a UE, DCI scheduling a set of multiple uplink data transmissions over a set of multiple transport blocks, the set of multiple uplink data transmissions including at least one repetition of a PUSCH over two or more transport blocks of the set of multiple transport blocks. The communication component 3630 may be configured as or otherwise support a means for receiving, from the UE, the set of multiple transport blocks including a transport block including A-CSI that is multiplexed in accordance with a type of repetition of the PUSCH and one or more rules associated with the set of multiple transport blocks.

In some examples, the A-CSI is multiplexed on a temporally first repetition of a temporally first transport block of the set of multiple transport blocks, the transport block corresponding to the temporally first repetition. In some examples, the set of multiple transport blocks includes two repetitions of a same transport block or repetitions of different transport blocks. In some examples, the A-CSI is multiplexed on a temporally second repetition of the two repetitions of the same transport block or on a temporally second transport block of the different transport blocks, the transport block corresponding to the temporally second repetition or the temporally second transport block.

In some examples, the A-CSI is multiplexed on a penultimate transmission occasion associated with the set of multiple transport blocks based on the set of multiple transport blocks including at least three repetitions of a first transport block, at least three transport blocks, or a combination thereof, the transport block corresponding to the penultimate transmission occasion. In some examples, a transmission occasion corresponds to a single repetition of a single transport block of the set of multiple transport blocks.

In some examples, the set of multiple transport blocks includes repetitions of two different transport blocks. In some examples, the A-CSI is multiplexed on a temporally first repetition of a temporally last transport block of the two different transport blocks based on the set of multiple transport blocks including the repetitions of the two different transport blocks, the transport block corresponding to the temporally first repetition.

In some examples, the set of multiple transport blocks includes repetitions of at least three different transport blocks. In some examples, the A-CSI is multiplexed a temporally first repetition of a penultimate transport block of the set of multiple transport blocks based on the set of multiple transport blocks including at least three different transport blocks, the transport block corresponding to the temporally first repetition.

In some examples, the A-CSI is multiplexed on a penultimate repetition of a first transport block of the set of multiple transport blocks based on the first transport block being associated with a largest quantity of repetitions relative to remaining transport blocks of the set of multiple transport blocks, the transport block corresponding to the penultimate repetition of the first transport block.

In some examples, the A-CSI is multiplexed on a temporally first repetition of a first transport block of the set of multiple transport blocks or on a temporally last repetition of the first transport block based on the first transport block being associated with a greatest symbol length indicated by a SLIV relative to remaining transport blocks of the set of multiple transport blocks, the transport block corresponding to the temporally first repetition or the temporally last repetition.

In some examples, the A-CSI is multiplexed on a temporally first repetition of a first transport block of the set of multiple transport blocks or on a temporally last repetition of the first transport block, the first transport block having a greatest symbol length across repetitions of the first transport block relative to remaining transport blocks of the set of multiple transport blocks, the transport block corresponding to the temporally first repetition or the temporally last repetition.

In some examples, the A-CSI is multiplexed on a temporally last repetition of a temporally last transport block of the set of multiple transport blocks or on a temporally first repetition of the temporally last transport block, the transport block corresponding to the temporally last repetition or the temporally first repetition.

In some examples, to support receiving the set of multiple transport blocks, the communication component 3630 may be configured as or otherwise support a means for receiving the transport block using a first beam for communicating with the UE. In some examples, to support receiving the set of multiple transport blocks, the communication component 3630 may be configured as or otherwise support a means for receiving, using a second beam for communicating with the UE, a second transport block including second A-CSI that is multiplexed in accordance with the type of repetition of the PUSCH and the one or more rules, the second beam being different from the first beam.

In some examples, the A-CSI is multiplexed on a temporally first transmission occasion associated with the first beam, the transport block corresponding to the temporally first transmission occasion associated with the first beam. In some examples, a transmission occasion corresponds to a single repetition of a single transport block of the set of multiple transport blocks. In some examples, the second A-CSI is multiplexed on a temporally first transmission occasion associated with the second beam, the second transport block corresponding to the temporally first transmission occasion associated with the second beam.

In some examples, the A-CSI is multiplexed on a temporally last transmission occasion associated with the first beam, the transport block corresponding to the temporally last transmission occasion associated with the first beam. In some examples, a transmission occasion corresponds to a single repetition of a single transport block of the set of multiple transport blocks. In some examples, the second A-CSI is multiplexed on a temporally last transmission occasion associated with the second beam, the second transport block corresponding to the temporally last transmission occasion associated with the second beam.

In some examples, the A-CSI is multiplexed on a penultimate transmission occasion associated with the first beam, the transport block corresponding to the penultimate transmission occasion associated with the first beam. In some examples, a transmission occasion corresponds to a single repetition of a single transport block of the set of multiple transport blocks. In some examples, the second A-CSI is multiplexed on a penultimate transmission occasion associated with the second beam, the second transport block corresponding to the penultimate transmission occasion associated with the second beam.

In some examples, the A-CSI is multiplexed on a first transmission occasion associated with the first beam and including a largest quantity of resource elements for A-CSI multiplexing relative to other transmission occasions associated with the first beam, the transport block corresponding to the first transmission occasion associated with the first beam. In some examples, a transmission occasion corresponds to a single repetition of a single transport block of the set of multiple transport blocks. In some examples, the second A-CSI is multiplexed on a second transmission occasion associated with the second beam and including a largest quantity of resource elements for A-CSI multiplexing relative to other transmission occasions associated with the second beam, the second transport block corresponding to the second transmission occasion associated with the second beam.

In some examples, the transport block and the second transport block include a same quantity of resource elements for A-CSI multiplexing. In some examples, the transport block and the second transport block include a same quantity of resource elements for A-CSI multiplexing based on: UCI different from the A-CSI and the second A-CSI being excluded from the transport block and the second transport block; or the transport block and the second transport block each corresponding to respective initial transmissions or retransmissions associated with the first beam and the second beam, including a same quantity of symbols, being associated with a same modulation and coding scheme, including a same quantity of resource blocks, including a same quantity of layers, including a same quantity of resource elements for DMRSs, or a combination thereof.

In some examples, the A-CSI is multiplexed on a temporally first repetition of a first transport block of the set of multiple transport blocks that is associated with the first beam, the transport block corresponding to the temporally first repetition associated with the first beam. In some examples, the second A-CSI is multiplexed on a temporally first repetition of the first transport block that is associated with the second beam, the second transport block corresponding to the temporally first repetition associated with the second beam.

In some examples, the first transport block corresponds to a temporally first transport block of the set of multiple transport blocks, a penultimate transport block of the set of multiple transport blocks, or a temporally last transport block of the set of multiple transport blocks.

In some examples, the first transport block corresponds to a temporally first transport block of the set of multiple transport blocks that excludes UCI different from the A-CSI and the second A-CSI. In some examples, the DCI indicates a timing offset between a reception of the DCI by the UE and a transmission of the set of multiple transport blocks by the UE, the one or more rules based on the timing offset. In some examples, the transport block has a duration of at least two symbols.

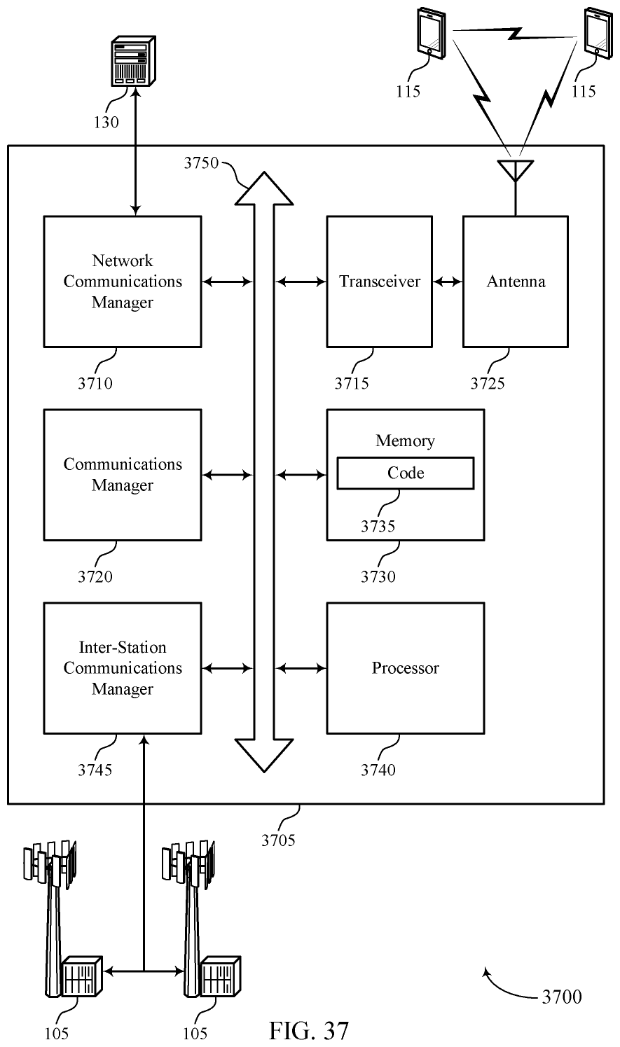

FIG. 37 shows a diagram of a system 3700 including a device 3705 that supports techniques for CSI multiplexing on multiple PUSCH repetitions in accordance with aspects of the present disclosure. The device 3705 may be an example of or include the components of a device 3405, a device 3505, or a base station 105 as described herein. The device 3705 may communicate wirelessly with one or more base stations 105, UEs 115, or any combination thereof. The device 3705 may include components for bi-directional voice and data communications including components for transmitting and receiving communications, such as a communications manager 3720, a network communications manager 3710, a transceiver 3715, an antenna 3725, a memory 3730, code 3735, a processor 3740, and an inter-station communications manager 3745. These components may be in electronic communication or otherwise coupled (e.g., operatively, communicatively, functionally, electronically, electrically) via one or more buses (e.g., a bus 3750).

The network communications manager 3710 may manage communications with a core network 130 (e.g., via one or more wired backhaul links). For example, the network communications manager 3710 may manage the transfer of data communications for client devices, such as one or more UEs 115.

In some cases, the device 3705 may include a single antenna 3725. However, in some other cases the device 3705 may have more than one antenna 3725, which may be capable of concurrently transmitting or receiving multiple wireless transmissions. The transceiver 3715 may communicate bi-directionally, via the one or more antennas 3725, wired, or wireless links as described herein. For example, the transceiver 3715 may represent a wireless transceiver and may communicate bi-directionally with another wireless transceiver. The transceiver 3715 may also include a modem to modulate the packets, to provide the modulated packets to one or more antennas 3725 for transmission, and to demodulate packets received from the one or more antennas 3725. The transceiver 3715, or the transceiver 3715 and one or more antennas 3725, may be an example of a transmitter 3415, a transmitter 3515, a receiver 3410, a receiver 3510, or any combination thereof or component thereof, as described herein.

The memory 3730 may include RAM and ROM. The memory 3730 may store computer-readable, computer-executable code 3735 including instructions that, when executed by the processor 3740, cause the device 3705 to perform various functions described herein. The code 3735 may be stored in a non-transitory computer-readable medium such as system memory or another type of memory. In some cases, the code 3735 may not be directly executable by the processor 3740 but may cause a computer (e.g., when compiled and executed) to perform functions described herein. In some cases, the memory 3730 may contain, among other things, a BIOS which may control basic hardware or software operation such as the interaction with peripheral components or devices.

The processor 3740 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 3740 may be configured to operate a memory array using a memory controller. In some other cases, a memory controller may be integrated into the processor 3740. The processor 3740 may be configured to execute computer-readable instructions stored in a memory (e.g., the memory 3730) to cause the device 3705 to perform various functions (e.g., functions or tasks supporting techniques for CSI multiplexing on multiple PUSCH repetitions). For example, the device 3705 or a component of the device 3705 may include a processor 3740 and memory 3730 coupled to the processor 3740, the processor 3740 and memory 3730 configured to perform various functions described herein.

The inter-station communications manager 3745 may manage communications with other base stations 105, and may include a controller or scheduler for controlling communications with UEs 115 in cooperation with other base stations 105. For example, the inter-station communications manager 3745 may coordinate scheduling for transmissions to UEs 115 for various interference mitigation techniques such as beamforming or joint transmission. In some examples, the inter-station communications manager 3745 may provide an X2 interface within an LTE/LTE-A wireless communications network technology to provide communication between base stations 105.

The communications manager 3720 may support wireless communication at a base station in accordance with examples as disclosed herein. For example, the communications manager 3720 may be configured as or otherwise support a means for transmitting, to a UE, DCI scheduling a set of multiple uplink data transmissions over a set of multiple transport blocks, the set of multiple uplink data transmissions including at least one repetition of a PUSCH over two or more transport blocks of the set of multiple transport blocks. The communications manager 3720 may be configured as or otherwise support a means for receiving, from the UE, the set of multiple transport blocks including a transport block including A-CSI that is multiplexed in accordance with a type of repetition of the PUSCH and one or more rules associated with the set of multiple transport blocks.

By including or configuring the communications manager 3720 in accordance with examples as described herein, the device 3705 may support techniques for improved reliability, latency, data rates, resource utilization, spectral efficiency, and coordination between devices, among other benefits.

In some examples, the communications manager 3720 may be configured to perform various operations (e.g., receiving, monitoring, transmitting) using or otherwise in cooperation with the transceiver 3715, the one or more antennas 3725, or any combination thereof. Although the communications manager 3720 is illustrated as a separate component, in some examples, one or more functions described with reference to the communications manager 3720 may be supported by or performed by the processor 3740, the memory 3730, the code 3735, or any combination thereof. For example, the code 3735 may include instructions executable by the processor 3740 to cause the device 3705 to perform various aspects of techniques for CSI multiplexing on multiple PUSCH repetitions as described herein, or the processor 3740 and the memory 3730 may be otherwise configured to perform or support such operations.

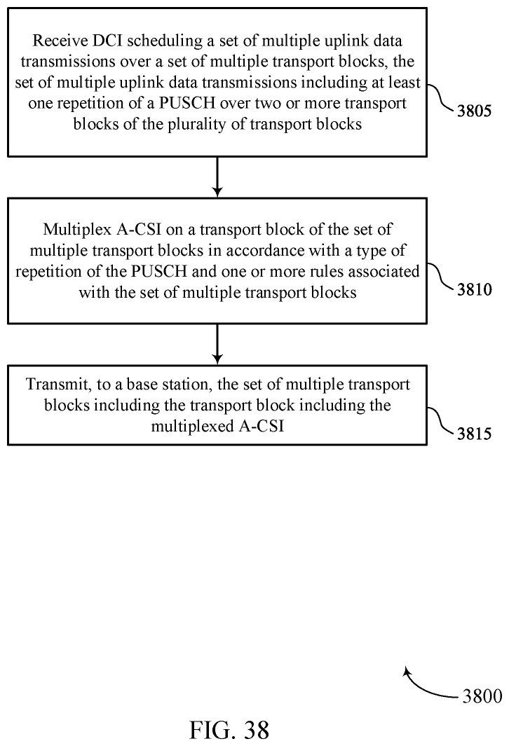

FIG. 38 shows a flowchart illustrating a method 3800 that supports techniques for CSI multiplexing on multiple PUSCH repetitions in accordance with aspects of the present disclosure. The operations of the method 3800 may be implemented by a UE or its components as described herein. For example, the operations of the method 3800 may be performed by a UE 115 as described with reference to FIGS. 1 through 33. In some examples, a UE may execute a set of instructions to control the functional elements of the UE to perform the described functions. Additionally or alternatively, the UE may perform aspects of the described functions using special-purpose hardware.

At 3805, the method may include receiving DCI scheduling a set of multiple uplink data transmissions over a set of multiple transport blocks, the set of multiple uplink data transmissions including at least one repetition of a PUSCH over two or more transport blocks of the set of multiple transport blocks. The operations of 3805 may be performed in accordance with examples as disclosed herein. In some examples, aspects of the operations of 3805 may be performed by a scheduling component 3225 as described with reference to FIG. 32.

At 3810, the method may include multiplexing A-CSI on a transport block of the set of multiple transport blocks in accordance with a type of repetition of the PUSCH and one or more rules associated with the set of multiple transport blocks. The operations of 3810 may be performed in accordance with examples as disclosed herein. In some examples, aspects of the operations of 3810 may be performed by a multiplexing component 3230 as described with reference to FIG. 32.

At 3815, the method may include transmitting, to a base station, the set of multiple transport blocks including the transport block including the multiplexed A-CSI. The operations of 3815 may be performed in accordance with examples as disclosed herein. In some examples, aspects of the operations of 3815 may be performed by a communication component 3235 as described with reference to FIG. 32.

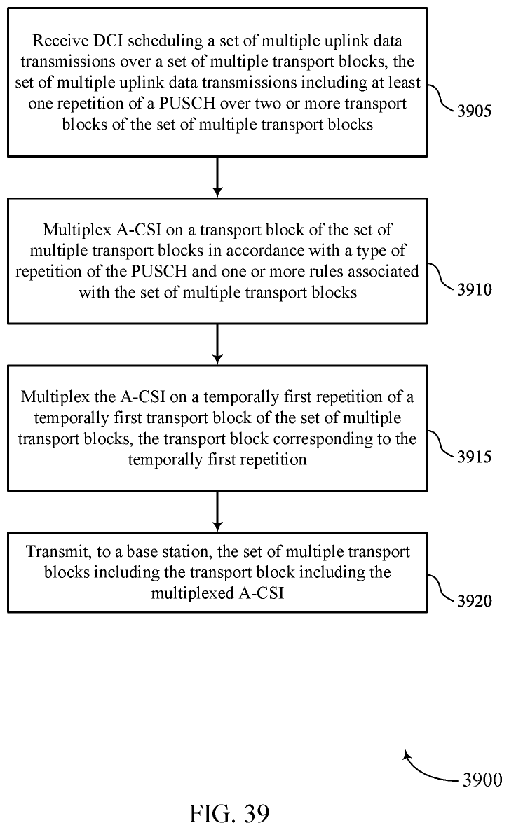

FIG. 39 shows a flowchart illustrating a method 3900 that supports techniques for CSI multiplexing on multiple PUSCH repetitions in accordance with aspects of the present disclosure. The operations of the method 3900 may be implemented by a UE or its components as described herein. For example, the operations of the method 3900 may be performed by a UE 115 as described with reference to FIGS. 1 through 33. In some examples, a UE may execute a set of instructions to control the functional elements of the UE to perform the described functions. Additionally or alternatively, the UE may perform aspects of the described functions using special-purpose hardware.

At 3905, the method may include receiving DCI scheduling a set of multiple uplink data transmissions over a set of multiple transport blocks, the set of multiple uplink data transmissions including at least one repetition of a PUSCH over two or more transport blocks of the set of multiple transport blocks. The operations of 3905 may be performed in accordance with examples as disclosed herein. In some examples, aspects of the operations of 3905 may be performed by a scheduling component 3225 as described with reference to FIG. 32.

At 3910, the method may include multiplexing A-CSI on a transport block of the set of multiple transport blocks in accordance with a type of repetition of the PUSCH and one or more rules associated with the set of multiple transport blocks. The operations of 3910 may be performed in accordance with examples as disclosed herein. In some examples, aspects of the operations of 3910 may be performed by a multiplexing component 3230 as described with reference to FIG. 32.

At 3915, the method may include multiplexing the A-CSI on a temporally first repetition of a temporally first transport block of the set of multiple transport blocks, the transport block corresponding to the temporally first repetition. The operations of 3915 may be performed in accordance with examples as disclosed herein. In some examples, aspects of the operations of 3915 may be performed by a multiplexing component 3230 as described with reference to FIG. 32.

At 3920, the method may include transmitting, to a base station, the set of multiple transport blocks including the transport block including the multiplexed A-CSI. The operations of 3920 may be performed in accordance with examples as disclosed herein. In some examples, aspects of the operations of 3920 may be performed by a communication component 3235 as described with reference to FIG. 32.

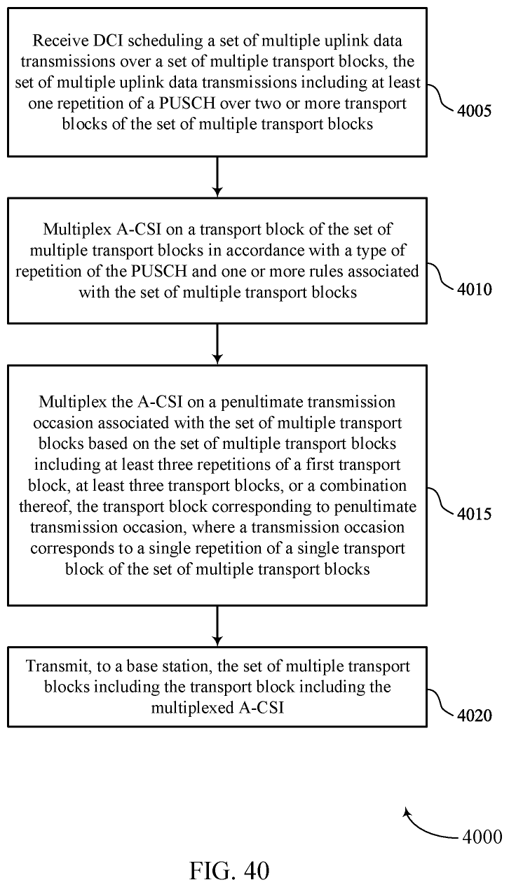

FIG. 40 shows a flowchart illustrating a method 4000 that supports techniques for CSI multiplexing on multiple PUSCH repetitions in accordance with aspects of the present disclosure. The operations of the method 4000 may be implemented by a UE or its components as described herein. For example, the operations of the method 4000 may be performed by a UE 115 as described with reference to FIGS. 1 through 33. In some examples, a UE may execute a set of instructions to control the functional elements of the UE to perform the described functions. Additionally or alternatively, the UE may perform aspects of the described functions using special-purpose hardware.

At 4005, the method may include receiving DCI scheduling a set of multiple uplink data transmissions over a set of multiple transport blocks, the set of multiple uplink data transmissions including at least one repetition of a PUSCH over two or more transport blocks of the set of multiple transport blocks. The operations of 4005 may be performed in accordance with examples as disclosed herein. In some examples, aspects of the operations of 4005 may be performed by a scheduling component 3225 as described with reference to FIG. 32.

At 4010, the method may include multiplexing A-CSI on a transport block of the set of multiple transport blocks in accordance with a type of repetition of the PUSCH and one or more rules associated with the set of multiple transport blocks. The operations of 4010 may be performed in accordance with examples as disclosed herein. In some examples, aspects of the operations of 4010 may be performed by a multiplexing component 3230 as described with reference to FIG. 32.

At 4015, the method may include multiplexing the A-CSI on a penultimate transmission occasion associated with the set of multiple transport blocks based on the set of multiple transport blocks including at least three repetitions of a first transport block, at least three transport blocks, or a combination thereof, the transport block corresponding to the penultimate transmission occasion, where a transmission occasion corresponds to a single repetition of a single transport block of the set of multiple transport blocks. The operations of 4015 may be performed in accordance with examples as disclosed herein. In some examples, aspects of the operations of 4015 may be performed by a multiplexing component 3230 as described with reference to FIG. 32.

At 4020, the method may include transmitting, to a base station, the set of multiple transport blocks including the transport block including the multiplexed A-CSI. The operations of 4020 may be performed in accordance with examples as disclosed herein. In some examples, aspects of the operations of 4020 may be performed by a communication component 3235 as described with reference to FIG. 32.

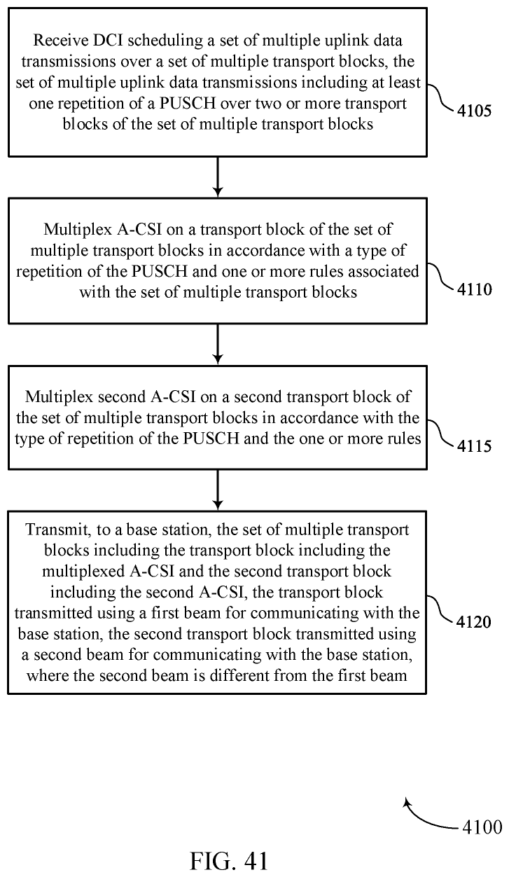

FIG. 41 shows a flowchart illustrating a method 4100 that supports techniques for CSI multiplexing on multiple PUSCH repetitions in accordance with aspects of the present disclosure. The operations of the method 4100 may be implemented by a UE or its components as described herein. For example, the operations of the method 4100 may be performed by a UE 115 as described with reference to FIGS. 1 through 33. In some examples, a UE may execute a set of instructions to control the functional elements of the UE to perform the described functions. Additionally or alternatively, the UE may perform aspects of the described functions using special-purpose hardware.

At 4105, the method may include receiving DCI scheduling a set of multiple uplink data transmissions over a set of multiple transport blocks, the set of multiple uplink data transmissions including at least one repetition of a PUSCH over two or more transport blocks of the set of multiple transport blocks. The operations of 4105 may be performed in accordance with examples as disclosed herein. In some examples, aspects of the operations of 4105 may be performed by a scheduling component 3225 as described with reference to FIG. 32.

At 4110, the method may include multiplexing A-CSI on a transport block of the set of multiple transport blocks in accordance with a type of repetition of the PUSCH and one or more rules associated with the set of multiple transport blocks. The operations of 4110 may be performed in accordance with examples as disclosed herein. In some examples, aspects of the operations of 4110 may be performed by a multiplexing component 3230 as described with reference to FIG. 32.

At 4115, the method may include multiplexing second A-CSI on a second transport block of the set of multiple transport blocks in accordance with the type of repetition of the PUSCH and the one or more rules. The operations of 4115 may be performed in accordance with examples as disclosed herein. In some examples, aspects of the operations of 4115 may be performed by a multiplexing component 3230 as described with reference to FIG. 32.

At 4120, the method may include transmitting, to a base station, the set of multiple transport blocks including the transport block including the multiplexed A-CSI and the second transport block including the second A-CSI, the transport block transmitted using a first beam for communicating with the base station, the second transport block transmitted using a second beam for communicating with the base station, where the second beam is different from the first beam. The operations of 4120 may be performed in accordance with examples as disclosed herein. In some examples, aspects of the operations of 4120 may be performed by a communication component 3235 as described with reference to FIG. 32.

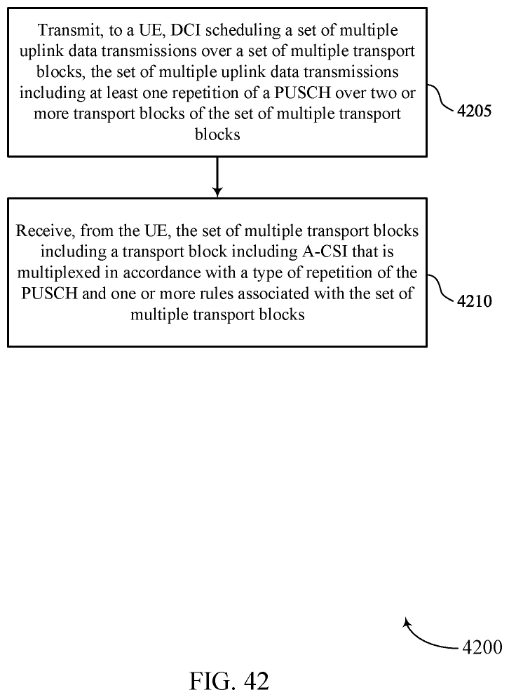

FIG. 42 shows a flowchart illustrating a method 4200 that supports techniques for CSI multiplexing on multiple PUSCH repetitions in accordance with aspects of the present disclosure. The operations of the method 4200 may be implemented by a base station or its components as described herein. For example, the operations of the method 4200 may be performed by a base station 105 as described with reference to FIGS. 1 through 29 and 34 through 37. In some examples, a base station may execute a set of instructions to control the functional elements of the base station to perform the described functions. Additionally or alternatively, the base station may perform aspects of the described functions using special-purpose hardware.

At 4205, the method may include transmitting, to a UE, DCI scheduling a set of multiple uplink data transmissions over a set of multiple transport blocks, the set of multiple uplink data transmissions including at least one repetition of a PUSCH over two or more transport blocks of the set of multiple transport blocks. The operations of 4205 may be performed in accordance with examples as disclosed herein. In some examples, aspects of the operations of 4205 may be performed by a scheduling component 3625 as described with reference to FIG. 36.

At 4210, the method may include receiving, from the UE, the set of multiple transport blocks including a transport block including A-CSI that is multiplexed in accordance with a type of repetition of the PUSCH and one or more rules associated with the set of multiple transport blocks. The operations of 4210 may be performed in accordance with examples as disclosed herein. In some examples, aspects of the operations of 4210 may be performed by a communication component 3630 as described with reference to FIG. 36.

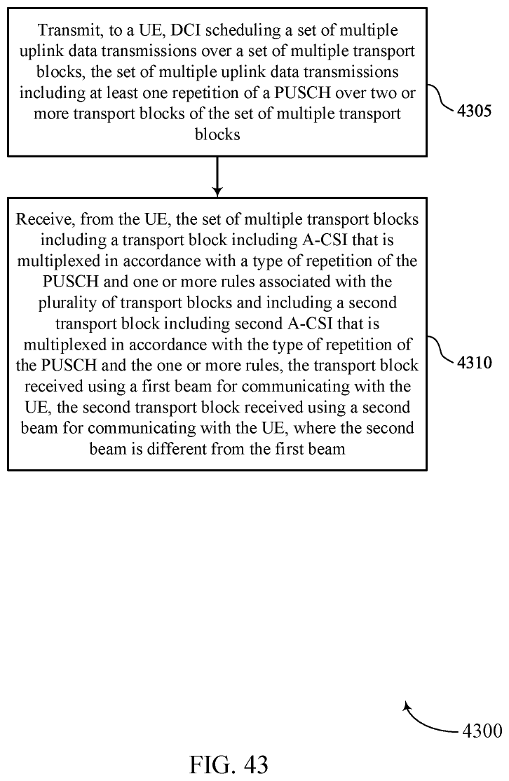

FIG. 43 shows a flowchart illustrating a method 4300 that supports techniques for CSI multiplexing on multiple PUSCH repetitions in accordance with aspects of the present disclosure. The operations of the method 4300 may be implemented by a base station or its components as described herein. For example, the operations of the method 4300 may be performed by a base station 105 as described with reference to FIGS. 1 through 29 and 34 through 37. In some examples, a base station may execute a set of instructions to control the functional elements of the base station to perform the described functions. Additionally or alternatively, the base station may perform aspects of the described functions using special-purpose hardware.

At 4305, the method may include transmitting, to a UE, DCI scheduling a set of multiple uplink data transmissions over a set of multiple transport blocks, the set of multiple uplink data transmissions including at least one repetition of a PUSCH over two or more transport blocks of the set of multiple transport blocks. The operations of 4305 may be performed in accordance with examples as disclosed herein. In some examples, aspects of the operations of 4305 may be performed by a scheduling component 3625 as described with reference to FIG. 36.

At 4310, the method may include receiving, from the UE, the set of multiple transport blocks including a transport block including A-CSI that is multiplexed in accordance with a type of repetition of the PUSCH and one or more rules associated with the plurality of transport blocks and including a second transport block including second A-CSI that is multiplexed in accordance with the type of repetition of the PUSCH and the one or more rules, the transport block received using a first beam for communicating with the UE, the second transport block received using a second beam for communicating with the UE, where the second beam is different from the first beam. The operations of 4310 may be performed in accordance with examples as disclosed herein. In some examples, aspects of the operations of 4310 may be performed by a communication component 3630 as described with reference to FIG. 36.

The following provides an overview of aspects of the present disclosure:

Aspect 1: A method for wireless communication at a UE, comprising: receiving DCI scheduling a plurality of uplink data transmissions over a plurality of transport blocks, the plurality of uplink data transmissions comprising at least one repetition of a PUSCH over two or more transport blocks of the plurality of transport blocks; multiplexing A-CSI on a transport block of the plurality of transport blocks in accordance with a type of repetition of the PUSCH and one or more rules associated with the plurality of transport blocks; and transmitting, to a base station, the plurality of transport blocks including the transport block comprising the multiplexed A-CSI.

Aspect 2: The method of aspect 1, wherein multiplexing the A-CSI on the transport block comprises: multiplexing the A-CSI on a temporally first repetition of a temporally first transport block of the plurality of transport blocks, the transport block corresponding to the temporally first repetition.

Aspect 3: The method of aspect 1, wherein multiplexing the A-CSI on the transport block comprises: multiplexing the A-CSI on a temporally first repetition of a temporally first transport block of the plurality of transport blocks that has a duration of at least two symbols, the transport block corresponding to the temporally first repetition.

Aspect 4: The method of aspect 1, wherein the plurality of transport blocks comprises two repetitions of a same transport block or repetitions of different transport blocks, and wherein multiplexing the A-CSI on the transport block comprises: multiplexing the A-CSI on a temporally second repetition of the two repetitions of the same transport block or on a temporally second transport block of the different transport blocks, the transport block corresponding to the temporally second repetition or the temporally second transport block.

Aspect 5: The method of aspect 1, wherein multiplexing the A-CSI on the transport block comprises: multiplexing the A-CSI on a penultimate transmission occasion associated with the plurality of transport blocks based at least in part on the plurality of transport blocks comprising at least three repetitions of a first transport block, at least three transport blocks, or a combination thereof, the transport block corresponding to the penultimate transmission occasion, wherein a transmission occasion corresponds to a single repetition of a single transport block of the plurality of transport blocks.

Aspect 6: The method of aspect 1, wherein the plurality of transport blocks comprises repetitions of two different transport blocks, and wherein multiplexing the A-CSI on the transport block comprises: multiplexing the A-CSI on a temporally first repetition of a temporally last transport block of the two different transport blocks based at least in part on the plurality of transport blocks comprising the repetitions of the two different transport blocks, the transport block corresponding to the temporally first repetition.

Aspect 7: The method of aspect 1, wherein the plurality of transport blocks comprises repetitions of at least three different transport blocks, and wherein multiplexing the A-CSI on the transport block comprises: multiplexing the A-CSI on a temporally first repetition of a penultimate transport block of the plurality of transport blocks based at least in part on the plurality of transport blocks comprising at least three different transport blocks, the transport block corresponding to the temporally first repetition.

Aspect 8: The method of aspect 1, wherein multiplexing the A-CSI on the transport block comprises: multiplexing the A-CSI on a penultimate repetition of a first transport block of the plurality of transport blocks based at least in part on the first transport block being associated with a largest quantity of repetitions relative to remaining transport blocks of the plurality of transport blocks, the transport block corresponding to the penultimate repetition of the first transport block.

Aspect 9: The method of aspect 1, wherein multiplexing the A-CSI on the transport block comprises: multiplexing the A-CSI on a temporally first repetition of a first transport block of the plurality of transport blocks based at least in part on the first transport block being associated with a greatest symbol length indicated by a SLIV relative to remaining transport blocks of the plurality of transport blocks, the transport block corresponding to the temporally first repetition.

Aspect 10: The method of aspect 1, wherein multiplexing the A-CSI on the transport block comprises: multiplexing the A-CSI on a temporally last repetition of a first transport block of the plurality of transport blocks based at least in part on the first transport block being associated with a greatest symbol length indicated by a SLIV relative to remaining transport blocks of the plurality of transport blocks, the transport block corresponding to the temporally last repetition.

Aspect 11: The method of aspect 1, further comprising: determining, for each transport block of the plurality of transport blocks, a symbol length across repetitions of a respective transport block, wherein multiplexing the A-CSI on the transport block comprises: multiplexing the A-CSI on a temporally first repetition of a first transport block of the plurality of transport blocks, the first transport block having a greatest symbol length across repetitions of the first transport block relative to remaining transport blocks of the plurality of transport blocks, the transport block corresponding to the temporally first repetition.

Aspect 12: The method of aspect 1, further comprising: determining, for each transport block of the plurality of transport blocks, a symbol length across repetitions of a respective transport block, wherein multiplexing the A-CSI on the transport block comprises: multiplexing the A-CSI on a temporally last repetition of a first transport block of the plurality of transport blocks, the first transport block having a greatest symbol length across repetitions of the first transport block relative to remaining transport blocks of the plurality of transport blocks, the transport block corresponding to the temporally last repetition.

Aspect 13: The method of aspect 1, wherein multiplexing the A-CSI on the transport block comprises: multiplexing the A-CSI on a temporally last repetition of a temporally last transport block of the plurality of transport blocks, the transport block corresponding to the temporally last repetition.

Aspect 14: The method of aspect 1, wherein multiplexing the A-CSI on the transport block comprises: multiplexing the A-CSI on a temporally first repetition of a temporally last transport block of the plurality of transport blocks, the transport block corresponding to the temporally first repetition.

Aspect 15: The method of any of aspects 1 through 13, further comprising: multiplexing second A-CSI on a second transport block of the plurality of transport blocks in accordance with the type of repetition of the PUSCH and the one or more rules, wherein transmitting the plurality of transport blocks comprises: transmitting the transport block using a first beam for communicating with the base station; and transmitting, to the base station using a second beam for communicating with the base station, the second transport block comprising the multiplexed second A-CSI, wherein the second beam is different from the first beam.

Aspect 16: The method of aspect 15, wherein multiplexing the A-CSI on the transport block comprises: multiplexing the A-CSI on a temporally first transmission occasion associated with the first beam, the transport block corresponding to the temporally first transmission occasion associated with the first beam, wherein a transmission occasion corresponds to a single repetition of a single transport block of the plurality of transport blocks, and wherein multiplexing the second A-CSI on the second transport block comprises: multiplexing the second A-CSI on a temporally first transmission occasion associated with the second beam, the second transport block corresponding to the temporally first transmission occasion associated with the second beam.

Aspect 17: The method of aspect 15, wherein multiplexing the A-CSI on the transport block comprises: multiplexing the A-CSI on a temporally last transmission occasion associated with the first beam, the transport block corresponding to the temporally last transmission occasion associated with the first beam, wherein a transmission occasion corresponds to a single repetition of a single transport block of the plurality of transport blocks, and wherein multiplexing the second A-CSI on the second transport block comprises: multiplexing the second A-CSI on a temporally last transmission occasion associated with the second beam, the second transport block corresponding to the temporally last transmission occasion associated with the second beam.

Aspect 18: The method of aspect 15, wherein multiplexing the A-CSI on the transport block comprises: multiplexing the A-CSI on a penultimate transmission occasion associated with the first beam, the transport block corresponding to the penultimate transmission occasion associated with the first beam, wherein a transmission occasion corresponds to a single repetition of a single transport block of the plurality of transport blocks, and wherein multiplexing the second A-CSI on the second transport block comprises: multiplexing the second A-CSI on a penultimate transmission occasion associated with the second beam, the second transport block corresponding to the penultimate transmission occasion associated with the second beam.

Aspect 19: The method of aspect 15, wherein multiplexing the A-CSI on the transport block comprises: multiplexing the A-CSI on a first transmission occasion associated with the first beam and comprising a largest quantity of resource elements for A-CSI multiplexing relative to other transmission occasions associated with the first beam, the transport block corresponding to the first transmission occasion associated with the first beam, wherein a transmission occasion corresponds to a single repetition of a single transport block of the plurality of transport blocks, and wherein multiplexing the second A-CSI on the second transport block comprises: multiplexing the second A-CSI on a second transmission occasion associated with the second beam and comprising a largest quantity of resource elements for A-CSI multiplexing relative to other transmission occasions associated with the second beam, the second transport block corresponding to the second transmission occasion associated with the second beam.

Aspect 20: The method of any of aspects 15 through 19, wherein the transport block and the second transport block comprise a same quantity of resource elements for A-CSI multiplexing.

Aspect 21: The method of any of aspects 15 through 20, further comprising: determining that the transport block and the second transport block comprise a same quantity of resource elements for A-CSI multiplexing based at least in part on: UCI different from the A-CSI and the second A-CSI being excluded from the transport block and the second transport block; or the transport block and the second transport block each corresponding to respective initial transmissions or retransmissions associated with the first beam and the second beam, comprising a same quantity of symbols, being associated with a same modulation and coding scheme, comprising a same quantity of resource blocks, comprising a same quantity of layers, comprising a same quantity of resource elements for DMRSs, or a combination thereof.

Aspect 22: The method of any of aspects 15 through 20, further comprising: determining a quantity of resource elements for A-CSI associated with the transport block, the transport block corresponding to a temporally first transmission occasion associated with the first beam; and determining a temporally first transmission occasion associated with the second beam that comprises the quantity of resource elements, wherein a transmission occasion corresponds to a single repetition of a single transport block of the plurality of transport blocks, and wherein the second transport block corresponds to the temporally first transmission occasion.

Aspect 23: The method of any of aspects 15 through 20, further comprising: determining a quantity of resource elements for A-CSI associated with the transport block, the transport block corresponding to a temporally last transmission occasion associated with the first beam; and determining a temporally last transmission occasion associated with the second beam that comprises the quantity of resource elements, wherein a transmission occasion corresponds to a single repetition of a single transport block of the plurality of transport blocks, and wherein the second transport block corresponds to the temporally last transmission occasion.

Aspect 24: The method of any of aspects 15 through 20, further comprising: determining a quantity of resource elements for A-CSI associated with the transport block, the transport block corresponding to a temporally penultimate transmission occasion associated with the first beam; and determining a temporally penultimate transmission occasion associated with the second beam that comprises the quantity of resource elements, wherein a transmission occasion corresponds to a single repetition of a single transport block of the plurality of transport blocks, and wherein the second transport block corresponds to the temporally penultimate transmission occasion.

Aspect 25: The method of any of aspects 15 through 20, further comprising: determining a quantity of resource elements for A-CSI associated with the transport block, wherein the A-CSI and the second A-CSI are multiplexed using the determined quantity of resource elements.

Aspect 26: The method of aspect 15, wherein multiplexing the A-CSI on the transport block comprises: multiplexing the A-CSI on a temporally first repetition of a first transport block of the plurality of transport blocks that is associated with the first beam, the transport block corresponding to the temporally first repetition associated with the first beam, and wherein multiplexing the second A-CSI on the second transport block comprises: multiplexing the second A-CSI on a temporally first repetition of the first transport block that is associated with the second beam, the transport block corresponding to the temporally first repetition associated with the second beam.

Aspect 27: The method of aspect 26, wherein the first transport block corresponds to a temporally first transport block of the plurality of transport blocks, a penultimate transport block of the plurality of transport blocks, or a temporally last transport block of the plurality of transport blocks.

Aspect 28: The method of aspect 26, wherein the first transport block corresponds to a temporally first transport block of the plurality of transport blocks that excludes UCI different from the A-CSI and the second A-CSI.

Aspect 29: The method of any of aspects 1 through 28, wherein the DCI indicates a timing offset between the reception of the DCI and the transmission of the plurality of transport blocks, the method further comprising: selecting the one or more rules based at least in part on the timing offset being satisfied, wherein the A-CSI is multiplexed on the transport block based at least in part on the timing offset.

Aspect 30: The method of any of aspects 1 through 28, wherein the DCI indicates a timing offset between the reception of the DCI and the transmission of the plurality of transport blocks, the method further comprising: selecting the one or more rules based at least in part on the timing offset failing to be satisfied, wherein the A-CSI is multiplexed on the transport block based at least in part on the timing offset.

Aspect 31: The method of any of aspects 1 through 30, wherein the transport block has a duration of at least two symbols.

Aspect 32: A method for wireless communication at a base station, comprising: transmitting, to a UE, DCI scheduling a plurality of uplink data transmissions over a plurality of transport blocks, the plurality of uplink data transmissions comprising at least one repetition of a PUSCH over two or more transport blocks of the plurality of transport blocks; receiving, from the UE, the plurality of transport blocks including a transport block comprising A-CSI that is multiplexed in accordance with a type of repetition of the PUSCH and one or more rules associated with the plurality of transport blocks.

Aspect 33: The method of aspect 32, wherein the A-CSI is multiplexed on a temporally first repetition of a temporally first transport block of the plurality of transport blocks, the transport block corresponding to the temporally first repetition.

Aspect 34: The method of aspect 32, wherein the plurality of transport blocks comprises two repetitions of a same transport block or repetitions of different transport blocks, and the A-CSI is multiplexed on a temporally second repetition of the two repetitions of the same transport block or on a temporally second transport block of the different transport blocks, the transport block corresponding to the temporally second repetition or the temporally second transport block.

Aspect 35: The method of aspect 32, wherein the A-CSI is multiplexed on a penultimate transmission occasion associated with the plurality of transport blocks based at least in part on the plurality of transport blocks comprising at least three repetitions of a first transport block, at least three transport blocks, or a combination thereof, the transport block corresponding to the penultimate transmission occasion, wherein a transmission occasion corresponds to a single repetition of a single transport block of the plurality of transport blocks.

Aspect 36: The method of aspect 32, wherein the plurality of transport blocks comprises repetitions of two different transport blocks, and the A-CSI is multiplexed on a temporally first repetition of a temporally last transport block of the two different transport blocks based at least in part on the plurality of transport blocks comprising the repetitions of the two different transport blocks, the transport block corresponding to the temporally first repetition.

Aspect 37: The method of aspect 32, wherein the plurality of transport blocks comprises repetitions of at least three different transport blocks, and the A-CSI is multiplexed a temporally first repetition of a penultimate transport block of the plurality of transport blocks based at least in part on the plurality of transport blocks comprising at least three different transport blocks, the transport block corresponding to the temporally first repetition.

Aspect 38: The method of aspect 32, wherein the A-CSI is multiplexed on a penultimate repetition of a first transport block of the plurality of transport blocks based at least in part on the first transport block being associated with a largest quantity of repetitions relative to remaining transport blocks of the plurality of transport blocks, the transport block corresponding to the penultimate repetition of the first transport block.

Aspect 39: The method of aspect 32, wherein the A-CSI is multiplexed on a temporally first repetition of a first transport block of the plurality of transport based at least in part on the first transport block being associated with a greatest symbol length indicated by a SLIV relative to remaining transport blocks of the plurality of transport blocks, the transport block corresponding to the temporally first repetition.

Aspect 40: The method of aspect 32, wherein the A-CSI is multiplexed on a temporally last repetition of a first transport block of the plurality of transport blocks based at least in part on the first transport block being associated with a greatest symbol length indicated by a SLIV relative to remaining transport blocks of the plurality of transport blocks, the transport block corresponding to the temporally last repetition.

Aspect 41: The method of aspect 32, wherein the A-CSI is multiplexed on a temporally first repetition of a first transport block of the plurality of transport blocks, the first transport block having a greatest symbol length across repetitions of the first transport block relative to remaining transport blocks of the plurality of transport blocks, the transport block corresponding to the temporally first repetition.

Aspect 42: The method of aspect 32, wherein the A-CSI is multiplexed on a temporally last repetition of a first transport block of the plurality of transport blocks, the first transport block having a greatest symbol length across repetitions of the first transport block relative to remaining transport blocks of the plurality of transport blocks, the transport block corresponding to the temporally last repetition.

Aspect 43: The method of aspect 32, wherein the A-CSI is multiplexed on a temporally last repetition of a temporally last transport block of the plurality of transport blocks, the transport block corresponding to the temporally last repetition.

Aspect 44: The method of aspect 32, wherein the A-CSI is multiplexed on a temporally first repetition of a temporally last transport block of the plurality of transport blocks, the transport block corresponding to the temporally first repetition.

Aspect 45: The method of any of aspects 32 through 43, wherein receiving the plurality of transport blocks comprises: receiving the transport block using a first beam for communicating with the UE; and receiving, using a second beam for communicating with the UE, a second transport block comprising second A-CSI that is multiplexed in accordance with the type of repetition of the PUSCH and the one or more rules, the second beam being different from the first beam.

Aspect 46: The method of aspect 45, wherein the A-CSI is multiplexed on a temporally first transmission occasion associated with the first beam, the transport block corresponding to the temporally first transmission occasion associated with the first beam, wherein a transmission occasion corresponds to a single repetition of a single transport block of the plurality of transport blocks, and the second A-CSI is multiplexed on a temporally first transmission occasion associated with the second beam, the second transport block corresponding to the temporally first transmission occasion associated with the second beam.

Aspect 47: The method of aspect 45, wherein the A-CSI is multiplexed on a temporally last transmission occasion associated with the first beam, the transport block corresponding to the temporally last transmission occasion associated with the first beam, wherein a transmission occasion corresponds to a single repetition of a single transport block of the plurality of transport blocks, and the second A-CSI is multiplexed on a temporally last transmission occasion associated with the second beam, the second transport block corresponding to the temporally last transmission occasion associated with the second beam.

Aspect 48: The method of aspect 45, wherein the A-CSI is multiplexed on a penultimate transmission occasion associated with the first beam, the transport block corresponding to the penultimate transmission occasion associated with the first beam, wherein a transmission occasion corresponds to a single repetition of a single transport block of the plurality of transport blocks, and the second A-CSI is multiplexed on a penultimate transmission occasion associated with the second beam, the second transport block corresponding to the penultimate transmission occasion associated with the second beam.

Aspect 49: The method of aspect 45, wherein the A-CSI is multiplexed on a first transmission occasion associated with the first beam and comprising a largest quantity of resource elements for A-CSI multiplexing relative to other transmission occasions associated with the first beam, the transport block corresponding to the first transmission occasion associated with the first beam, wherein a transmission occasion corresponds to a single repetition of a single transport block of the plurality of transport blocks, and the second A-CSI is multiplexed on a second transmission occasion associated with the second beam and comprising a largest quantity of resource elements for A-CSI multiplexing relative to other transmission occasions associated with the second beam, the second transport block corresponding to the second transmission occasion associated with the second beam.

Aspect 50: The method of any of aspects 45 through 49, wherein the transport block and the second transport block comprise a same quantity of resource elements for A-CSI multiplexing.

Aspect 51: The method of any of aspects 45 through 50, wherein the transport block and the second transport block comprise a same quantity of resource elements for A-CSI multiplexing based at least in part on UCI different from the A-CSI and the second A-CSI being excluded from the transport block and the second transport block; or the transport block and the second transport block each corresponding to respective initial transmissions or retransmissions associated with the first beam and the second beam, comprising a same quantity of symbols, being associated with a same modulation and coding scheme, comprising a same quantity of resource blocks, comprising a same quantity of layers, comprising a same quantity of resource elements for DMRSs, or a combination thereof.

Aspect 52: The method of aspect 45, wherein the A-CSI is multiplexed on a temporally first repetition of a first transport block of the plurality of transport blocks that is associated with the first beam, the transport block corresponding to the temporally first repetition associated with the first beam, and the second A-CSI is multiplexed on a temporally first repetition of the first transport block that is associated with the second beam, the transport block corresponding to the temporally first repetition associated with the second beam.

Aspect 53: The method of aspect 52, wherein the first transport block corresponds to a temporally first transport block of the plurality of transport blocks, a penultimate transport block of the plurality of transport blocks, or a temporally last transport block of the plurality of transport blocks.

Aspect 54: The method of aspect 52, wherein the first transport block corresponds to a temporally first transport block of the plurality of transport blocks that excludes UCI different from the A-CSI and the second A-CSI.

Aspect 55: The method of any of aspects 32 through 54, wherein the DCI indicates a timing offset between a reception of the DCI by the UE and a transmission of the plurality of transport blocks by the UE, the one or more rules based at least in part on the timing offset.

Aspect 56: The method of any of aspects 32 through 55, wherein the transport block has a duration of at least two symbols.

Aspect 57: An apparatus for wireless communication at a UE, comprising a processor; memory coupled with the processor; and instructions stored in the memory and executable by the processor to cause the apparatus to perform a method of any of aspects 1 through 31.

Aspect 58: An apparatus for wireless communication at a UE, comprising at least one means for performing a method of any of aspects 1 through 31.

Aspect 59: A non-transitory computer-readable medium storing code for wireless communication at a UE, the code comprising instructions executable by a processor to perform a method of any of aspects 1 through 31.

Aspect 60: An apparatus for wireless communication at a base station, comprising a processor; memory coupled with the processor; and instructions stored in the memory and executable by the processor to cause the apparatus to perform a method of any of aspects 32 through 56.

Aspect 61: An apparatus for wireless communication at a base station, comprising at least one means for performing a method of any of aspects 32 through 56.

Aspect 62: A non-transitory computer-readable medium storing code for wireless communication at a base station, the code comprising instructions executable by a processor to perform a method of any of aspects 32 through 56.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a user equipment (UE), comprising:
a processor;
memory coupled with the processor; and
instructions stored in the memory and executable by the processor to cause the apparatus to:
receive downlink control information scheduling a plurality of uplink data transmissions over a plurality of transport blocks, the plurality of uplink data transmissions comprising at least one repetition of a physical uplink shared channel over two or more transport blocks of the plurality of transport blocks;
multiplex aperiodic-channel state information on a transport block of the plurality of transport blocks in accordance with a type of repetition of the physical uplink shared channel and one or more rules associated with the plurality of transport blocks; and
transmit, to a base station, the plurality of transport blocks including the transport block comprising the multiplexed aperiodic-channel state information.

2. The apparatus of claim 1, wherein the instructions to multiplex the aperiodic-channel state information on the transport block are executable by the processor to cause the apparatus to:
multiplex the aperiodic-channel state information on a temporally first repetition of a temporally first transport block of the plurality of transport blocks, the transport block corresponding to the temporally first repetition.

3. The apparatus of claim 1, wherein the plurality of transport blocks comprises two repetitions of a same transport block or repetitions of different transport blocks, and wherein the instructions to multiplex the aperiodic-channel state information on the transport block are executable by the processor to cause the apparatus to:
multiplex the aperiodic-channel state information on a temporally second repetition of the two repetitions of the same transport block or on a temporally second transport block of the different transport blocks, the transport block corresponding to the temporally second repetition or the temporally second transport block.

4. The apparatus of claim 1, wherein the instructions to multiplex the aperiodic-channel state information on the transport block are executable by the processor to cause the apparatus to:
multiplex the aperiodic-channel state information on a penultimate transmission occasion associated with the plurality of transport blocks based at least in part on the plurality of transport blocks comprising at least three repetitions of a first transport block, at least three transport blocks, or a combination thereof, the transport block corresponding to the penultimate transmission occasion, wherein a transmission occasion corresponds to a single repetition of a single transport block of the plurality of transport blocks.

5. The apparatus of claim 1, wherein the plurality of transport blocks comprises repetitions of two different transport blocks, and wherein the instructions to multiplex the aperiodic-channel state information on the transport block are executable by the processor to cause the apparatus to:
multiplex the aperiodic-channel state information on a temporally first repetition of a temporally last transport block of the two different transport blocks based at least in part on the plurality of transport blocks comprising the repetitions of the two different transport blocks, the transport block corresponding to the temporally first repetition.

6. The apparatus of claim 1, wherein the plurality of transport blocks comprises repetitions of at least three different transport blocks, and wherein the instructions to multiplex the aperiodic-channel state information on the transport block are executable by the processor to cause the apparatus to:
multiplex the aperiodic-channel state information on a temporally first repetition of a penultimate transport block of the plurality of transport blocks based at least in part on the plurality of transport blocks comprising at least three different transport blocks, the transport block corresponding to the temporally first repetition.

7. The apparatus of claim 1, wherein the instructions to multiplex the aperiodic-channel state information on the transport block are executable by the processor to cause the apparatus to:
multiplex the aperiodic-channel state information on a penultimate repetition of a first transport block of the plurality of transport blocks based at least in part on the first transport block being associated with a largest quantity of repetitions relative to remaining transport blocks of the plurality of transport blocks, the transport block corresponding to the penultimate repetition of the first transport block.

8. The apparatus of claim 1, wherein the instructions to multiplex the aperiodic-channel state information on the transport block are executable by the processor to cause the apparatus to:
multiplex the aperiodic-channel state information on a temporally first repetition of a first transport block of the plurality of transport blocks or on a temporally last repetition of the first transport block based at least in part on the first transport block being associated with a greatest symbol length indicated by a start and length indicator value relative to remaining transport blocks of the plurality of transport blocks, the transport block corresponding to the temporally first repetition or the temporally last repetition.

9. The apparatus of claim 1, wherein the instructions are further executable by the processor to cause the apparatus to:
determine, for each transport block of the plurality of transport blocks, a symbol length across repetitions of a respective transport block, wherein the instructions to multiplex the aperiodic-channel state information on the transport block are executable by the processor to cause the apparatus to:
multiplex the aperiodic-channel state information on a temporally first repetition of a first transport block of the plurality of transport blocks or on a temporally last repetition of the first transport block, the first transport block having a greatest symbol length across repetitions of the first transport block relative to remaining transport blocks of the plurality of transport blocks, the transport block corresponding to the temporally first repetition or the temporally last repetition.

10. The apparatus of claim 1, wherein the instructions to multiplex the aperiodic-channel state information on the transport block are executable by the processor to cause the apparatus to:
multiplex the aperiodic-channel state information on a temporally last repetition of a temporally last transport block of the plurality of transport blocks or on a temporally first repetition of the temporally last transport block, the transport block corresponding to the temporally last repetition or the temporally first repetition.

11. The apparatus of claim 1, wherein the instructions are further executable by the processor to cause the apparatus to:
multiplex second aperiodic-channel state information on a second transport block of the plurality of transport blocks in accordance with the type of repetition of the physical uplink shared channel and the one or more rules, wherein the instructions to transmit the plurality of transport blocks are executable by the processor to cause the apparatus to:
transmit the transport block using a first beam for communicating with the base station; and
transmit, to the base station using a second beam for communicating with the base station, the second transport block comprising the multiplexed second aperiodic-channel state information, wherein the second beam is different from the first beam.

12. The apparatus of claim 11, wherein the instructions to multiplex the aperiodic-channel state information on the transport block are executable by the processor to cause the apparatus to:
multiplex the aperiodic-channel state information on a temporally first transmission occasion associated with the first beam, the transport block corresponding to the temporally first transmission occasion associated with the first beam, wherein a transmission occasion corresponds to a single repetition of a single transport block of the plurality of transport blocks, and wherein the instructions to multiplex the second aperiodic-channel state information on the second transport block are executable by the processor to cause the apparatus to:
multiplex the second aperiodic-channel state information on a temporally first transmission occasion associated with the second beam, the second transport block corresponding to the temporally first transmission occasion associated with the second beam.

13. The apparatus of claim 11, wherein the instructions to multiplex the aperiodic-channel state information on the transport block are executable by the processor to cause the apparatus to:
multiplex the aperiodic-channel state information on a temporally last transmission occasion associated with the first beam, the transport block corresponding to the temporally last transmission occasion associated with the first beam, wherein a transmission occasion corresponds to a single repetition of a single transport block of the plurality of transport blocks, and wherein the instructions to multiplex the second aperiodic-channel state information on the second transport block are executable by the processor to cause the apparatus to:
multiplex the second aperiodic-channel state information on a temporally last transmission occasion associated with the second beam, the second transport block corresponding to the temporally last transmission occasion associated with the second beam.

14. The apparatus of claim 11, wherein the instructions to multiplex the aperiodic-channel state information on the transport block are executable by the processor to cause the apparatus to:
multiplex the aperiodic-channel state information on a penultimate transmission occasion associated with the first beam, the transport block corresponding to the penultimate transmission occasion associated with the first beam, wherein a transmission occasion corresponds to a single repetition of a single transport block of the plurality of transport blocks, and wherein the instructions to multiplex the second aperiodic-channel state information on the second transport block are executable by the processor to cause the apparatus to:
multiplex the second aperiodic-channel state information on a penultimate transmission occasion associated with the second beam, the second transport block corresponding to the penultimate transmission occasion associated with the second beam.

15. The apparatus of claim 11, wherein the instructions to multiplex the aperiodic-channel state information on the transport block are executable by the processor to cause the apparatus to:
multiplex the aperiodic-channel state information on a first transmission occasion associated with the first beam and comprising a largest quantity of resource elements for aperiodic-channel state information multiplexing relative to other transmission occasions associated with the first beam, the transport block corresponding to the first transmission occasion associated with the first beam, wherein a transmission occasion corresponds to a single repetition of a single transport block of the plurality of transport blocks, and wherein the instructions to multiplex the second aperiodic-channel state information on the second transport block are executable by the processor to cause the apparatus to:
multiplex the second aperiodic-channel state information on a second transmission occasion associated with the second beam and comprising a largest quantity of resource elements for aperiodic-channel state information multiplexing relative to other transmission occasions associated with the second beam, the second transport block corresponding to the second transmission occasion associated with the second beam.

16. The apparatus of claim 11, wherein the transport block and the second transport block comprise a same quantity of resource elements for aperiodic-channel state information multiplexing.

17. The apparatus of claim 11, wherein the instructions are further executable by the processor to cause the apparatus to:
determine that the transport block and the second transport block comprise a same quantity of resource elements for aperiodic-channel state information multiplexing based at least in part on:
uplink control information different from the aperiodic-channel state information and the second aperiodic-channel state information being excluded from the transport block and the second transport block; or
the transport block and the second transport block each corresponding to respective initial transmissions or retransmissions associated with the first beam and the second beam, comprising a same quantity of symbols, being associated with a same modulation and coding scheme, comprising a same quantity of resource blocks, comprising a same quantity of layers, comprising a same quantity of resource elements for demodulation reference signals, or a combination thereof.

18. The apparatus of claim 11, wherein the instructions are further executable by the processor to cause the apparatus to:
determine a quantity of resource elements for aperiodic-channel state information associated with the transport block; and
determine a temporally first transmission occasion associated with the second beam that comprises the quantity of resource elements, a temporally last transmission occasion associated with the second beam that comprises the quantity of resource elements, or a temporally penultimate transmission occasion associated with the second beam that comprises the quantity of resource elements, wherein a transmission occasion corresponds to a single repetition of a single transport block of the plurality of transport blocks, and wherein the second transport block corresponds to the temporally first transmission occasion, the temporally last transmission occasion, or the temporally penultimate transmission occasion.

19. The apparatus of claim 11, wherein the instructions are further executable by the processor to cause the apparatus to:
determine a quantity of resource elements for aperiodic-channel state information associated with the transport block, wherein the aperiodic-channel state information and the second aperiodic-channel state information are multiplexed using the determined quantity of resource elements.

20. The apparatus of claim 11, wherein the instructions to multiplex the aperiodic-channel state information on the transport block are executable by the processor to cause the apparatus to:
multiplex the aperiodic-channel state information on a temporally first repetition of a first transport block of the plurality of transport blocks that is associated with the first beam, the transport block corresponding to the temporally first repetition associated with the first beam, and wherein the instructions to multiplex the second aperiodic-channel state information on the second transport block are executable by the processor to cause the apparatus to:
multiplex the second aperiodic-channel state information on a temporally first repetition of the first transport block that is associated with the second beam, the transport block corresponding to the temporally first repetition associated with the second beam.

21. The apparatus of claim 20, wherein the first transport block corresponds to a temporally first transport block of the plurality of transport blocks, a penultimate transport block of the plurality of transport blocks, or a temporally last transport block of the plurality of transport blocks.

22. The apparatus of claim 20, wherein the first transport block corresponds to a temporally first transport block of the plurality of transport blocks that excludes uplink control information different from the aperiodic-channel state information and the second aperiodic-channel state information.

23. The apparatus of claim 1, wherein the downlink control information indicates a timing offset between the reception of the downlink control information and the transmission of the plurality of transport blocks, and the instructions are further executable by the processor to cause the apparatus to:
select the one or more rules based at least in part on the timing offset being satisfied, wherein the aperiodic-channel state information is multiplexed on the transport block based at least in part on the timing offset.

24. The apparatus of claim 1, wherein the downlink control information indicates a timing offset between the reception of the downlink control information and the transmission of the plurality of transport blocks, and the instructions are further executable by the processor to cause the apparatus to:
select the one or more rules based at least in part on the timing offset failing to be satisfied, wherein the aperiodic-channel state information is multiplexed on the transport block based at least in part on the timing offset.

25. The apparatus of claim 1, wherein the transport block has a duration of at least two symbols.

26. An apparatus for wireless communication at a base station, comprising:
a processor;
memory coupled with the processor; and
instructions stored in the memory and executable by the processor to cause the apparatus to:
transmit, to a user equipment (UE), downlink control information scheduling a plurality of uplink data transmissions over a plurality of transport blocks, the plurality of uplink data transmissions comprising at least one repetition of a physical uplink shared channel over two or more transport blocks of the plurality of transport blocks;
receive, from the UE, the plurality of transport blocks including a transport block comprising aperiodic-channel state information that is multiplexed in accordance with a type of repetition of the physical uplink shared channel and one or more rules associated with the plurality of transport blocks.

27. The apparatus of claim 26, wherein the instructions to receive the plurality of transport blocks are executable by the processor to cause the apparatus to:
receive the transport block using a first beam for communicating with the UE; and
receive, using a second beam for communicating with the UE, a second transport block comprising second aperiodic-channel state information that is multiplexed in accordance with the type of repetition of the physical uplink shared channel and the one or more rules, the second beam being different from the first beam.

28. The apparatus of claim 26, wherein the downlink control information indicates a timing offset between a reception of the downlink control information by the UE and a transmission of the plurality of transport blocks by the UE, the one or more rules based at least in part on the timing offset.

29. A method for wireless communication at a user equipment (UE), comprising:
receiving downlink control information scheduling a plurality of uplink data transmissions over a plurality of transport blocks, the plurality of uplink data transmissions comprising at least one repetition of a physical uplink shared channel over two or more transport blocks of the plurality of transport blocks;
multiplexing aperiodic-channel state information on a transport block of the plurality of transport blocks in accordance with a type of repetition of the physical uplink shared channel and one or more rules associated with the plurality of transport blocks; and
transmitting, to a base station, the plurality of transport blocks including the transport block comprising the multiplexed aperiodic-channel state information.

30. A method for wireless communication at a base station, comprising:
transmitting, to a user equipment (UE), downlink control information scheduling a plurality of uplink data transmissions over a plurality of transport blocks, the plurality of uplink data transmissions comprising at least one repetition of a physical uplink shared channel over two or more transport blocks of the plurality of transport blocks;
receiving, from the UE, the plurality of transport blocks including a transport block comprising aperiodic-channel state information that is multiplexed in accordance with a type of repetition of the physical uplink shared channel and one or more rules associated with the plurality of transport blocks.
